(19) United States
(12) Patent Application Publication
(10) Pub. No.: US 2016/0349573 A1
(43) Pub. Date: Dec. 1, 2016

(54) OPTICAL SHEET MEMBER AND DISPLAY DEVICE

(71) Applicant: FUJIFILM Corporation, Tokyo (JP)

(72) Inventors: Katsufumi OHMURO, Kanagawa (JP); Yukito SAITOH, Kanagawa (JP); Takashi YONEMOTO, Kanagawa (JP); Hideyuki NISHIKAWA, Kanagawa (JP); Yoji ITO, Kanagawa (JP)

(73) Assignee: FUJIFILM Corporation, Tokyo (JP)

(21) Appl. No.: 15/188,363

(22) Filed: Jun. 21, 2016

Related U.S. Application Data
(63) Continuation of application No. PCT/JP2014/084031, filed on Dec. 24, 2014.

(30) Foreign Application Priority Data
Dec. 24, 2013 (JP) 2013-266181
Jun. 27, 2014 (JP) 2014-132971

(51) Int. Cl. G02F 1/1335; F21V 8/00; G02B 5/22; G02B 5/30; G02B 1/14

(52) U.S. Cl. CPC G02F 1/133617; G02B 5/3041; G02B 5/3016; G02B 5/3083; G02B 1/14; G02B 5/22; G02F 1/13362; G02F 1/133621; G02B 6/0056; G02B 6/0055; G02B 6/0053; G02B 6/0051; G02B 6/0073; G02F 2001/133614; G02F 2001/133624

(57) ABSTRACT

Provided are an optical sheet member including an optical conversion sheet containing a fluorescent material which absorbs at least a part of light in a wavelength range of 380 nm to 480 nm, converts the absorbed light into light in a wavelength range longer than that of the absorbed light, and re-emits the converted light, and a wavelength selective reflective polarizer functioning in the wavelength range of at least a part of the light in the wavelength range of 380 nm to 480 nm, in which both of front brightness and a color reproduction range are improved in a case of being incorporated into a display device using backlight which emits light having at least a blue wavelength range; and the display device.

### CROSS-REFERENCE TO RELATED APPLICATIONS

This application is a Continuation of PCT International Application No. PCT/JP2014/084031, filed on Dec. 24, 2014, which was published under Article 21(2) in Japanese and claims priority under 35 U.S.C. Section 119(a) to Japanese Patent Application No. 2013-266181 filed on Dec. 24, 2013 and Japanese Patent Application No. 2014-132971 filed on Jun. 27, 2014. The above applications are hereby expressly incorporated by reference, in their entirety, into the present application.

### BACKGROUND OF THE INVENTION

1. Field of the Invention

The present invention relates to an optical sheet member and a display device. More specifically, the present invention relates to an optical sheet member in which both of front brightness and a color reproduction range are improved in a case of being incorporated into a display device, and a display device using the optical sheet member.

2. Description of the Related Art

A flat panel display such as a liquid crystal display device (hereinafter, also referred to as LCD) has been annually variously used as a display device. The flat panel display has been annually widely used as a space saving image display device having low power consumption. The display device has a configuration in which backlight (hereinafter, also referred to as BL) is disposed as a light source.

In the recent flat panel display market, power saving, high definition, and improvement in color reproducibility have progressed as improvement in LCD performance, and in particular, the power saving and the improvement in color reproducibility are remarkably required in a small-size liquid crystal display device of a tablet PC, a smart phone, or the like, and a next-generation hi-vision (4K2K, an EBU ratio of greater than or equal to 100%) of the current TV standard (FHD, a national television system committee (NTSC)) ratio of 72%≅an European broadcasting union (EBU) ratio of 100%) has been developed in a large-size liquid crystal display device. For this reason, in the liquid crystal display device, the power saving and the improvement in color reproducibility have been increasingly required.

It has been known that the power saving is obtained by disposing an optical sheet member on a visible side from the backlight according to the power saving of the backlight. The optical sheet member is an optical element including a reflection polarizer in which among incident light rays while vibrating in all directions, only light rays vibrating in a specific polarization direction are transmitted, and light rays vibrating in the other polarization direction are reflected. It has been expected that brightness (the degree of brightness per unit area of the light source) increases by solving low light efficiency of the LCD, as a core component of a low power LCD according to an increase in a mobile device and a reduction in power consumption of home electric appliances.

In response, in the liquid crystal display device including the polarizing plate, a technology has been known in which an optical sheet member (a dual brightness enhancement film (DBEF: Registered Trademark) or the like) is combined between the backlight and a backlight side polarizing plate, and thus, a light utilization rate of the BL is improved by light recycling, and the brightness is improved while saving power of the backlight (refer to JP3448626B). Similarly, in JP1989-133003A (JP-H01-133003A), a technology is disclosed in which a broad band is obtained in a polarizing plate configured by laminating a λ/4 plate and a layer formed by immobilizing a cholesteric liquid crystalline phase and three or more layers formed by immobilizing cholesteric liquid crystalline phases having different pitches, and thus, the light utilization rate of the BL is improved by light recycling.

On the other hand, a method has been also known in which a light emitting spectrum of the backlight becomes sharp from the viewpoint of the improvement in color reproducibility in the liquid crystal display device. For example, in JP2012-169271A, a quantum dot backlight mode (a quantum dot BL) is disclosed in which white light is embodied by using a quantum dot (QD) emitting red light and green light between a blue LED and a light guide plate as a fluorescent body, and thus, high brightness and the improvement in color reproducibility are realized. In SID'12 DIGEST p. 895, a quantum dot BL mode of combining a optical conversion sheet (QDEF, also referred to as a quantum dot sheet) using a quantum dot for improving color reproducibility of the LCD is proposed.

Further, in order to improve the performance of the optical conversion sheet, for example, in JP4589385B, a technology is disclosed in which a reflection filter layer is disposed in the optical conversion sheet described above, and thus, optical conversion efficiency increases. However, such an optical sheet member is strongly required to improve the performance in order to be supplied to the market.

### SUMMARY OF THE INVENTION

In addition, in the fluorescent (PL) application technology disclosed in JP2012-169271A, JP4589385B, and SID '12 DIGEST p. 895, high brightness and improvement in color reproducibility due to white light are realized by using the quantum dot (hereinafter, also referred to as QD), but the configuration is complicated, and thus, it is necessary to adjust a white point (a white balance) while following tristimulus values X, Y, and Z corresponding to RGB of three primary colors.

The improvement in the BL light utilization rate which is necessary for power saving, the high definition (a decrease in an opening ratio), and the improvement in color reproducibility (a decrease in the transmittance of a color filter (hereinafter, referred to as CF)) are in a trade-off relationship, and the improvement in the light utilization rate (brightness) and color reproducibility are required to be compatible.

In response, in JP2013-544018A, an illumination device based on a quantum dot and an illumination device based on a quantum dot are proposed in which a blue light emission diode is used as a primary light source, a remote fluorescent body film including a quantum dot emitting secondary light having a red color and a quantum dot emitting rainbow light having a red color is used, and the primary light is recycled by a brightness enhancement film (BEF) while embodying white light, and thus, high efficiency, high brightness, and high color purity are obtained. However, in JP2013-544018A, specific studies with respect to a combination between wavelength ranges of the fluorescent body film and the brightness enhancement film have not been conducted.

An object of the present invention is to provide an optical sheet member in which both of front brightness and a color reproduction range are improved in a case of being incorporated into a display device using backlight which emits light having at least a blue wavelength range.

As a result of intensive studies of the present inventors for attaining the object described above, it has been found that sufficient brightness of quantum dot BL is able to be attained, and color reproducibility is also improved, according to a configuration including a light source (preferably, a blue light emission diode light source) which emits light having at least a blue wavelength range (380 nm to 480 nm), an optical conversion sheet (a quantum dot, particles having a quantum effect, such as quantum rod type particles and quantum tetrapod type particles, and a PL material (an organic material and an inorganic material) are able to be used, and preferably, an optical sheet in which a QD fluorescent body material is interposed between equipment material films of which at least one includes a barrier layer), and a wavelength selective reflective polarizer (preferably, a light reflection layer formed by immobilizing a cholesteric liquid crystalline phase+a λ/4 plate) which functions in at least a part of a blue wavelength range (380 nm to 480 nm). As described above, it has been found that optical conversion efficiency and light utilization efficiency of the quantum dot BL increase by the present invention, and high front brightness and a wide color reproduction range are able to be simultaneously obtained to the extent of not being obtained from the related art by using a simple configuration, and thus, the object described above is able to be attained. That is, the object described above is attained by the present invention having the following configurations.

<1> An optical sheet member comprising an optical conversion sheet containing a fluorescent material which absorbs at least a part of light in a wavelength range of 380 nm to 480 nm, converts the absorbed light into light in a wavelength range longer than that of the absorbed light, and re-emits the converted light; and a wavelength selective reflective polarizer functioning in at least a part of the wavelength range of 380 nm to 480 nm.

<2> It is preferable that in the optical sheet member according to <1>, a light reflection member further arranged between the optical conversion sheet and the wavelength selective reflective polarizer or the wavelength selective reflective polarizer has a wavelength range having reflectivity of greater than or equal to 60% in at least one wavelength range of wavelength ranges of 470 nm to 510 nm, 560 nm to 610 nm, and 660 nm to 780 nm.

<3> It is preferable that in the optical sheet member according to <1> or <2>, the wavelength selective reflective polarizer includes a light reflection layer formed by immobilizing a cholesteric liquid crystalline phase which reflects light in at least a part of the wavelength range of 380 nm to 480 nm, and a half band width of a reflection range of the light reflection layer is 15 nm to 400 nm.

<4> It is preferable that in the optical sheet member according to any one of <1> to <3>, the wavelength selective reflective polarizer includes a light reflection layer formed by immobilizing a cholesteric liquid crystalline phase which has a reflection center wavelength in at least one wavelength range of wavelength ranges of 380 nm to 480 nm, 500 nm to 570 nm, and 600 nm to 690 nm.

<5> It is preferable that the optical sheet member according to any one of <1> to <4> further comprises a λ/4 plate satisfying at least one of Expressions (1) to (3) described below (more preferably, all of Expressions (1) to (3) described below).

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

In Expressions (1) to (3), Re(λ) represents retardation in an in-plane direction at a wavelength of λ nm, and a unit of Re(λ) is nm.

<6> It is preferable that the optical sheet member according to <5> further comprises a polarizing plate, and the polarizing plate, the λ/4 plate, and the wavelength selective reflective polarizer are laminated in this order directly in contact with each other or through an adhesive layer.

<7> It is preferable that the optical sheet member according to any one of <1> to <4> further comprises a polarizing plate, the polarizing plate includes a polarizer and at least one polarizing plate protective film, the polarizer, the polarizing plate protective film, and the wavelength selective reflective polarizer are laminated in this order directly in contact with each other or through an adhesive layer, and the polarizing plate protective film is a λ/4 plate satisfying at least one of Expressions (1) to (3) described below (more preferably, all of Expressions (1) to (3) described below).

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

In Expressions (1) to (3), Re(λ) represents retardation in an in-plane direction at a wavelength of λ nm, and a unit of Re(λ) is nm.

<8> It is preferable that in the optical sheet member according to any one of <5> to <7>, the λ/4 plate is an optically approximately monoaxial or approximately biaxial retardation film, or a retardation film including one or more liquid crystal layers containing a liquid crystal compound.

<9> It is preferable that in the optical sheet member according to <1> or <2>, the wavelength selective reflective polarizer is a dielectric multi-layer film.

<10> It is preferable that the optical sheet member according to <9> further comprises a polarizing plate, and the polarizing plate and the wavelength selective reflective polarizer are laminated directly in contact with each other or through an adhesive layer.

<11> It is preferable that in the optical sheet member according to any one of <1> to <10>, the fluorescent material contains at least one of an organic fluorescent body or an inorganic fluorescent body.

<12> It is preferable that in the optical sheet member according to <11>, the inorganic fluorescent body contains at least one of an oxide fluorescent body, a sulfide fluorescent body, a quantum dot fluorescent body, or a quantum rod fluorescent body.

<13> It is preferable that in the optical sheet member according to <11>, the inorganic fluorescent body contains a quantum rod material, and the optical conversion sheet is a thermoplastic film formed by being stretched after dispersing a quantum rod material, and emits fluorescent light having at least a part of polarization properties of incidence light.

<14> It is preferable that in the optical sheet member according to any one of <1> to <13>, the optical sheet member has light absorption properties in at least one wavelength range of wavelength ranges of 470 nm to 510 nm, 560 nm to 610 nm, and 660 nm to 780 nm.

<15> It is preferable that in the optical sheet member according to any one of <1> to <14>, a light absorption member further arranged between the optical conversion sheet and the wavelength selective reflective polarizer or the wavelength selective reflective polarizer has light absorption properties in at least one wavelength range of wavelength ranges of 470 nm to 510 nm, 560 nm to 610 nm, and 660 nm to 780 nm.

<16> It is preferable that in the optical sheet member according to <14> or <15>, the absorption properties are properties which have an absorption range having light absorbance of greater than or equal to 0.1 in at least one wavelength range of wavelength ranges of 470 nm to 510 nm, 560 nm to 610 nm, and 660 nm to 780 nm.

Here, light absorbance A is −log₁₀ (transmittance).

<17> It is preferable that in the optical sheet member according to any one of <1> to <16>, the light re-emitted from the fluorescent material is green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a light emission intensity peak having a half band width of less than or equal to 100 nm.

<18> It is preferable that in the optical sheet member according to any one of <1> to <17>, the optical conversion sheet includes a fluorescent material member in which the fluorescent material is dispersed in a polymer matrix between two base films on which an oxygen gas barrier layer is disposed.

<19> A display device comprising at least a light source having a light emission wavelength in at least a part of a wavelength range of 380 nm to 480 nm; and the optical sheet member according to any one of <1> to <18>.

<20> It is preferable that in the display device according to <19>, the light source, the optical conversion sheet included in the optical sheet member, and the wavelength selective reflective polarizer included in the optical sheet member are arranged in this order.

<21> It is preferable that the display device according to <19> or <20> further comprises an optical switching device switching light of the light source.

<22> It is preferable that in the display device according to <21>, the optical switching device is a liquid crystal driving device, and a polarizing plate is disposed between the wavelength selective reflective polarizer and the liquid crystal driving device.

<23> It is preferable that in the display device according to <22>, the polarizing plate and the wavelength selective reflective polarizer are laminated directly in contact with each other or through an adhesive layer.

<24> It is preferable that in the display device according to <22> or <23>, the optical sheet member includes a λ/4 plate satisfying at least one of Expressions (1) to (3) described below (more preferably, all of Expressions (1) to (3) described below), and the polarizing plate, the λ/4 plate, and the wavelength selective reflective polarizer are laminated in this order directly in contact with each other or through an adhesive layer.

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

In Expressions (1) to (3), Re(λ) represents retardation in an in-plane direction at a wavelength of λ nm, and a unit of Re(λ) is nm.

<25> It is preferable that the display device according to any one of <22> to <24> further comprises a light guide plate bonded to the light source; and an optical sheet disposed in at least one position between the light guide plate and the optical conversion sheet, between the optical conversion sheet and the wavelength selective reflective polarizer, and between the wavelength selective reflective polarizer and the polarizing plate.

<26> It is preferable that in the display device according to <25>, the optical sheet is a single-layer optical sheet or a laminated optical sheet selected from one or more of a prism sheet, a lens sheet, and a scattering sheet.

<27> It is preferable that in the display device according to any one of <19> to <26>, the light source includes a blue LED, and the optical conversion sheet includes a fluorescent material having a light emission wavelength of green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a half band width of less than or equal to 100 nm.

<28> It is preferable that in the display device according to any one of <19> to <27>, the optical conversion sheet includes a fluorescent material member in which the fluorescent material is dispersed in a polymer matrix between two base films on which an oxygen gas barrier layer is disposed, and the optical conversion sheet is arranged between the wavelength selective reflective polarizer and the light source.

<29> It is preferable that the display device according to any one of <19> to <28> further comprises a thin layer transistor, and the thin layer transistor includes an oxide semiconductor layer having a carrier concentration of less than 1×10¹⁴/cm³.

According to the present invention, it is possible to provide an optical sheet member in which both of front brightness and a color reproduction range are improved in a case of being incorporated into a display device using backlight which emits light having at least a blue wavelength range.

### BRIEF DESCRIPTION OF THE DRAWINGS

FIG. 1 is a schematic view illustrating a sectional surface of an example of an optical sheet member of the present invention using one light reflection layer formed by immobilizing a cholesteric liquid crystalline phase as a wavelength selective reflective polarizer along with a positional relationship with respect to backlight.

FIG. 2 is a schematic view illustrating a sectional surface of another example of an optical sheet member of the present invention using three light reflection layers formed by immobilizing cholesteric liquid crystalline phases as a wavelength selective reflective polarizer along with a positional relationship with respect to backlight.

FIG. 3 is a schematic view illustrating a sectional surface of still another example of the optical sheet member of the present invention using three light reflection layers formed by immobilizing cholesteric liquid crystalline phases as a wavelength selective reflective polarizer along with a positional relationship with respect to backlight.

FIG. 4 is a schematic view illustrating a sectional surface of an example of an optical sheet member of the present invention using a dielectric multi-layer film as a wavelength selective reflective polarizer along with a positional relationship with respect to backlight.

FIG. 5 is a schematic view illustrating a sectional surface of another example of an optical sheet member of the present invention using a dielectric multi-layer film as a wavelength selective reflective polarizer along with a positional relationship with respect to backlight.

FIG. 6 is a schematic view illustrating a sectional surface of still another example of an optical sheet member of the present invention using a dielectric multi-layer film as a wavelength selective reflective polarizer along with a positional relationship with respect to backlight.

FIG. 7 is a schematic view illustrating a sectional surface of an example of a liquid crystal display device which is a display device of the present invention along with a positional relationship with respect to backlight.

FIG. 8 is a schematic view illustrating a sectional surface of an example of a liquid crystal display device which is a display device of the present invention.

FIG. 9 is a schematic view illustrating a sectional surface of an example of a liquid crystal display device which is a display device of the present invention.

FIG. 10 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range.

FIG. 11 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range and includes an unnecessary light absorption material in an optical conversion sheet.

FIG. 12 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range and includes an unnecessary light absorption material in a polarizing plate protective film.

FIG. 13 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range and includes an unnecessary light absorption material in a retardation film.

FIG. 14 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range and includes an unnecessary light absorption material in a BL optical member sheet.

FIG. 15 is a schematic view illustrating a sectional surface of an example of a liquid crystal display device which is a display device of the present invention, and specifically, a schematic view illustrating a sectional surface of an example of a liquid crystal display device of an example in which a wavelength selective reflective polarizer has a reflection range of greater than or equal to 60% in a part of a wavelength range and includes a BL light source member (in a gap between a light guide plate and an LED light source light guide plate).

FIG. 16 is a schematic view illustrating a sectional surface of an example of a liquid crystal display device which is a display device of the present invention, and specifically, a schematic view illustrating a sectional surface of an example of a liquid crystal display device of an example including a linear polarization reflection type wavelength selective reflective polarizer in which a λ/4 plate, a light reflection layer formed by immobilizing a cholesteric liquid crystalline phase, and a λ/4 plate are laminated in this order.

FIG. 17 is a schematic view illustrating a preferred relationship between an absorption axis direction of a backlight side polarizer and a slow axis direction of a λ/4 plate when a spiral structure of a light reflection layer formed by immobilizing a cholesteric liquid crystalline phase is a right spiral.

FIG. 18 is a schematic view illustrating a preferred relationship between an absorption axis direction of a backlight side polarizer and a slow axis direction of a λ/4 plate when a spiral structure of a light reflection layer formed by immobilizing a cholesteric liquid crystalline phase is a left spiral.

### DESCRIPTION OF THE PREFERRED EMBODIMENTS

Hereinafter, an optical sheet member and a display device of the present invention will be described in detail. The following configuration requirements will be described on the basis of representative embodiments of the present invention, but the present invention is not limited to such embodiments. Furthermore, herein, a numerical range denoted by using to indicates a range including numerical values before and after to as the lower limit value and the upper limit value. Herein, a “half value width” of a peak indicates the width of a peak at a height of ½ of a peak height.

[Optical Sheet Member]

An optical sheet member of the present invention includes an optical conversion sheet containing a fluorescent material which absorbs at least a part of light in a wavelength range of 380 nm to 480 nm, converts the absorbed light into light in a wavelength range longer than that of the absorbed light, and re-emits the converted light, and a wavelength selective reflective polarizer functioning in at least a part of the wavelength range of 380 nm to 480 nm.

According to such a configuration, in the optical sheet member of the present invention, both of front brightness and a color reproduction range are improved in a case of being incorporated into a display device using backlight which emits light having at least a blue wavelength range. A mechanism of obtaining such an effect will be described.

First, a mechanism of improving the front brightness will be described. This is because in the display device configuration including a backlight light source which emits light having at least a blue wavelength range (380 nm to 480 nm), the optical conversion sheet, and the wavelength selective reflective polarizer functioning in at least a part of a blue wavelength range (380 nm to 480 nm), it is possible to considerably decrease a fluorescent material concentration in the optical conversion sheet using a fluorescent material which is necessary for attaining sufficient brightness by increasing efficient recycling of blue light of a light source and an optical path distance of the blue light with respect to the optical conversion sheet. As described above, it is possible to improve the front brightness to the extent of not being obtained from the related art by increasing optical conversion efficiency and light utilization efficiency of the optical conversion sheet using the fluorescent material.

In addition, a mechanism of improving the color reproduction range by the configuration of the optical sheet member of the present invention, that is, the optical sheet member including the optical conversion sheet containing the fluorescent material which absorbs at least a part of the light in the wavelength range of 380 nm to 480 nm, converts the absorbed light into light in the wavelength range longer than that of the absorbed light, and re-emits the converted light, and the wavelength selective reflective polarizer functioning in at least a part of the wavelength range of 380 nm to 480 nm is as follows.

It has been generally known that the color reproduction range of the liquid crystal display device broadens by narrowing the half band width of a transmitted spectrum of CF. (Non-Patent Literature: Technical Review 2000-I published on May 25, 2000 by Sumitomo Chemical Company, Limited; High Performance of Color Filter for Liquid Crystal Display Element, P. 39) That is, the color reproduction range and the brightness are in a trade-off relationship, and thus, a resource for improving the brightness in the present invention is also able to broad the color reproduction range.

It is preferable that the light source described above is a blue light emission diode light source.

A quantum dot, particles having a quantum effect, such as quantum rod type particles and quantum tetrapod type particles, a PL material (an organic material and an inorganic material), and preferably, an optical sheet in which a QD fluorescent body material is interposed between equipment material films of which at least one includes a barrier layer are able to be used as the optical conversion sheet described above.

It is preferable that the wavelength selective reflective polarizer described above is a laminated body of a light reflection layer formed by immobilizing a cholesteric liquid crystalline phase and a λ/4 plate.

It is preferable that the display device described above is a display device including a liquid crystal panel (LCD).

It is preferable that the configuration of the display device described above is a configuration in which the light source described above forms a surface light source bonded to a light guide plate (LGP), and the optical conversion sheet and the wavelength selective reflective polarizer are arranged between LGP and the optical film (the polarizing plate protective film) of LCD.

It is preferable that a quantum dot BL is configured by combining the light source described above and the optical conversion sheet described above combination.

In the optical sheet member of the present invention, the optical conversion sheet described above and the wavelength selective reflective polarizer described above may be laminated directly in contact with each other, may be laminated through an adhesive layer, or may be separately arranged (respectively arranged through an air layer as an independent member). Furthermore, in a case where the optical conversion sheet described above and the wavelength selective reflective polarizer described above are separately arranged, the optical conversion sheet described above may not be bonded to the wavelength selective reflective polarizer described above in the optical sheet member of the present invention.

<Example of Preferred Embodiment of Display Device Using Optical Sheet Member>

The following first to sixth embodiments will be described as a preferred embodiment of the display device using the optical sheet member of the present invention.

In the below description, a panel is preferably an optical switching device, is more preferably a liquid crystal driving device, and is particularly preferably a liquid crystal panel including at least a liquid crystal cell, a thin layer transistor substrate, and a color filter substrate.

In a first embodiment which is an example of the preferred embodiment of the display device using the optical sheet member of the present invention, the display device includes a polarizing plate including a polarizer (A), a wavelength selective reflective polarizer (B1) formed of a layer formed by immobilizing a cholesteric liquid crystalline phase or a layer formed by immobilizing a cholesteric liquid crystalline phase which includes a λ/4 plate, an optical conversion sheet (C1), and a light source which has a light emission center wavelength in a wavelength range of 380 nm to 480 nm and has a half band width of less than or equal to 100 nm, preferably of less than or equal to 50 nm, and more preferably of less than or equal to 20 nm from the panel side, the wavelength selective reflective polarizer (B1) reflects light in at least a part of the wavelength range of 380 nm to 480 nm and has a reflection range having a half band width of less than or equal to 400 nm, preferably less than or equal to 200 nm, and more preferably less than or equal to 100 nm to 15 nm, and the optical conversion sheet (C1) converts a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and more preferably less than or equal to 50 nm, and transmits a part of the blue light described above.

In addition, the light reflection layer formed by immobilizing the cholesteric liquid crystalline phase is able to reflect at least one of right circularly polarized light or left circularly polarized light in a wavelength range in the vicinity of the reflection center wavelength thereof. The λ/4 plate is able to convert light having a wavelength of λ nm into linearly polarized light from circularly polarized light.

In a case of this embodiment, light in a first polarization state (for example, right circularly polarized light) is substantially reflected by a reflection polarizer, and light in a second polarization state (for example, left circularly polarized light) is substantially transmitted through the reflection polarizer described above, and the light in the second polarization state (for example, the left circularly polarized light) which has been transmitted through the reflection polarizer described above is able to be converted into the linearly polarized light by the λ/4 plate and is able to be substantially transmitted through a polarizer (a linear polarizer) of a BL side polarizing plate.

It is preferable that the film thickness of the wavelength selective reflective polarizer described above which is used in this embodiment is thin from the viewpoint of reducing the weight and the thickness (designability) of a final product (a display device into which this embodiment is incorporated), the thickness is preferably 5 μm to 100 μm, and is more preferably 5 μm to 50 μm, and the light reflection layer formed by immobilizing the cholesteric liquid crystalline phase may be laminated on the λ/4 plate through an adhesive layer or a pressure sensitive adhesive material.

In addition, the λ/4 plate may be a single-layer, or may be a laminated body including two or more layers, and a case of the laminated body including two or more layers is more preferable from the viewpoint of controlling birefringence.

In a second embodiment which is an example of the preferred embodiment of the display device using the optical sheet member of the present invention, the display device includes a polarizing plate including a polarizer (A), a wavelength selective reflective polarizer (B1) formed of a dielectric multi-layer film, and optical conversion sheet (C1), and a light source which has a light emission center wavelength in a wavelength range of 380 nm to 480 nm and has a half band width of less than or equal to 100 nm, preferably less than or equal to 50 nm, and more preferably less than or equal to 20 nm from the panel side, the wavelength selective reflective polarizer (B1) reflects light in at least a part of the wavelength range of 380 nm to 480 nm and has a half band width having a reflection range of less than or equal to 400 nm, preferably less than or equal to 200 nm, and more preferably 100 nm to 15 nm, and the optical conversion sheet (C1) converts a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and preferably less than or equal to 50 nm, and transmits a part of the blue light described above.

In addition, it is preferable that the film thickness of the dielectric multi-layer film which is used in this embodiment is thin from the viewpoint of reducing the weight and the thickness (designability) of a final product (a display device into which this embodiment is incorporated), and the thickness is preferably 5 μm to 100 μm, is more preferably 5 μm to 50 μm, and is particularly preferably 5 μm to 20 μm.

In addition, a manufacturing method of the dielectric multi-layer film which is used in this embodiment is not particularly limited, and for example, the dielectric multi-layer film is able to be manufactured with reference to methods disclosed in JP3187821B, JP3704364B, JP4037835B, JP4091978B, JP3709402B, JP4860729B, JP3448626B, and the like, and the contents of the publications are incorporated in the present invention. Furthermore, the dielectric multi-layer film indicates a dielectric multi-layer reflection polarizing plate or a birefringence interference polarizer of an alternate multi-layer film.

In a third embodiment which is an example of the preferred embodiment of the display device using the optical sheet member of the present invention, the display device includes a polarizing plate including a polarizer (A), a wavelength selective reflective polarizer (B1) formed of a layer formed by immobilizing a cholesteric liquid crystalline phase or a layer formed by immobilizing a cholesteric liquid crystalline phase which includes a λ/4 plate, an optical conversion sheet (C1), and a light source which has a light emission center wavelength in a wavelength range of 380 nm to 480 nm and has a half band width of less than or equal to 100 nm, preferably less than or equal to 50 nm, and more preferably less than or equal to 20 nm from the panel side, the wavelength selective reflective polarizer (B1) is a light reflection layer formed by immobilizing a cholesteric liquid crystalline phase having a reflection center wavelength in at least one wavelength range of wavelength ranges of 380 nm to 480 nm, 500 nm to 570 nm, and 600 nm to 690 nm and has a half band width having a reflection range of less than or equal to 100 nm, and preferably 50 nm to 15 nm, and the optical conversion sheet (C1) converts a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and preferably less than or equal to 50 nm, and transmits a part of the blue light described above.

In addition, in this embodiment, the same performance is able to be realized in the wavelength selective reflective polarizer (B1) which is formed of the dielectric multi-layer film having a reflection center wavelength in at least one wavelength range of wavelength ranges of 380 nm to 480 nm, 500 nm to 570 nm, and 600 nm to 690 nm.

In a fourth embodiment which is an example of the preferred embodiment of the display device using the optical sheet member of the present invention, the display device includes a polarizing plate including a polarizer (A), and a wavelength selective reflective polarizer (B2; a band having reflectivity of greater than or equal to 60% is able to be formed by further including a cholesteric liquid crystal layer having a different twist from that of the wavelength selective reflective polarizer (B1) described above) which is formed of a layer formed by immobilizing a cholesteric liquid crystalline phase or a layer formed by immobilizing a cholesteric liquid crystalline phase which includes a λ/4 plate, reflects light in at least a part of the wavelength range of 380 nm to 480 nm, has a half band width having a reflection range of less than or equal to 400 nm, preferably less than or equal to 200 nm, and more preferably 100 nm to 15 nm, and has reflectivity (front reflectivity) of greater than or equal to 60%, and preferably greater than or equal to 70%, and more preferably, the maximum reflectivity of greater than or equal to 80% in at least one band of wavelength ranges of 470 nm to 510 nm, 560 nm to 610 nm, and 660 nm to 780 nm from the panel side, and an optical conversion sheet (C1) reflects a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and preferably less than or equal to 50 nm, and transmits a part of the blue light described above.

In addition, the light reflection layer formed by immobilizing the cholesteric liquid crystalline phase is able to reflect at least one of right circularly polarized light or left circularly polarized light in a wavelength range in the vicinity of the reflection center wavelength thereof. The λ/4 plate is able to convert light having a wavelength of λ nm into linearly polarized light from circularly polarized light.

In a case of this embodiment, a first cholesteric layer (for example, a right twist) substantially reflects light in a first polarization state (for example, right circularly polarized light) by a reflection polarizer, a second cholesteric layer (having a twist opposite to that of the first cholesteric layer: for example, a left twist) is formed and reflects a part of light in a second polarization state (for example, left circularly polarized light) in at least one band of wavelength ranges of 470 nm to 510 nm, 560 nm to 610 nm, and 660 nm to 780 nm reflection, and thus, the reflectivity (the front reflectivity) of the band described above is able to be adjusted to be greater than or equal to 60%.

On the other hand, a part of the light in the wavelength range described above and the other light in the second polarization state (for example, the left circularly polarized light) are able to be transmitted through the reflection polarizer described above, the light in the second polarization state (for example, the left circularly polarized light) which has been transmitted through the reflection polarizer described above is able to be converted into linearly polarized light by the λ/4 plate and is able to be substantially transmitted through a polarizer (a linear polarizer) of a BL side polarizing plate.

In addition, in this embodiment, the same effect of the present invention is able to be realized in the wavelength selective reflective polarizer which is formed of the dielectric multi-layer film.

In addition, a first dielectric multi-layer film is able to reflect light in at least one wavelength range of S polarization or P polarization. Further, the first dielectric multi-layer film (for example, S polarization reflection) substantially reflects the light in the first polarization state (for example, the S polarization) by the reflection polarizer, and a second dielectric multi-layer film (linearly polarized light orthogonal to the first cholesteric layer: for example, P polarization reflection) reflects a part of the light in the second polarization state (for example, the P polarization) in at least one band of wavelength ranges of 470 nm to 510 nm, 560 nm to 610 nm, and 660 nm to 780 nm, and thus, the reflectivity (front reflectivity) of the band described above is able to be adjusted to be greater than or equal to 60%.

On the other hand, in this case, a part of the light in the wavelength range described above and the other light in the second polarization state (for example, linearly polarized light S) are able to be transmitted through the reflection polarizer described above, and the light in the second polarization state (for example, linearly polarized light P orthogonal to the linearly polarized light S) which has been transmitted through the reflection polarizer described above is able to be substantially transmitted through the polarizer (the linear polarizer) of the BL side polarizing plate.

In a fifth embodiment which is an example of the preferred embodiment of the display device using the optical sheet member of the present invention, the display device includes a polarizing plate including a polarizer (A), and a reflection polarizer which is formed of a layer formed by immobilizing a cholesteric liquid crystalline phase or a layer immobilizing a cholesteric liquid crystalline phase which includes a λ/4 plate, reflects light in at least a part of the wavelength range of 380 nm to 480 nm, has a half band width having a reflection range of less than or equal to 400 nm, preferably less than or equal to 200 nm, and more preferably 100 nm to 15 nm from the panel side, an optical conversion sheet (C1) converts a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and preferably less than or equal to 50 nm, and transmits a part of the blue light described above.

Further, the display device includes at least one of a polarizer, a polarizing plate protective film, retardation, a wavelength selective reflective polarizer, or an optical conversion sheet which have light absorption properties in at least one band of wavelength ranges of 470 nm to 510 nm, 560 nm to 610 nm, and 660 nm to 780 nm.

In this case, a squarylium-based compound, an azo methine-based compound, a cyanine-based compound, an oxonol-based compound, an anthraquinone-based compound, an azo-based compound, or a benzylidene-based compound is preferably used as an absorption material (a dye or a pigment) which has the maximum value of light absorbance (hereinafter, also referred to as maximal absorption) in each wavelength range and has a light absorbance peak having a half band width of less than or equal to 50 nm Various azo dyes disclosed in GB539703B, GB575691B, U.S. Pat. No. 2,956,879A, “Reviews of Synthesized Dye” written by Hiroshi HORIGUCHI and published by SANKYO SHUPPAN Co., Ltd., and the like are able to be used as an azo dye. A preferred embodiment of the absorption material will be described below.

In a sixth embodiment which is an example of the preferred embodiment of the display device using the optical sheet member of the present invention, the display device includes a polarizing plate including a polarizer (A), and a wavelength selective reflective polarizer (B2) which is formed of a layer formed by immobilizing a cholesteric liquid crystalline phase or a layer formed by immobilizing a cholesteric liquid crystalline phase which includes a λ/4 plate, reflects light in at least a part of the wavelength range of 380 nm to 480 nm, has a half band width having a reflection range of less than or equal to 400 nm, preferably less than or equal to 200 nm, and more preferably 100 nm to 15 nm, and has reflectivity (front reflectivity) of greater than or equal to 60%, and preferably greater than or equal to 70% in a wavelength range of 470 nm to 510 nm and 560 nm to 610 nm, and more preferably, the maximum reflectivity of greater than or equal to 80% from the panel side, an optical conversion sheet (C1) converts a part of incidence blue light having a light emission center wavelength in a wavelength range of 380 nm to 480 nm into green light which has a light emission center wavelength in a wavelength range of 500 nm to 600 nm and has a light emission intensity peak having a half band width of less than or equal to 100 nm, preferably less than or equal to 50 nm, and more preferably less than or equal to 30 nm and red light which has a light emission center wavelength in a wavelength range of 600 nm to 700 nm (more preferably, a light emission center wavelength in a wavelength range of 600 nm to 650 nm) and has a light emission intensity peak having a half band width of less than or equal to 100 nm, and more preferably less than or equal to 50 nm, and transmits a part of the blue light described above, and the display device further includes at least one of a polarizer, a polarizing plate protective film, retardation, a wavelength selective reflective polarizer, or an optical conversion sheet which have light absorption properties in at least one band in a wavelength range of 660 nm to 780 nm.

According to the configuration described above (the first embodiment to the sixth embodiment), in the optical sheet member of the present invention, a reduction in a member thickness according to a reduction in the number of members and improvement in front brightness and a color reproduction range, and a reduction in color unevenness in an oblique azimuth are able to be obtained at the time of being incorporated into display device using backlight in which a bright line having a half band width of less than or equal to 100 nm in a blue wavelength range.

<Configuration of Optical Sheet Member>

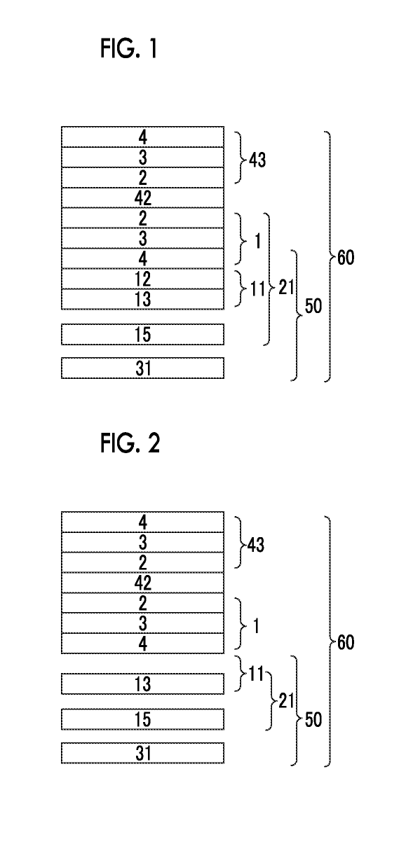

In FIG. 1, a schematic view of the optical sheet member of the present invention is illustrated along with a backlight unit 31.

An optical sheet member 21 of the present invention includes an optical conversion sheet 15 described above and a wavelength selective reflective polarizer 13.

It is preferable that the optical sheet member 21 of the present invention further includes a brightness enhancement film 11. In an embodiment (i) of the optical sheet member 21 of the present invention illustrated in FIG. 1, it is preferable that the brightness enhancement film 11 includes a wavelength selective reflective polarizer 13 and a λ/4 plate 12, and the wavelength selective reflective polarizer 13 is a circular polarization reflection polarizer. In an embodiment (ii) of the optical sheet member 21 of the present invention illustrated in FIG. 2, it is preferable that the brightness enhancement film 11 is the wavelength selective reflective polarizer 13, and the wavelength selective reflective polarizer 13 is a linear polarization reflection polarizer.

The optical sheet member 21 of the present invention may further include a backlight side polarizing plate 1. It is preferable that the backlight side polarizing plate 1 includes a retardation film 2, a polarizer 3, and a polarizing plate protective film 4. Here, in the embodiment (i) of the optical sheet member 21 of the present invention, the polarizing plate protective film 4 may be configured to also function as the λ/4 plate 12.

The backlight side polarizing plate 1 and the brightness enhancement film 11 may be laminated through an adhesive layer or a pressure sensitive adhesive material (not illustrated), or may be separately arranged.

As illustrated in FIG. 1, in the display device of the present invention, it is preferable that the backlight unit 31 including the light source described above, the optical conversion sheet 15 described above of the optical sheet member 21 described above, and the wavelength selective reflective polarizer 13 described above of the optical sheet member 21 described above are arranged in this order.

<Optical Conversion Sheet (D)>

The optical conversion sheet of the optical sheet member of the present invention is an optical conversion sheet containing a fluorescent material which absorbs at least a part of light in a wavelength range of 380 nm to 480 nm, converts the absorbed light described above into light in a wavelength range longer than that of the absorbed light, and re-emits the converted light. It is preferable that the optical conversion sheet described above converts light of a blue light source for quantum backlight (preferably, a blue light emission diode) having a wavelength of 380 nm to 480 nm into light having a wavelength longer than that of the light source by photoluminescence (PL) of the fluorescent body. The optical conversion sheet described above also referred to as a wavelength conversion sheet.

In addition, light re-emitted from the fluorescent material preferably has a half band width of less than or equal to 100 nm. In the optical sheet member of the present invention, it is preferable that the light re-emitted from the fluorescent material described above is green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a light emission intensity peak having a half band width of less than or equal to 100 nm.

A fluorescent body using a quantum dot (QD) is preferably used as the fluorescent material described above.

It is preferable that the fluorescent body is arranged between base films (protective films) in which an oxygen gas barrier layer is formed at least one of an upper side surface or a lower side surface of a layer containing the fluorescent material such as QD (hereinafter, also referred to as a wavelength conversion layer).

In addition, preferably, a blue LED light source is bonded to a light guide plate (LGP), the optical sheet member of the present invention in which the optical conversion sheet using a quantum dot fluorescent body and the wavelength selective reflective polarizer are combined is arranged between LGP and a polarizing plate of a liquid crystal panel, and thus, the blue light is able to be efficiently re-used, and a QD concentration which is necessary for attaining sufficient brightness as quantum backlight is able to be considerably reduced.

A layer in which a multi-layer film barrier layer of an inorganic layer (SiOx, SiNx, AlOx, and the like) and an organic layer are formed on a base film such as PET and PET, and a glass plate are included in a preferred oxygen gas barrier layer.

Preferably, in the quantum dot fluorescent body, green light and red light are emitted from blue primary light of a blue LED by a quantum dot. In a preferred embodiment, backlight for a liquid crystal display device is a white light emission backlight unit (BLU). The preferred embodiment includes a first quantum dot which emits red secondary light and a second quantum dot which emits green secondary light, and most preferably, a green light emission quantum dot and a green light emission quantum dot are excited by the blue primary light, and thus, white light is obtained. The preferred embodiment includes a third quantum dot which emits blue secondary light at the time of being excited. Each portion of the red light, the green light, and the blue light is able to be controlled such that a white balance which is desirable for the white light emitted from the device is realized.

The quantum dot which is able to be used in the present invention contains CdSe or ZnS. Preferably, examples of the quantum dot include a core/shell emissive nano crystal containing CdSe/ZnS, InP/ZnS, PbSe/PbS, CdSe/CdS, CdTe/CdS, or CdTe/ZnS. In an exemplary embodiment, the emissive nano crystal includes outside ligand coating, and is dispersed in a polymer matrix.

In addition, it is preferable that the polymer matrix in which the quantum dot is dispersed is a discontinuous composite matrix containing at least two materials. Preferably, a first matrix material contains aminopolystyrene (APS), and a second matrix material contains epoxy. It is more preferable that the first matrix material contains polyethylene imine or modified polyethylene imine (PEI), and the second matrix material contains epoxy. A preferred method for preparing a quantum dot fluorescent body material includes dispersing a plurality of emissive nano crystals in the first polymer material, and forming a mixture of the emissive nano crystal and the first polymer material. It is preferable that the mixture is cured, and a particulate substance is generated from the cured mixture. In addition, it is preferable that a cross-linking agent is added to the mixture before being cured. In the exemplary embodiment, a particulate substance is generated by pulverizing the cured mixture. It is preferable that the particulate substance is dispersed in the second polymer material, a composite matrix is generated, and a film is formed by curing the material. The other preferred method for preparing the quantum dot fluorescent body material includes dispersing a plurality of emissive nano crystals in the first polymer material, forming a mixture of the emissive nano crystal and the first polymer material, adding the second material, forming a film using the mixture, and then, curing the film.

Further, in the embodiment, it is preferable that the present invention provides QD BLU including a scattering characteristic portion in order to accelerate scattering of primary light from the blue light source, to increase an optical path distance of the primary light with respect to QD in a QD film, and thus, to increase efficiency of the QD BLU, and to reduce the number of QD in a system. Examples of a preferred scattering characteristic portion include a characteristic portion formed on a scattering bead in the QD film, a scattering domain in a host matrix, and/or a barrier layer or LGP.

Hereinafter, a preferred embodiment of the optical conversion sheet which is used in the present invention will be specifically described.

(Fluorescent Material)

In the optical sheet member of the present invention, it is preferable that the fluorescent material described above contains at least one of an organic fluorescent body or an inorganic fluorescent body. It is preferable that the inorganic fluorescent body described above contains at least one of an oxide fluorescent body, a sulfide fluorescent body, a quantum dot fluorescent body, or a quantum rod fluorescent body. Examples of the inorganic fluorescent body which is able to be used in the optical conversion sheet of the optical sheet member of the present invention include a lutetium aluminum oxide manufactured by U-VIX Corporation: cerium or barium magnesium aluminate: a green fluorescent body of europium and manganese or gadolinium oxy sulfide: europium or calcium sulfide: and a red fluorescent body of europium, examples of the other inorganic fluorescent body include a yttrium.aluminum.garnet-based yellow fluorescent body, a terbium.aluminum.garnet-based yellow fluorescent body, or the like. In addition, a fluorescent material disclosed in JP2008-41706A or JP2010-532005A is able to be used.

In addition, the organic fluorescent body which is an organic fluorescent material is also able to be used, and for example, organic fluorescent bodies disclosed in JP2001-174636A, JP2001-174809A, and the like are able to be used.

In the optical sheet member of the present invention, it is preferable that the optical conversion sheet (D) including the fluorescent material contains at least one of a quantum dot fluorescent body or a quantum rod fluorescent body, it is more preferable that the optical conversion sheet (D) is a quantum dot sheet, a thermoplastic film formed by being stretched after dispersing a quantum dot material (a quantum dot and a quantum rod), or an adhesive layer into which a quantum dot material is dispersed, and it is preferable that the inorganic fluorescent body described above contains the quantum rod material, and the optical conversion sheet described above is the thermoplastic film formed by being stretched after dispersing the quantum rod material and emits fluorescent light retaining at least a part of polarization properties of incidence light.

In addition, the material to be used in the optical sheet of the present invention described above which is formed by being stretched after dispersing the quantum dot material is not particularly limited. For example, cellulose acylate, a polycarbonate-based polymer, a polyester-based polymer such as polyethylene terephthalate or polyethylene naphthalate, an acrylic polymer such as polymethyl methacrylate, a styrene-based polymer such as polystyrene or an acrylonitrile.styrene copolymer (an AS resin), and the like are able to be used as various polymer films. In addition, one or two or more types of polymers are selected from polyolefin such as polyethylene and polypropylene, a polyolefin-based polymer such as an ethylene.propylene copolymer, a vinyl chloride-based polymer, an amide-based polymer such as nylon or aromatic polyamide, an imide-based polymer, a sulfone-based polymer, a polyether sulfone-based polymer, a polyether ether ketone-based polymer, a polyphenylene sulfide-based polymer, a vinylidene chloride-based polymer, a vinyl alcohol-based polymer, a vinyl butyral-based polymer, an arylate-based polymer, a polyoxy methylene-based polymer, an epoxy-based polymer, or a polymer in which the polymers described above are mixed, and the like, and are used as a main component, and thus, the polymers are able to be used for preparing the polymer film and for preparing the optical sheet in a combination satisfying the properties described above.

In a case where the optical conversion sheet (D) including the fluorescent material described above is the quantum dot sheet, such a quantum dot sheet is not particularly limited, and known quantum dot sheets, for example, disclosed in JP2012-169271A, SID'12 DIGEST p. 895, JP2010-532005A, and the like are able to be used, and the contents of the literatures are incorporated in the present invention. In addition, a Quantum Dot Enhancement Film ((QDEF), manufactured by NanoSys Co., Ltd.) is able to be used as such a quantum dot sheet.

In a case where the optical conversion sheet (D) including the fluorescent material described above is the thermoplastic film formed by being stretched after dispersing the quantum dot material, such a thermoplastic film is not particularly limited, and known thermoplastic films, for example, disclosed in JP2001-174636A, JP2001-174809A, and the like are able to be used, and the contents of the literatures are incorporated in the present invention. In addition, specific examples of such a thermoplastic resin include a cellulose resin such as triacetyl cellulose, a polyester resin, a polyether sulfone resin, a polysulfone resin, a polycarbonate resin, a polyamide resin, a polyimide resin, a polyolefin resin, a (meth)acrylic resin, a cyclic polyolefin resin (a norbornene-based resin), a polyarylate resin, a polystyrene resin, a polyvinyl alcohol resin, and a mixture thereof.

In a case where the optical conversion sheet (D) including the fluorescent material described above is the adhesive layer in which the quantum dot material is dispersed, such an adhesive layer is not particularly limited, and an adhesive layer in which a quantum dot material and the like disclosed in JP2012-169271A, SID'12 DIGEST p. 895, JP2001-174636A, JP2001-174809A, JP2010-532005A, and the like are dispersed in a known adhesive layer is able to be used.

In the optical sheet member of the present invention, it is preferable that the optical conversion sheet emits the fluorescent light retaining at least a part of the polarization properties of the incidence light from the viewpoint of improving brightness and low power consumption. The quantum dot material described above is able to be used as the optical conversion sheet which is able to emit the fluorescent light retaining at least a part of the polarization properties of the incidence light. In addition, it is more preferable that a quantum rod type material disclosed in Non-Patent Literature (THE PHYSICAL CHEMISTRY LETTERS 2013, 4, 502-507) is able to be used from the viewpoint of retaining the polarization properties of the fluorescent light. Emitting the fluorescent light retaining at least a part of the polarization properties of the incidence light indicates that when excitation light having a degree of polarization of 99.9% is incident on the optical conversion sheet, the degree of polarization of the fluorescent light emitted from the optical conversion sheet is not 0%, and the degree of polarization is preferably 10% to 80%, is more preferably 80% to 99%, and is even more preferably 99% to 99.9%.

In the optical sheet member of the present invention, it is preferable that the optical conversion sheet (a fluorescent body dispersion sheet) includes a fluorescent material in which light exiting from the optical conversion sheet (a fluorescent body) includes linearly polarized light and circularly polarized light from the viewpoint of improving brightness and low power consumption. Examples of the fluorescent material in which the light exiting from the optical conversion sheet includes the linearly polarized light and the circularly polarized light are able to include the quantum dot material described above. In addition, the λ/4 plate described above is used in the fluorescent material emitting the circularly polarized light, and the linearly polarized light is obtained, and thus, it is possible to realize an optical sheet member which is excellent from the viewpoint of improving brightness.

In addition, in a case where the light exiting from the optical conversion sheet generally includes the linearly polarized light, it is preferable that the wavelength selective reflective polarizer is a linear polarization reflection polarizer. In addition, it is more preferable that a transmission axis of the polarizing plate described above (the polarizing plate on the BL side and an absorption type polarizing plate), a polarization axis (the linearly polarized light) of the optical conversion sheet described above, and a transmission axis of the linear polarization reflection polarizer described above are coincident with each other from the viewpoint of improving brightness.

The linear polarization reflection polarizer described above may function in the entire wavelength range of 380 nm to 780 nm, and it is preferable that the linear polarization reflection polarizer is a linear polarization reflection polarizer which reflects all or at least a part of light in a wavelength range of 380 nm to 480 nm. It is preferable that the linear polarization reflection polarizer described above is a dielectric multi-layer film which reflects light in the entire wavelength range of 380 nm to 780 nm, and it is more preferable that the linear polarization reflection polarizer is a dielectric multi-layer film which reflects (all or at least a part) of light in a wavelength range of 380 nm to 480 nm. In addition, the linear polarization reflection polarizer described above may be a reflection polarizer including a λ/4 plate on at least one surface of a light reflection layer formed by immobilizing a cholesteric liquid crystalline phase which reflects light in the entire wavelength range of 380 nm to 780 nm, and it is preferable that the linear polarization reflection polarizer is a linear polarization reflection polarizer including a λ/4 plate on at least one surface of a light reflection layer formed by immobilizing a cholesteric liquid crystalline phase which reflects (all or at least a part) of light in a wavelength range of 380 nm to 480 nm. In FIG. 16, an embodiment is illustrated in which in an embodiment where light exiting from an optical conversion sheet 15R containing a quantum rod material includes linearly polarized light, and the polarizing plate 1 on the BL side further includes the wavelength selective reflective polarizer 13 which is a linear polarization reflection polarizer, the λ/4 plate 12 is disposed on both sides of the wavelength selective reflective polarizer 13 in which the brightness enhancement film 11 described above is a light reflection layer formed by immobilizing a cholesteric liquid crystalline phase.

In addition, a more preferred embodiment of the wavelength selective reflective polarizer will be described below in the description of the brightness enhancement film including the wavelength selective reflective polarizer.

(Oxygen Gas Barrier Layer)

In the optical sheet member of the present invention, it is preferable that the optical conversion sheet described above includes an oxygen gas barrier layer, and it is more preferable that a fluorescent material member in which the fluorescent material described above is dispersed in a polymer matrix is included between two base films (also referred to as a substrate and a substrate film) on which an oxygen gas barrier layer is disposed. The oxygen gas barrier layer is a film having a gas barrier function of blocking oxygen. It is preferable that the oxygen gas barrier layer has a function of blocking water vapor. Hereinafter, the oxygen gas barrier layer will be referred to as a barrier film, and the oxygen gas barrier layer is identical to the barrier film.

It is preferable that the barrier film is included in the optical conversion sheet as a layer which is adjacent to or directly in contact with the wavelength conversion layer described above containing the fluorescent material. In addition, one or two or more barrier films may be included in the optical conversion sheet, and it is preferable that the optical conversion sheet has a structure in which the barrier film, the wavelength conversion layer described above containing the fluorescent material, and the barrier film are laminated in this order.

The wavelength conversion layer described above containing the fluorescent material may be formed by using the barrier film as a substrate. In addition, the barrier film is able to be used in any one of a substrate on one surface of the wavelength conversion layer described above containing the fluorescent material and a substrate on the other surface of the wavelength conversion layer described above containing the fluorescent material, or is able to be used in both of the substrates. When both of the surfaces on one surface and the other surface of the wavelength conversion layer described above containing the fluorescent material are the barrier films, the barrier films may be identical to each other or different from each other.

Any known barrier film may be used as the barrier film, and for example, the following barrier film may be used.

In general, the barrier film may include at least an inorganic layer, or may be a film including a substrate film and an inorganic layer. The substrate film can be referred to that in the above description with respect to the support. The barrier film may include a barrier laminated body including at least one inorganic layer and at least one organic layer on the substrate film. By laminating a plurality of layers, it is possible to further increase barrier properties. On the other hand, the light transmittance of the optical conversion sheet tends to decrease as the number of layers to be laminated increases, and thus, it is desirable that the number of layers to be laminated increases within a range of enabling excellent light transmittance to be maintained. Specifically, in the barrier film, it is preferable that the total light transmittance in a visible light range is greater than or equal to 80%, and oxygen permeability is less than or equal to 1 cm³/(m²·day·atm). Here, the oxygen permeability described above is a value measured by using an oxygen gas transmittance measurement device (Product Name: OX-TRAN 2/20, manufactured by MOCON Inc.) under conditions of a measurement temperature of 23° C. and relative humidity of 90%. In addition, the visible light range indicates a wavelength range of 380 nm to 780 nm, and the total light transmittance indicates the average value of the light transmittance in the visible light range.

The oxygen permeability of the barrier film is preferably less than or equal to 0.1 cm³/(m²·day·atm), and is more preferably less than or equal to 0.01 cm³/(m²·day·atm). The total light transmittance in the visible light range is more preferably greater than or equal to 90%. It is preferable that the oxygen permeability decreases, and it is preferable that the total light transmittance in the visible light range increases.

—Inorganic Layer—

The “inorganic layer” is a layer containing an inorganic material as a main component, and preferably is a layer formed only of an inorganic material. In contrast, the organic layer is a layer containing an organic material as a main component, and preferably is a layer containing an organic material of preferably greater than or equal to 50 mass %, more preferably greater than or equal to 80 mass %, and particularly preferably greater than or equal to 90 mass %.

The inorganic material configuring the inorganic layer is not particularly limited, and for example, metal or various inorganic compounds such as an inorganic oxide, a nitride, and an oxynitride are able to be used as the inorganic material configuring the inorganic layer. Silicon, aluminum, magnesium, titanium, tin, indium, and cerium are preferable as an element configuring the inorganic material, and one type or two or more types of the elements may be contained. Specific examples of the inorganic compound are able to include silicon oxide, silicon oxynitride, aluminum oxide, magnesium oxide, titanium oxide, tin oxide, indium alloy oxide, silicon nitride, aluminum nitride, and titanium nitride. In addition, a metal film, for example, an aluminum film, a silver film, a tin film, a chromium film, a nickel film, and a titanium film may be disposed as the inorganic layer.

In the materials described above, the silicon nitride, the silicon oxide, or the silicon oxynitride is particularly preferable. This is because the inorganic layer formed of such materials has excellent adhesiveness with respect to the organic layer, and thus, it is possible to further increase barrier properties.

A forming method of the inorganic layer is not particularly limited, and for example, various film formation methods are able to be used in which a film formation material is able to be evaporated and scattered, and thus, is able to be sedimented on a surface to be vapor-deposited.

Examples of the forming method of the inorganic layer include a physical vapor deposition method such as a vacuum vapor deposition method in which an inorganic material such as an inorganic oxide, an inorganic nitride, an inorganic oxynitride, and metal is heated and vapor-deposited; an oxide reaction vapor deposition method in which an inorganic material is used as a raw material, is oxidized by introducing oxygen gas, and thus, is vapor-deposited; a sputtering method in which an inorganic material is used as a target raw material, is sputtered by introducing argon gas and oxygen gas, and thus, is vapor-deposited; and an ion plating method in which an inorganic material is heated by a plasma beam generated from a plasma gun, and thus, is vapor-deposited, a plasma chemical vapor deposition method in which an organic silicon compound is used as a raw material in a case of forming a vapor deposition film of silicon oxide, and the like. The vapor deposition may be performed with respect to the surface of a substrate such as a support, a substrate film, an optical conversion sheet, and an organic layer.

The thickness of the inorganic layer, for example, is in a range of 1 nm to 500 nm, is preferably in a range of 5 nm to 300 nm, and is more preferably in a range of 10 nm to 150 nm. This is because it is possible to suppress reflection on the inorganic layer while realizing excellent barrier properties, and it is possible to provide an optical conversion sheet having higher light transmittance, by setting the film thickness of the inorganic layer to be in the range described above.

It is preferable that the optical conversion sheet includes at least one inorganic layer which is adjacent to the wavelength conversion layer, and preferably, is directly in contact with the wavelength conversion layer. It is preferable that the inorganic layer is directly in contact with both surfaces of the wavelength conversion layer.

—Organic Layer—

The organic layer can be referred to that disclosed in paragraphs 0020 to 0042 of JP2007-290369A and paragraphs 0074 to 0105 of JP2005-096108A. Furthermore, it is preferable that the organic layer contains a Cardo polymer. Accordingly, adhesiveness between the organic layer and the adjacent layer, in particular, adhesiveness between the organic layer and the inorganic layer becomes excellent, and thus, more excellent gas barrier properties are able to be realized. The details of the Cardo polymer can be referred to that disclosed in paragraphs 0085 to 0095 of JP2005-096108A. The film thickness of the organic layer is preferably in a range of 0.05 μm to 10 μm, and more preferably in a range of 0.5 μm to 10 μm. In a case where the organic layer is formed by a wet coating method, the film thickness of the organic layer is in a range of 0.5 μm to 10 μm, and is preferably in a range of 1 μm to 5 μm. In addition, in a case where the organic layer is formed by a dry coating method, the film thickness of the organic layer is in a range of 0.05 μm to 5 μm, and is preferably in a range of 0.05 μm to 1 μm. This is because it is possible to make the adhesiveness with respect to the inorganic layer more excellent by setting the film thickness of the organic layer which is formed by the wet coating method or the dry coating method to be in the range described above.

The other details of the inorganic layer and the organic layer can be referred to those disclosed in JP2007-290369A, JP2005-096108A, and US2012/0113672A1.

The organic layer and the inorganic layer, two organic layers, or two inorganic layers may be bonded to each other by a known adhesive layer. It is preferable that the adhesive layer is rarely included, and it is more preferable that the adhesive layer is not included, from the viewpoint of improving light transmittance.

<Polarizing Plate>

Next, the polarizing plate will be described.

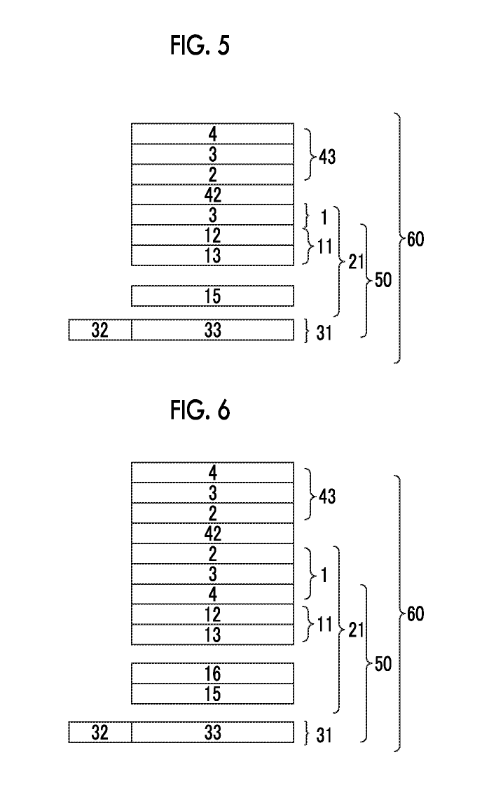

It is preferable that the optical sheet member of the present invention further includes the polarizing plate, and it is more preferable that the optical sheet member includes a backlight side polarizing plate in a case of being incorporated into the display device. In general, it is preferable that the polarizing plate is formed of a polarizer and two polarizing plate protective films (hereinafter, also referred to as a protective film) arranged on both sides of the polarizer, as with the polarizing plate used in the liquid crystal display device. In the present invention, it is preferable that a retardation film is used as a protective film arranged on a liquid crystal cell side in the two protective films. In FIG. 1, a polarizing plate 1 includes a polarizer 3. The polarizing plate 1 may or may not include a retardation film 2 on the surface of the polarizer 3 on a visible side, and it is preferable that the polarizing plate 1 includes the retardation film 2. The polarizing plate 1 may or may not include a polarizing plate protective film 4 on the surface of the polarizer 3 on a backlight unit 31 side. FIG. 5 illustrates an example of an embodiment in which the polarizing plate 1 does not include the retardation film 2 on the surface of the polarizer 3 on the visible side, and does not include the polarizing plate protective film 4 on the surface of the polarizer 3 on the backlight unit 31 side.

In a case of an embodiment (i) described below in which the wavelength selective reflective polarizer includes the light reflection layer formed by immobilizing the cholesteric liquid crystalline phase, the optical sheet member of the present invention further includes the polarizing plate, and it is preferable that the polarizing plate described above, the λ/4 plate described above, and the wavelength selective reflective polarizer described above are arranged in this order directly in contact with each other or through the adhesive layer. Further, in a case where the wavelength selective reflective polarizer has the embodiment (i) described below, the polarizing plate described above includes the polarizer and at least one polarizing plate protective film, and the polarizer described above, the polarizing plate protective film described above, the wavelength selective reflective polarizer described above are laminated in this order directly in contact with each other or through the adhesive layer, and the polarizing plate protective film described above is a λ/4 plate satisfying Expression (1) described below; further, wavelength dispersion of the λ/4 plate may be forward dispersion “Re(450)> Re(550)”, and preferably flat dispersion “Re(450)≅Re(550)”, and more preferably reverse dispersion “Re(450)<Re(550)” is able to be used.

450 nm/4−60 nm<Re(450)<450 nm/4+60 nm Expression (1)

(In Expression (1), Re(λ) represents retardation (unit: nm) in an in-plane direction at a wavelength of λ nm)

It is more preferable that a λ/4 plate (C) satisfying Expression (1) described above satisfies Expression (1′) described below.

450 nm/4−25 nm<Re(450)<450 nm/4+25 nm Expression (1′)

It is particularly preferable that the λ/4 plate (C) satisfying Expression (1) described above satisfies Expression (1″) described below.

450 nm/4−15 nm<Re(450)<450 nm/4+15 nm Expression (1″)

FIG. 4 illustrates an example of a display device in which the polarizer 3, the polarizing plate protective film, and the wavelength selective reflective polarizer 13 are laminated directly in contact with each other, and the polarizing plate protective film is the λ/4 plate 12.

On the other hand, in a case where of an embodiment (ii) described below in which the wavelength selective reflective polarizer includes the dielectric multi-layer film, it is preferable that the optical sheet member of the present invention further includes the polarizing plate, the polarizing plate described above and the wavelength selective reflective polarizer described above are laminated directly in contact with each other or through the adhesive layer.

(Polarizer)

It is preferable that the polarizer described above is a linear polarizer. In addition, it is preferable that the polarizer described above is an absorption polarizer. It is more preferable that the polarizer described above is a linear absorption polarizer.

It is preferable that a polarizer in which iodine is adsorbed and aligned on a polymer film is used as the polarizer described above. The polymer film described above is not particularly limited, and various polymer films are able to be used. Examples of the polymer film include a hydrophilic polymer film such as a polyvinyl alcohol-based film, a polyethylene terephthalate-based film, an ethylene-vinyl acetate copolymer-based film, a partially saponification film thereof, and a cellulose-based film, an polyene-based alignment film of a dehydration treatment product of polyvinyl alcohol or a dehydrochlorination treatment product of polyvinyl chloride, and the like. Among them, it is preferable that the polyvinyl alcohol-based film having excellent dyeability of iodine is used as the polarizer (A).

Polyvinyl alcohol or a derivative thereof is used as the material of the polyvinyl alcohol-based film described above. Examples of the derivative of the polyvinyl alcohol include polyvinyl formal, polyvinyl acetal, and the like, and olefin such as ethylene and propylene, an unsaturated carboxylic acid such as an acrylic acid, a methacrylic acid, and a crotonic acid, and alkyl ester thereof, and an acrylamide-modified derivative.

The degree of polymerization of the polymer which is the material of the polymer film described above is generally 500 to 10,000, is preferably in a range of 1000 to 6000, and is more is preferably in a range of 1400 to 4000. Further, in a case of a saponification film, the degree of saponification, for example, is preferably greater than or equal to 75 mol %, is more preferably greater than or equal to 98 mol %, and is more preferably in a range of 98.3 mol % to 99.8 mol %, from the viewpoint of solubility with respect to water.

The polymer film (an unstretched film) described above is subjected to at least a monoaxial stretching treatment and an iodine dyeing treatment according to a normal method. Further, a boric acid treatment and a washing treatment are able to be performed. In addition, the polymer film (a stretched film) which has been subjected to the treatment described above is subjected to a drying treatment and becomes the polarizer according to a normal method.

A stretching method in the monoaxial stretching treatment is not particularly limited, either a wet stretching method or a dry stretching method is able to be adopted. Examples of stretching means of the dry stretching method include an inter-roll stretching method, a heating roll stretching method, a compression stretching method, and the like. The stretching is able to be performed in a multi-stage. In the stretching means described above, in general, the unstretched film is in a heating state. A stretching ratio of the stretched film is able to be set according to the purpose, and the stretching ratio (the total stretching ratio) is approximately 2 times to 8 times, is preferably 3 times to 7 times, and is more preferably 3.5 times to 6.5 times.

The iodine dyeing treatment, for example, is performed by dipping the polymer film into an iodine solution containing iodine and potassium iodide. In general, the iodine solution is an aqueous solution of iodine, and contains iodine and potassium iodide as a dissolution aid. An iodine concentration is approximately 0.01 mass % to 1 mass %, and preferably 0.02 mass % to 0.5 mass %, and a potassium iodide concentration is approximately 0.01 mass % to 10 mass %, and is preferably 0.02 mass % to 8 mass %.

In the iodine dyeing treatment, in general, the temperature of the iodine solution is approximately 20° C. to 50°, and is preferably 25° C. to 40° C. In general, a dipping time is approximately 10 seconds to 300 seconds, and is preferably in a range of 20 seconds to 240 seconds. In the iodine dyeing treatment, an iodine content and a potassium content in the polymer film are adjusted to be in the range described below by adjusting conditions such as the concentration of the iodine solution, the dipping temperature of the polymer film in the iodine solution, and the dipping time. The iodine dyeing treatment may be performed before the monoaxial stretching treatment, during the monoaxial stretching treatment, or after the monoaxial stretching treatment.

In consideration of optical properties, the iodine content of the polarizer described above, for example, is in a range of 2 mass % to 5 mass %, and is preferably in a range of 2 mass % to 4 mass %.

It is preferable that the polarizer described above contains potassium. The potassium content is preferably in a range of 0.2 mass % to 0.9 mass %, and is more preferably in a range of 0.5 mass % to 0.8 mass %. The polarizer contains potassium, and thus, it is possible to obtain a polarizing film having a preferred composite modulus of elasticity (Er) and a high degree of polarization. The potassium, for example, is able to be contained by dipping the polymer film which is a forming material of the polarizer into a solution containing potassium. The solution described above may function as a solution containing iodine.

A known drying method in the related art such as natural drying, air drying, and heating drying is able to be used as the drying treatment step. For example, in the heating drying, a heating temperature is approximately 20° C. to 80° C., and a drying time is approximately 1 minute to 10 minutes. In addition, in the drying treatment step, the stretching is able to be suitably performed.

The thickness of the polarizer is not particularly limited, and the thickness of the polarizer is generally 5 μm to 300 μm, is preferably 10 μm to 200 μm, and is more preferably 20 μm to 100 μm.

In the optical properties of the polarizer, single body transmittance at the time of being measured by a polarizer (A) single body is preferably greater than or equal to 43%, and is more preferably in a range of 43.3% to 45.0%. In addition, it is preferable that orthogonal transmittance measured by preparing two polarizers (A) described above, and by superposing the two polarizers (A) such that an angle between absorption axes of the two polarizers (A) is 90° is small, and practically, the orthogonal transmittance is preferably greater than or equal to 0.00% and less than or equal to 0.050%, and is more preferably less than or equal to 0.030%. Practically, the degree of polarization is preferably greater than or equal to 99.90% and less than or equal to 100%, and is particularly preferably greater than or equal to 99.93% and less than or equal to 100%. Even in a case where the optical properties of the polarizing plate are measured, it is preferable that approximately the same optical properties as those described above are able to be obtained.

A manufacturing method of the polarizer is not limited to that described above, and examples of the manufacturing method of the polarizer include a method in which a thin polarizing plate is prepared by performing iodine dyeing after coating PET with PVA, and by performing stretching, and a coating type polarizing plate manufacturing method in which a polarizing plate is formed by performing an alignment treatment with respect to a transparent support, and then, by aligning a dichroic pigment, and the effects of the present invention are able to be attained without being affected by the manufacturing method of the polarizing plate.

(Polarizing Plate Protective Film)

The optical sheet member of the present invention may or may not include the polarizing plate protective film on a side of the polarizer opposite to the liquid crystal cell. In a case where the optical sheet member does not include the polarizing plate protective film on the side of the polarizer opposite to the liquid crystal cell, the reflection polarizer described below may be directly disposed on the polarizer or may be disposed on the polarizer through the adhesive agent. In addition, the polarizing plate protective film may function as the λ/4 layer of the present invention, and may or may not function as a part of the λ/4 layer which is realized by being laminated. In addition, in a case where the optical member sheet of the present invention is bonded to the polarizing plate, a part or all of the optical member sheet of λ/4 or the like is able to function as one protective film of the polarizing plate.

In the polarizing plate protective film described above, a thermoplastic resin having excellent transparency, mechanical strength, thermal stability, moisture blocking properties, and isotropy is used as the protective film arranged on the side opposite to the liquid crystal cell. Specific examples of such a thermoplastic resin include a cellulose resin of triacetyl cellulose, a polyester resin, a polyether sulfone resin, a polysulfone resin, a polycarbonate resin, a polyamide resin, a polyimide resin, a polyolefin resin, a (meth)acrylic resin, a cyclic polyolefin resin (a norbornene-based resin), a polyarylate resin, a polystyrene resin, a polyvinyl alcohol resin, and a mixture thereof.

The cellulose resin is ester of cellulose and a fatty acid. Specific examples of such a cellulose ester-based resin include triacetyl cellulose, diacetyl cellulose, tripropyl cellulose, dipropyl cellulose, and the like. Among them, the triacetyl cellulose is particularly preferable. Various products are commercially available as the triacetyl cellulose, and are advantageous from the viewpoint of easy obtainability and cost. Examples of a commercially available product of a triacetyl cellulose (TAC) film include “UV-50”, “UV-80”, “SH-80”, “TD-80U”, “TD-TAC”, and “UZ-TAC” (Product Name), manufactured by Fujifilm Corporation, “KC SERIES” manufactured by Konica Minolta, Inc., and the like.

It is possible to prepare a thinner optical sheet member by using a cellulose acylate-based film having a thickness of preferably less than or equal to 40 μm, and more preferably less than or equal to 25 μm.

Specific examples of the cyclic polyolefin resin preferably include a norbornene-based resin. The cyclic olefin-based resin is a general term of a resin which is polymerized by using cyclic olefin as polymerization unit, and examples of the cyclic olefin-based resin include resins disclosed in JP1989-240517A (JP-H01-240517A), JP1991-14882A (JP-H03-14882A), JP1991-122137A (JP-H03-122137A), and the like. Specific examples of the cyclic olefin-based resin include a ring opening (co)polymer of cyclic olefin, an addition polymer of cyclic olefin, a copolymer of cyclic olefin and alpha-olefin such as ethylene and propylene (representatively, a random copolymer), and a graft polymer in which the polymers are modified by an unsaturated carboxylic acid or a derivative thereof, a hydride thereof, and the like. Specific examples of the cyclic olefin include a norbornene-based monomer.

Various products are commercially available as the cyclic polyolefin resin. Specific example of the cyclic polyolefin resin include “ZEONEX” and “ZEONOR” (Product Name) manufactured by Zeon Corporation, “ARTON” (Product Name) manufactured by JSR Corporation, “TOPAS” (Product Name) manufactured by TICONA GmbH, and “APEL” (Product Name) manufactured by Mitsui Chemicals, Inc.

An arbitrary suitable (meth)acrylic resin is able to be adopted as the (meth)acrylic resin within a range not impairing the effects of the present invention. Examples of the (meth)acrylic resin include poly(meth)acrylic acid ester such as polymethyl methacrylate, methyl methacrylate-(meth)acrylic acid copolymer, a methyl methacrylate-(meth)acrylic acid ester copolymer, a methyl methacrylate-acrylic acid ester-(meth)acrylic acid copolymer, a methyl (meth)acrylate-styrene copolymer (an MS resin and the like), and a polymer having an alicyclic hydrocarbon group (for example, a methyl methacrylate-cyclohexyl methacrylate copolymer, a methyl methacrylate-norbornyl (meth)acrylate copolymer, and the like). Preferably, examples of the (meth)acrylic resin include poly(meth)acrylic acid alkyl having 1 to 6 carbon atoms such as polymethyl (meth)acrylate. More preferably, examples of the (meth)acrylic resin include a methyl methacrylate-based resin having methyl methacrylate as a main component (50 mass % to 100 mass %, and preferably 70 mass % to 100 mass %).

Specific examples of the (meth)acrylic resin include ACRYPET VH or ACRYPET VRL20A manufactured by Mitsubishi Rayon Co., Ltd, a (meth)acrylic resin disclosed in JP2004-70296A which has a ring structure in the molecules, and a (meth)acrylic resin having high Tg which is obtained by cross-linking in the molecules or a cyclization reaction in the molecules.

A (meth)acrylic resin having a lactone ring structure is able to be used as the (meth)acrylic resin. This is because the (meth)acrylic resin having a lactone ring structure has high heat resistance, high transparency, and high mechanical strength which is obtained by biaxial stretching.

The thickness of the protective film is able to be suitably set, and in general, the thickness of the protective film is approximately 1 μm to 500 μm from the viewpoint of workability such as strength or handling, thin layer properties, and the like. In particular, the thickness of the protective film is preferably 1 μm to 300 μm, and is more preferably 5 μm to 200 μm. It is particularly preferable that the thickness of the protective film is 5 μm to 150 μm.

Re(λ) and Rth(λ) each represent in-plane retardation and retardation in a thickness direction at a wavelength of λ nm Re(λ) is measured by allowing light having a wavelength of λ nm to be incident in a film normal direction using KOBRA 21ADH or WR (manufactured by Oji Scientific Instruments). The measurement is able to be performed by manually replacing a wavelength selective filter or by converting a measured value with a program or the like in a case of selecting a measurement wavelength of λ nm. In a case where a film to be measured is denoted by a monoaxial index ellipsoid or a biaxial index ellipsoid, Rth(λ) is calculated by the following method. Furthermore, a part of the measurement method is used in measurement of an average tilt angle of discotic liquid crystal molecules on an alignment film side in an optical anisotropic layer described below and an average tilt angle on a side opposite to the alignment film side.

In Rth(λ), Re(λ) described above is measured at total 6 points by allowing the light having a wavelength of λ nm to be incident from directions respectively inclined in 10° step from a normal direction to 50° on one side with respect to the film normal direction in which an in-plane slow axis (determined by KOBRA 21ADH or WR) is used as an inclination axis (a rotational axis) (in a case where there is no slow axis, an arbitrary direction of a film plane is used as the rotational axis), and Rth(λ) is calculated by KOBRA 21ADH or WR on the basis of the measured retardation value, an assumed value of the average refractive index, and the input film thickness value. In the above description, in a case of a film having a direction in which a retardation value at a certain inclination angle is zero by using the in-plane slow axis as the rotational axis from the normal direction, a retardation value at an inclination angle greater than the inclination angle described above is changed to have a negative sign, and then, Rth(λ) is calculated by KOBRA 21ADH or WR. Furthermore, a retardation value is measured from two arbitrarily oblique directions by using the slow axis as the inclination axis (the rotational axis) (in a case where there is no slow axis, an arbitrary direction of the film plane is used as the rotational axis), and Rth is able to be calculated by Expression (A) described below and Expression (B) described below on the basis of the retardation value, an assumed value of the average refractive index, and the input film thickness value.

$$Re ( θ ) = [ nx - \frac{( ny \times nz )}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( θ )}{nx} ) )} \qquad Expression ( A )$$

Furthermore, Re(θ) described above indicates a retardation value in a direction inclined by an angle of θ° from the normal direction. In addition, in Expression (A), nx represents a refractive index in a slow axis direction in the plane, ny represents a refractive index in a direction orthogonal to nx in the plane, and nz represents a refractive index in a direction orthogonal to nx and ny. d represents a film thickness.

Rth=((nx+ny)/2−nz)×d Expression (B)

In a case where the film to be measured is a so-called film not having an optic axis which is not able to be denoted by a monoaxial index ellipsoid or a biaxial index ellipsoid, Rth(λ) is calculated by the following method. In Rth(λ), Re(λ) described above is measured at 11 points by allowing the light having a wavelength of λ nm to be incident from directions respectively inclined in 10° step from −50° to +50° with respect to the film normal direction in which the in-plane slow axis (determined by KOBRA 21ADH or WR) is used as the inclination axis (the rotational axis), and Rth(λ) is calculated by KOBRA 21ADH or WR on the basis of the measured retardation value, an assumed value of the average refractive index, and the input film thickness value. In addition, in the measurement described above, a catalog value of various optical films in a polymer handbook (JOHN WILEY&SONS, INC) is able to be used as the assumed value of the average refractive index. In a case where the value of the average refractive index is not known in advance, the value of the average refractive index is able to be measured by using an Abbe's refractometer. The value of the average refractive index of a main optical film will be exemplified as follows: cellulose acylate (1.48), a cycloolefin polymer (1.52), polycarbonate (1.59), polymethyl methacrylate (1.49), and polystyrene (1.59). The assumed values of the average refractive index and the film thickness are input, and thus, nx, ny, and nz are calculated by KOBRA 21ADH or WR.

Nz=(nx−nz)/(nx−ny) is further calculated by the calculated nx, ny, and nz.

Furthermore, herein, “visible light” indicates light in a range of 380 nm to 780 nm. In addition, herein, in a case where a measurement wavelength is not particularly described, the measurement wavelength is 550 nm, and the same applies to the measurement wavelength of Re or Rth in the table of the following examples. In addition, herein, an angle (for example, an angle of “90°” or the like), and a relationship thereof (for example “orthogonal”, “parallel”, “intersect at 45°”, and the like) include an error range which is allowable in the technical field belonging to the present invention. For example, the angle indicates a range of less than an exact angle ±10°, and an error with respect to the exact angle is preferably in a range of less than or equal to 5°, and is more preferably in a range of less than or equal to 3°.

Herein, a “slow axis” of a retardation film or the like indicates a direction in which a refractive index is maximized.

In addition, herein, numerical values, numerical ranges, and qualitative expressions (for example, “equivalent”, “equal”, and the like) indicating optical properties of each member such as a retardation region, a retardation film, and a liquid crystal layer are interpreted as indicating numerical values, numerical ranges, and properties including error which is generally allowable in a liquid crystal display device and the members used therein. In addition, herein, “front” indicates a normal direction with respect to a display surface, “front contrast (CR)” indicates contrast calculated from white brightness and black brightness measured in the normal direction of the display surface, and “view angle contrast (CR)” indicates contrast calculated from white brightness and black brightness measured in an oblique direction (for example, a direction defined as 60 degrees in a polar angle direction with respect to the display surface) inclined from the normal direction of the display surface.

(Adhesive Layer)

The polarizer (A) described above is able to be bonded to the protective film by suitably adopting an adhesive agent, a pressure sensitive adhesive agent, or the like according to the polarizer (A) and the protective film. The adhesive agent and an adhesion treatment method are not particularly limited, and for example, the adhesion is able to be performed through an adhesive agent formed of a vinyl polymer, or an adhesive agent formed of a water-soluble cross-linking agent of a vinyl alcohol-based polymer such as at least a boric acid or borax, glutaraldehyde or melamine, and an oxalic acid. The adhesive layer formed of the adhesive agent is formed as a coating dry layer of an aqueous solution, or the like, and a catalyst such as a cross-linking agent or other additives, and an acid is able to be compounded at the time of preparing the aqueous solution, as necessary. In particular, in a case where a polyvinyl alcohol-based polymer film is used as the polarizer (A), it is preferable that an adhesive agent containing a polyvinyl alcohol-based resin is used from the viewpoint of adhesiveness. Further, it is more preferable that an adhesive agent containing a polyvinyl alcohol-based resin having an acetoacetyl group is used from the viewpoint of improving durability.

The polyvinyl alcohol-based resin described above is not particularly limited, and it is preferable that the average degree of polymerization is approximately 100 to 3000, and the average degree of saponification is approximately 85 mol % to 100 mol %, from the viewpoint of adhesiveness. In addition, the concentration of the aqueous solution of the adhesive agent is not particularly limited, and the concentration of the aqueous solution of the adhesive agent is preferably 0.1 mass % to 15 mass %, and is more preferably 0.5 mass % to 10 mass %. The thickness of the adhesive layer described above is preferably approximately 30 nm to 1000 nm, and is more preferably 50 nm to 300 nm, in the thickness after being dried. In a case where the thickness is excessively thin, adhesion force becomes insufficient, and in a case where the thickness is excessively thick, a problem is likely to occur on the appearance.

A thermosetting resin such as a (meth)acrylic adhesive agent, urethane-based adhesive agent, an acrylic urethane-based adhesive agent, an epoxy-based adhesive agent, and a silicone-based adhesive agent, or an ultraviolet curable type resin is able to be used as other adhesive agents.

<Brightness Enhancement Film Including Wavelength Selective Reflective Polarizer>

The brightness enhancement film includes the wavelength selective reflective polarizer (preferably, immobilizing a cholesteric liquid crystalline phase), and the wavelength selective reflective polarizer is a wavelength selective reflective polarizer which functions in at least a part of a wavelength range of 380 nm to 480 nm. In a case where the wavelength selective reflective polarizer functions in a specific wavelength range, it is preferable that the wavelength selective reflective polarizer exhibits reflectivity having a ½ height of a reflectivity peak in the entire wavelength of the specific wavelength range. That is, it is preferable that a wavelength range with a half band width of the reflectivity peak is a reflection range in which the wavelength selective reflective polarizer functions.

The half band width of the reflectivity peak of the wavelength selective reflective polarizer is preferably less than or equal to 400 nm, more preferably less than or equal to 200 nm, and even more preferably less than or equal to 100 nm and greater than or equal to 15 nm.

By the brightness enhancement film having such a configuration, light in the first polarization state is able to be substantially reflected by the wavelength selective reflective polarizer, and light in the second polarization state is able to be substantially transmitted through the wavelength selective reflective polarizer described above, and thus, the light in the first polarization state which has been substantially reflected by the wavelength selective reflective polarizer is able to be recirculated by randomizing the direction and the polarization state using a reflection member described below (also referred to as a light guide device or an optical resonator), and the brightness of the image display device is able to be improved.

It is essential that the reflection polarizer of the related art has wider half band width of greater than or equal to 400 nm, and the reflection polarizer is commercialized for each company. However, according to more intensive studies of the present inventors, it has been found that blue light is able to be efficiently reused, and a considerable decrease in a QD concentration which is necessary for attaining sufficient brightness as quantum backlight is able to be obtained, by combining a wavelength selective reflective polarizer having a half band width of less than or equal to 400 nm, and preferably less than or equal to 200 nm and a λ/4 plate with quantum backlight using a blue light source and an optical conversion sheet. Further, the present inventors have found that in the wavelength selective reflective polarizer described above, a film between the optical conversion sheet described above and the wavelength selective reflective polarizer described above or the wavelength selective reflective polarizer has a reflection peak having reflectivity of greater than or equal to 60% in at least one range of ranges of 470 nm to 510 nm, 560 nm to 610 nm, and 660 nm to 780 nm, in which light is absorbed on CF, and thus, a light utilization rate decreases, in order to widen a color reproduction range (in order to decrease brightness) of the liquid crystal display device, and thus, the light is recycled by the optical conversion sheet (reconverted into a high wavelength), and the color reproduction range widens and the light utilization rate including the brightness is improved.

Here, the region of reflectivity of 60% is able to be realized by laminating a right twist layer and a left twist layer in a case where the light reflection layer formed by immobilizing the cholesteric liquid crystalline phase is used.

A cholesteric liquid crystal compound selectively reflects only light having a reflection center wavelength λ (λ=NP, here, n represents the average refractive index of a liquid crystal) based on a spiral cycle and a half band width Δλ (Δλ=PAN, here, ΔN represents anisotropy of a refractive index) based on the wavelength, and transmits light in other wavelength ranges.

For this reason, in the liquid crystal used in the light reflection layer which is formed by immobilizing the cholesteric liquid crystalline phase, approximately 0.06≦Δn≦0.5 is practical (a material disclosed in High Δn Liquid Crystal of JP2011-510915A is able to be used), and corresponds to a range of 15 nm to 150 nm in the half band width. In a case of preparing a light reflection layer by controlling a half band width of less than or equal to 200 nm, a pitch gradient method is able to be used in which a wide half band width is able to be realized by gradually changing not only single pitch but also the number of pitches in a spiral direction of the cholesteric liquid crystalline phase. The pitch gradient method is able to be realized by a method disclosed in Nature 378, 467-469 (1995) or JP4990426B.

In the optical sheet member of the present invention, the film thickness of the wavelength selective reflective polarizer of the brightness enhancement film is preferably 3 μm to 12 μm, is more preferably 5 μm to 10 μm, and is particularly preferably 6 μm to 9 μm.

It is preferable that the following embodiment of (i) or (ii) is preferable as the brightness enhancement film described above.

Embodiment (i): The wavelength selective reflective polarizer described above includes a light reflection layer formed by immobilizing a cholesteric liquid crystalline phase which reflects light in at least a part of the wavelength range of 380 nm to 480 nm, and the half band width of the reflection range of the light reflection layer described above is 15 nm to 400 nm (more preferably less than or equal to 200 nm, and even more preferably less than or equal to 100 nm). It is preferable that the wavelength selective reflective polarizer of the embodiment (i) includes a light reflection layer formed by immobilizing a cholesteric liquid crystalline phase which has a reflection center wavelength in at least one wavelength range of wavelength ranges of 380 nm to 480 nm, 500 nm to 570 nm, and 600 nm to 690 nm. It is preferable that an optical sheet member of the embodiment (i) further includes a λ/4 plate satisfying at least one of Expressions (1) to (3) described below, and it is more preferable that the optical sheet member of the embodiment (i) includes a λ/4 plate satisfying all of Expressions (1) to (3). Further, the wavelength dispersion of the λ/4 plate may be forward dispersion of “Re(380)> Re(450)”, flat dispersion of “Re(380)≅Re(450)”, or reverse dispersion of “Re(380)<Re(450)”, is preferably the flat dispersion of “Re(380)≅Re(450)” or the reverse dispersion of “Re(380)<Re(450)”, and is more preferably the reverse dispersion of “Re(380)<Re(450)”.

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

In Expressions (1) to (3), Re(λ) represents retardation in the in-plane direction at a wavelength of λ nm, and the unit of Re(λ) is nm.

Embodiment (ii): The wavelength selective reflective polarizer is a dielectric multi-layer film having a reflection range in at least a part of a wavelength range of 380 nm to 480 nm.

### Embodiment (i)

First, the embodiment (i) will be described.

The light reflection layer formed by immobilizing the cholesteric liquid crystalline phase is able to reflect at least one of right circularly polarized light or left circularly polarized light in a wavelength range in the vicinity of the reflection center wavelength thereof. In addition, the λ/4 plate is able to convert light having a wavelength of λ nm into linearly polarized light from circularly polarized light. According to the brightness enhancement film having a configuration such as the embodiment (i), light in the first polarization state (for example, right circularly polarized light) is able to be substantially reflected by the wavelength selective reflective polarizer, light in the second polarization state (for example, left circularly polarized light) is able to be substantially transmitted through the wavelength selective reflective polarizer described above, and light in the second polarization state (for example, left circularly polarized light) which has been transmitted through the wavelength selective reflective polarizer described above is able to be converted into linearly polarized light by the λ/4 plate satisfying Expressions (1) to (4) and is able to be substantially transmitted through a polarizer (a linear polarizer) of the polarizing plate described above.

—Wavelength Selective Reflective Polarizer—

In the embodiment (i), it is preferable that the wavelength selective reflective polarizer described above is a wavelength selective reflective polarizer including a light reflection layer formed by immobilizing a cholesteric liquid crystalline phase which has a reflection range in at least a part of a wavelength range of 380 nm to 480 nm, and has a half band width of 15 nm to 400 nm, preferably less than or equal to 200 nm, and more preferably less than or equal to 100 nm. The wavelength selective reflective polarizer described above may be a light reflection layer formed by immobilizing a cholesteric liquid crystalline phase having a single pitch, may be a lamination of light reflection layers formed by immobilizing cholesteric liquid crystalline phases having plurality of different pitches in a reflection range, or may be a light reflection layer formed by immobilizing pitch gradient type cholesteric liquid crystalline phase in which a reflection range width is controlled by changing a pitch in a layer.

It is preferable that the wavelength selective reflective polarizer described above includes only one light reflection layer as the light reflection layer formed by immobilizing the cholesteric liquid crystalline phase, that is, it is preferable that the wavelength selective reflective polarizer described above does not include the other light reflection layer formed by immobilizing a cholesteric liquid crystalline phase, from the viewpoint of decreasing the film thickness of the brightness enhancement film described above.

FIG. 1 illustrates an embodiment in which a light reflection layer formed by immobilizing a cholesteric liquid crystalline phase, which is a wavelength selective reflective polarizer, is laminated on the λ/4 plate 12 satisfying at least one of Expressions (1) to (3) through an adhesive layer (not illustrated). Here, the present invention is not limited to such a specific example, the light reflection layer described above may be directly in contact with the λ/4 plate satisfying at least one of Expressions (1) to (3). In addition, the λ/4 plate 12 satisfying at least one of Expressions (1) to (3) may be a single-layer, or may be a laminated body of two or more layers, and it is preferable that the λ/4 plate 12 is a laminated body of two or more layers. In particular, it is more preferable that a λ/4 retardation layer is a (approximately optically monoaxial or biaxial) retardation film, or a retardation film including one or more liquid crystal layers which contain a liquid crystal compound (for example, at least one of a discotic liquid crystal, a rod-like liquid crystal, or a cholesteric liquid crystal) formed by polymerizing a liquid crystal monomer exhibiting a nematic phase or a smectic phase. In addition, a retardation film which is subjected to at least one stretching of TD stretching, MD stretching, and 45-degree stretching is able to be selected as the retardation film, and in consideration of manufacturability, a retardation film formed by performing 45-degree stretching with respect to a cyclic polyolefin resin (a norbornene-based resin) in which a Roll to Roll process is able to be performed, and a retardation film including a liquid crystal layer containing a liquid crystal compound (a rod-like liquid crystal and a DLC vertical liquid crystal) in which a transparent film is subjected to an alignment treatment, alignment is performed at a 45-degree azimuth with respect to an MD direction of the film are preferable.

It is preferable that the light reflection layer has a reflection range at least in a wavelength range of 380 nm to 480 nm, and has a half band width of 15 nm to 400 nm, preferably less than or equal to 200 nm, and more preferably less than or equal to 100 nm.

It is preferable that the light reflection layer has a reflection range at least in a wavelength range of 430 nm to 470 nm, and has a half band width of 15 nm to 400 nm, preferably less than or equal to 200 nm, and more preferably less than or equal to 100 nm.

A wavelength providing a peak (that is, a reflection center wavelength) is able to be adjusted by changing the pitch or the refractive index of a cholesteric liquid crystal layer, and the pitch is able to be easily changed by changing the added amount of a chiral agent. Specifically, the details are disclosed in Fuji Film Research & Development No. 50 (2005) pp. 60-63.

A manufacturing method of the light reflection layer formed by immobilizing the cholesteric liquid crystalline phase, which is used in the embodiment (i), is not particularly limited, and for example, methods disclosed in JP1989-133003A (JP-H01-133003A), JP3416302B, JP3363565B, and JP1996-271731A (JP-H08-271731A) are able to be used, and the contents of the publications are incorporated in the present invention. Hereinafter, a method disclosed in JP1996-271731A (JP-H08-271731A) will be described.

When the light reflection layers formed by immobilizing the cholesteric liquid crystalline phase described above are superposed, it is preferable that the light reflection layers are used in a combination reflecting circular polarization in the same direction. Accordingly, it is possible to prevent all phase states of the circular polarization reflected on each of the layers from being in different polarization states in each wavelength range, and it is possible to increase utilization efficiency of light.

On the other hand, in the optical sheet member of the present invention, it is preferable that a light reflection member further arranged between the optical conversion sheet described above and the wavelength selective reflective polarizer described above or the wavelength selective reflective polarizer described above has a wavelength range of reflectivity of greater than or equal to 60% in at least one wavelength range of wavelength ranges of 470 nm to 510 nm, 560 nm to 610 nm, and 660 nm to 780 nm. In this case, in order to have a wavelength range of reflectivity of greater than or equal to 60% in at least one wavelength range of wavelength ranges of 470 nm to 510 nm, 560 nm to 610 nm, and 660 nm to 780 nm, it is preferable to have a reflection peak in a desired wavelength range. The wavelength selective reflective polarizer is able to easily have a reflection peak in at least one wavelength range of wavelength ranges of 470 nm to 510 nm, 560 nm to 610 nm, and 660 nm to 780 nm by laminating light reflection layers formed by immobilizing a right twist cholesteric liquid crystalline phase and a left twist cholesteric liquid crystalline phase in a desired wavelength range.

Furthermore, an embodiment is also preferable in which the optical sheet member of the present invention has light absorption properties in at least one wavelength range of wavelength ranges of 470 nm to 510 nm, 560 nm to 610 nm, and 660 nm to 780 nm. In a case of this embodiment, examples of the embodiment in which the wavelength selective reflective polarizer has light absorption properties in at least one wavelength range of wavelength ranges of 470 nm to 510 nm, 560 nm to 610 nm, and 660 nm to 780 nm are able to include an embodiment in which the light absorption member of described below is integrated with the wavelength selective reflective polarizer by forming the light absorption directly on the wavelength selective reflective polarizer or by forming the light absorption on the wavelength selective reflective polarizer through an adhesive layer. Preferred embodiments of the light absorption member will be described below.

A suitable cholesteric liquid crystal may be used as the cholesteric liquid crystal, and is not particularly limited. It is advantageous that a liquid crystal polymer is used from the viewpoint of superposition efficiency, a reduction in the thickness, or the like of the liquid crystal layer. In addition, it is preferable that birefringence of cholesteric liquid crystal molecules increases since a wavelength range of selective reflection widens.

For example, a suitable liquid crystal polymer such as a main chain type liquid crystal polymer such as polyester, a side chain type liquid crystal polymer formed of an acrylic main chain or a methacrylic main chain, a siloxane main chain, and the like, a nematic liquid crystal polymer containing a low molecular chiral agent, a liquid crystal polymer into which a chiral component is introduced, and a mixture of a nematic-based liquid crystal polymer and a cholesteric-based liquid crystal polymer is able to be used as the liquid crystal polymer described above. A liquid crystal polymer having a glass transition temperature of 30° C. to 150° C. is preferable from the viewpoint of handleability or the like.

The cholesteric liquid crystal layer is able to be formed by a suitable method such as a method of performing direct coating with respect to a polarization separation plate through a suitable alignment film such as an oblique vapor deposition layer of polyimide, polyvinyl alcohol, or SiO, as necessary, and a method of performing coating with respect to a support formed of transparent film or the like, which does not deteriorate at an alignment temperature of a liquid crystal polymer, through an alignment film, as necessary. A support having minimized retardation is preferably used as the support from the viewpoint of preventing a change in a polarization state. In addition, a superposition method of the cholesteric liquid crystal layer through the alignment film, or the like is able to be adopted.

Furthermore, the coating of the liquid crystal polymer is able to be performed by a method in which a liquid material such as a solution formed of a solvent or a melting liquid formed by heated is developed using a suitable method such as a roll coating method, a gravure printing method, or a spin coating method. It is preferable that the thickness of the cholesteric liquid crystal layer to be formed is 0.5 μm to 100 μm from the viewpoint of selective reflectivity, preventing alignment disorder or transmittance decrease, or the like.

—λ/4 Plate—

In the embodiment (i), the brightness enhancement film includes the λ/4 plate satisfying at least one of Expressions (1) to (3) described below between the polarizer of the liquid crystal panel and the wavelength selective reflective polarizer, and preferably includes the λ/4 plate satisfying all of Expressions (1) to (3).

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

(In Expressions (1) to (3), Re(λ) represents retardation (unit: nm) in the in-plane direction at a wavelength of λ nm.)

It is preferable that the λ/4 plate described above satisfies at least one Expressions (1′) to (3′) described below, and it is more preferable that the λ/4 plate described above satisfies all of Expressions (1′) to (3′).

450 nm/4−25 nm<Re(450)<450 nm/4+25 nm Expression (1′)

550 nm/4−25 nm<Re(550)<550 nm/4+25 nm Expression (2′)

630 nm/4−25 nm<Re(630)<630 nm/4+25 nm Expression (3′)

It is particularly preferable that the λ/4 plate described above satisfies at least one of Expressions (1″) to (3″) described below, and it is more preferable that the λ/4 plate described above satisfies all of Expressions (1″) to (3″).

450 nm/4−15 nm<Re(450)<450 nm/4+15 nm Expression (1″)

550 nm/4−15 nm<Re(550)<550 nm/4+15 nm Expression (2″)

630 nm/4−15 nm<Re(630)<630 nm/4+15 nm Expression (3″)

(In Expressions (1) to (3″), Re(λ) represents retardation (unit: nm) in the in-plane direction at a wavelength of λ nm.)

In addition, in the brightness enhancement film of the present invention, it is preferable that the λ/4 plate described above satisfies Expression (4) described below.

Re(450)<Re(550)<Re(630) Expression (4)

(In Expression (4), Re(λ) represents retardation (unit: nm) in the in-plane direction at a wavelength of λ nm.)

For example, a method disclosed in JP1996-271731A (JP-H08-271731A) is able to be used as a manufacturing method of the λ/4 plate satisfying at least one of Expressions (1) to (3) which is used in the embodiment (i), and the contents of this publication is incorporated in the present invention. Hereinafter, the method disclosed in JP1996-271731A (JP-H08-271731A) will be described.

It is preferable that the λ/4 plate described above is an approximately optically monoaxial or biaxial retardation film, or a retardation film including one or more liquid crystal layers containing a liquid crystal compound.

Examples of a ¼ wavelength plate formed of a superposed body of the retardation film include a ¼ wavelength plate in which a plurality of retardation films which are a combination of a retardation film providing retardation of a ½ wavelength with respect to monochromatic light with a retardation film providing retardation of a ¼ wavelength with respect to monochromatic light are laminated such that optical axes thereof intersect with each other.

In the above-described case, by laminating a plurality of retardation films providing retardation of a ½ wavelength or a ¼ wavelength with respect to monochromatic light such that the optical axes intersect with each other, wavelength dispersion of the retardation defined as a product (Δnd) of a refractive index difference (Δn) of birefringent light and a thickness (d) is able to be superposed or modulated, and is able to be arbitrarily controlled, the wavelength dispersion is suppressed while controlling the entire retardation to be in a ¼ wavelength, and thus, it is possible to obtain a wavelength plate providing retardation of a ¼ wavelength over a wide wavelength range.

In the above description, the number of laminated retardation films is arbitrary. It is general that 2 to 5 retardation films are laminated from the viewpoint of transmittance of light, or the like. In addition, an arrangement position between the retardation film providing retardation of a ½ wavelength and the retardation film providing retardation of a ¼ wavelength is also arbitrary.

In addition, in a case where retardation of light having a wavelength of 450 nm is set to R₄₅₀, and retardation of light having a wavelength of 550 nm is set to R₅₅₀, the ¼ wavelength plate formed of the superposed body of the retardation film is able to be obtained as a ¼ wavelength plate in which a retardation film having large retardation, that is, R₄₅₀/R₅₅₀ of 1.00 to 1.05, and a retardation film having small retardation, that is, R₄₅₀/R₅₅₀ of 1.05 to 1.20, are laminated such that the optical axes thereof intersect with each other.

In the above-described case, the retardation films having different retardation laminated such that the optical axes thereof intersect with each other, in particular, such that the optical axes are orthogonal to each other, and thus, the wavelength dispersion of the retardation in each of the retardation films is able to be superposed or modulated, and is able to be controlled, and in particular, it is possible to reduce the retardation as being close to a short wavelength side.

For reference, specific examples of the ¼ wavelength plate described above include a ¼ wavelength plate in which a retardation film (retardation in light having a wavelength of 550 nm:700 nm) formed by performing a stretching treatment with respect to a polyvinyl alcohol film and a retardation film (retardation in light having a wavelength of 550 nm:560 nm) formed by performing a stretching treatment with respect to a polycarbonate film are laminated such that the optical axes are orthogonal to each other, and the like. Such a laminated product approximately functions as a ¼ wavelength plate over a wavelength of 450 nm to 650 nm.

The λ/4 plate may be an optical anisotropic support having a desired λ/4 function in the support itself, or may include an optical anisotropic layer or the like on a support formed of a polymer film.

In a case where the λ/4 plate is the optical anisotropic support having a desired λ/4 function in the support itself, for example, the optical anisotropic support is able to be obtained by a method in which the polymer film is subjected to a monoaxial or biaxial stretching treatment, or the like. The type of polymer is not particularly limited, a polymer having excellent transparency is preferably used. Examples of the polymer having excellent transparency include the materials used in the λ/4 plate, a cellulose acylate film (for example, a cellulose triacetate film (a refractive index of 1.48), a cellulose diacetate film, a cellulose acetate butyrate film, and a cellulose acetate propionate film), polyolefin such as polyethylene and polypropylene, a polyester resin-based film such as polyethylene terephthalate and polyethylene naphthalate, a polyacrylic resin film such as a polyether sulfone film and a polymethyl methacrylate, a polyurethane-based resin film, a polyester film, a polycarbonate film, a polysulfone film, a polyether film, a polymethyl pentene film, a polyether ketone film, a (meth)acrylonitrile film, polyolefin, a polymer having an alicyclic structure (a norbornene-based resin (ARTON: Product Name, manufactured by JSR Corporation), amorphous polyolefin (ZEONEX: Product Name, manufactured by Zeon Corporation)), and the like. Among them, the triacetyl cellulose, the polyethylene terephthalate, and the polymer having an alicyclic structure are preferable, and the triacetyl cellulose is particularly preferable.

It is preferable that the lamination is performed such that the direction of linearly polarized light transmitted through the λ/4 plate which is used in the present invention is parallel to a transmission axis direction of (the polarizer of) the backlight side polarizing plate.

As described below, an angle between a slow axis direction of the λ/4 plate and an absorption axis direction of the polarizing plate is 30° to 60°, is preferably 35° to 55°, is more preferably 40° to 50°, and is particularly preferably 45°. In a case where the polarizing plate is prepared by a roll to roll process, in general, a longitudinal direction (a transport direction) is an absorption axis direction, and thus, it is preferable that an angle between the slow axis direction of the λ/4 plate and the longitudinal direction is 30° to 60°.

It is preferable that in the lamination of the polarizing plate and the λ/4 plate of the brightness enhancement film, the polarizing plate is bonded to the λ/4 plate by the roll to roll process using an adhesive agent from the viewpoint of manufacturing efficiency. When the polarizing plate is bonded to the λ/4 plate by the roll to roll process, the λ/4 side of the brightness enhancement film may be directly bonded to the polarizer without using the polarizer protective film on the backlight unit side of the polarizing plate.

In addition, there are various definitions with respect to the spiral structure of the cholesteric liquid crystalline phase and the polarization state of light, but in the present invention, in a case where light is transmitted through the light reflection layer formed by immobilizing the cholesteric liquid crystalline phase, the λ/4 plate, and the polarizing plate in this order, arrangement in which brightness is maximized is preferable.

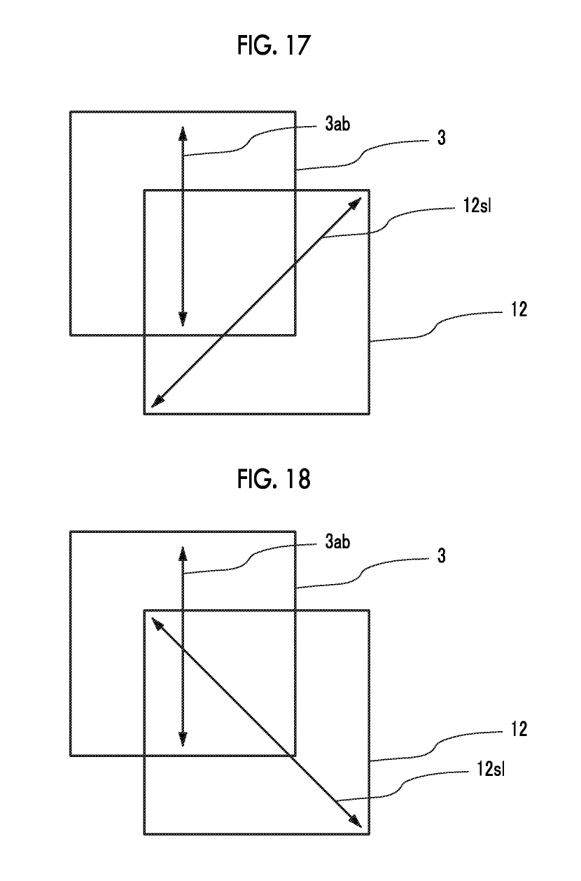

Accordingly, in a case of using the arrangement in which brightness is maximized, it is necessary that light exiting from the light reflection layer formed by immobilizing the cholesteric liquid crystalline phase is coincident with a transmission axis of the backlight side polarizing plate in a case where the direction of the spiral structure of the light reflection layer formed by immobilizing the cholesteric liquid crystalline phase is a right spiral (a light reflection layer formed by immobilizing a cholesteric liquid crystalline phase using a right chiral material described in examples herein). For this reason, in a case where the direction of the spiral structure of the light reflection layer formed by immobilizing the cholesteric liquid crystalline phase in the examples herein is a right spiral, as illustrated in FIG. 17, it is necessary that a slow axis direction 12sl of the λ/4 plate has the angle described above in a clockwise direction from an absorption axis direction 3ab of the polarizer when seen from the backlight side. In contrast, in a case where the direction of the spiral structure of the light reflection layer formed by immobilizing the cholesteric liquid crystalline phase is a left spiral, as illustrated in FIG. 18, it is necessary that the slow axis direction 12sl of the λ/4 plate has the angle described above in the counterclockwise direction from the absorption axis direction 3ab of the polarizer when seen from the backlight side.

A manufacturing method of the λ/4 plate in which the angle between the slow axis direction and the longitudinal direction is 30° to 60° is not particularly limited insofar as an alignment axis of a polymer is inclined at a desired angle by being continuously stretched in a direction at 30° to 60° with respect to the longitudinal direction, and a known method is able to be adopted as the manufacturing method. In addition, a stretching machine used in oblique stretching is not particularly limited, but a known tenter stretching machine of the related art is able to be used in which a feeding force or pulling force, or a taking off force having speeds different in right and left is able to be applied in a horizontal direction or a vertical direction. In addition, examples of a tenter type stretching machine include a horizontally monoaxial stretching machine, a simultaneously biaxial stretching machine, and the like, but the tenter type stretching machine is not particularly limited insofar as a long film is able to be continuously subjected to an oblique stretching treatment, and various types of stretching machines are able to be used.

For example, methods disclosed in JP1975-83482A (JP-S50-83482A), JP1990-113920A (JP-H02-113920A), JP1991-182701A (JP-H03-182701A), JP2000-9912A, JP2002-86554A, JP2002-22944A, and WO2007/111313A are able to be used as a method of the oblique stretching.

In a case where the λ/4 plate include the optical anisotropic layer or the like on the support formed of the polymer film, other layers are laminated on the support, and thus, a desired λ/4 function is obtained. The configuration material of the optical anisotropic layer is not particularly limited, but the optical anisotropic layer may be a layer which is formed of a composition containing a liquid crystal compound and exhibits optical anisotropy expressed by aligning molecules of the liquid crystal compound or a layer which has optical anisotropy expressed by stretching a polymer film and by aligning the polymer in the film, or may be both of the layers. That is, the optical anisotropic layer is able to be configured of one or two or more biaxial films, and is also able to be configured of a combination of two or more monoaxial films such as a combination of a C plate and an A plate. Naturally, the optical anisotropic layer is able to be configured of a combination of one or more biaxial films and one or more monoaxial films.

in particular, a retardation film having R₄₅₀/R₅₅₀ of 1.00 to 1.05, for example, is able to be formed by using a polymer or the like having an absorption end on a wavelength in the vicinity of 200 nm, such as a polyolefin-based polymer, a polyvinyl alcohol-based polymer, a cellulose acetate-based polymer, a polyvinyl chloride-based polymer, and a polymethyl methacrylate-based polymer.

In addition, a retardation film having R₄₅₀/R₅₅₀ of 1.05 to 1.20, for example, is able to be formed by using a polymer or the like having an absorption end on a wavelength side longer than 200 nm, such as a polycarbonate-based polymer, a polyester-based polymer, a polysulfone-based polymer, a polyether sulfone-based polymer, and a polystyrene-based polymer.

On the other hand, a plate prepared as a laminated body of a λ/2 plate and a λ/4 plate described below is also able to be used as the λ/4 plate (C) satisfying Expressions (1) to (4) which is used in the embodiment (i).

The optical anisotropic layer used as the λ/2 plate and the λ/4 plate described above will be described. The retardation film of the present invention may include the optical anisotropic layer, the optical anisotropic layer is able to be formed of one type of curable composition having a liquid crystal compound as a main component or a plurality of types thereof, and among the liquid crystal compound, a liquid crystal compound having a polymerizable group is preferable, and a liquid crystal compound formed of one type of curable composition described above is preferable.

A λ/4 plate which used in the λ/4 plate (C) satisfying Expressions (1) to (4) may be an optical anisotropy support which itself has a desired λ/4 function, or may include an optical anisotropic layer or the like on a support formed of a polymer film. That is, in the latter case, a desired λ/4 function is obtained by laminating other layers on the support. The configuration material of the optical anisotropic layer is not particularly limited, but the optical anisotropic layer is formed of a composition containing a liquid crystal compound, and the optical anisotropic layer may be a layer exhibiting optical anisotropy expressed by aligning the molecules of the liquid crystal compound, may be a layer having optical anisotropy expressed by stretching the polymer film and by aligning the polymer in the film, or may include both of the layers. That is, the optical anisotropic layer is able to be configured of one or two or more biaxial films, and is able to be configured of a combination of two or more monoaxial films, such as a combination of a C plate and an A plate. Naturally, the optical anisotropic layer is able to be configured of a combination of one or more biaxial films and one or more monoaxial films.

Here, the “λ/4 plate” used in the λ/4 plate (C) satisfying Expressions (1) to (4) indicates an optical anisotropic layer of which the in-plane retardation Re(λ) at a specific wavelength of λ nm satisfies Re(λ)=λ/4. The expression described above may be attained at any one wavelength (for example, 550 nm) in a visible range, and the in-plane retardation Re(550) at a wavelength of 550 nm is preferably 115 nm Re(550) 155 nm, and is more preferably 120 nm to 145 nm. It is preferable that the in-plane retardation Re(550) at a wavelength of 550 nm is in this range since light leakage of reflected light is able to be reduced to the extent of being invisible at the time of being combined with the λ/2 plate described below.

A λ/2 plate which used in the λ/4 plate (C) satisfying Expressions (1) to (4) may be an optical anisotropy support which itself has a desired λ/2 function, or may include an optical anisotropic layer or the like on a support formed of a polymer film. That is, in the latter case, a desired λ/2 function is obtained by laminating other layers on the support. The configuration material of the optical anisotropic layer is not particularly limited, but the optical anisotropic layer is formed of a composition containing a liquid crystal compound, and the optical anisotropic layer may be a layer exhibiting optical anisotropy expressed by aligning the molecules of the liquid crystal compound, may be a layer having optical anisotropy expressed by stretching the polymer film and by aligning the polymer in the film, or may include both of the layers. That is, the optical anisotropic layer is able to be configured of one or two or more biaxial films, and is able to be configured of a combination of two or more monoaxial films, such as a combination of a C plate and an A plate. Naturally, the optical anisotropic layer is able to be configured of a combination of one or more biaxial films and one or more monoaxial films.

Here, the “λ/2 plate” used in the λ/4 plate (C) satisfying Expressions (1) to (4) indicates an optical anisotropic layer of which the in-plane retardation Re(λ) at a specific wavelength of λ nm satisfies Re(λ)=λ/2. The expression described above may be attained at any one wavelength (for example, 550 nm) in a visible range. Further, in the present invention, in-plane retardation Re1 of the λ/2 plate is set to be substantially 2 times in-plane retardation Re2 of the λ/4 plate.

Here, the “retardation is substantially 2 times” indicates that Re1=2×Re2±50 nm Here, Re1=2×Re2±20 nm is more preferable, and Re1=2×Re2±10 nm is even more preferable. The expression described above may be attained at any one wavelength in a visible range, and it is preferable that the expression described above is attained at a wavelength of 550 nm According to the range described above, it is preferable since the light leakage of the reflected light is able to be reduced to the extent of being invisible at the time of being combined with the λ/4 plate.

A direction of linearly polarized light which has been transmitted through the λ/4 plate (C) is laminated to be parallel to a transmission axis direction of a backlight side polarizing plate.

In a case where the λ/4 plate (C) is a single layer, an angle between the slow axis direction of the λ/4 plate (C) and the absorption axis direction of the polarizing plate is 45°.

In a case where the λ/4 plate (C) is the laminated body of the λ/4 plate and the λ/2 plate, the angles between the slow axis directions of each of the λ/4 plate and the λ/2 plate and the absorption axis direction of the polarizing plate have the following positional relationship.

In a case where Rth of the λ/2 plate described above at a wavelength of 550 nm is negative, an angle between the slow axis direction of the λ/2 plate and the absorption axis direction of the polarizer described above is preferably in a range of 75°±8°, is more preferably in a range of 75°±6°, and is even more preferably in a range of 75°±3°. Further, at this time, the angle between the absorption axis direction of the polarizer layer described above and the slow axis direction of the λ/4 plate described above is preferably in a range of 15°±8°, is more preferably in a range of 15°±6°, and is even more preferably in a range of 15°±3°. According to the range described above, it is preferable since the light leakage of the reflected light is able to be reduced to the extent of being invisible.

In addition, in a case where Rth of the λ/2 plate described above at a wavelength of 550 nm is positive, the angle between the slow axis direction of the λ/2 plate and the absorption axis direction of the polarizer layer described above is preferably in a range of 15°±8°, is more preferably in a range of 15°±6°, and is even more preferably in a range of 15°±3° Further, at this time, the angle between the slow axis direction of the λ/4 plate described above and the absorption axis direction of the polarizer layer described above is preferably in a range of 75°±8°, is more preferably in a range of 75°±6°, and is even more preferably in a range of 75°±3°. According to the range described above, it is preferable since the light leakage of the reflected light is able to be reduced to the extent of being invisible.

The material of the optical anisotropic support which is used in the present invention is not particularly limited. Various polymer films, for example, a polyester-based polymer such as cellulose acylate, polycarbonate-based polymer, polyethylene terephthalate, or polyethylene naphthalate, an acrylic polymer such as polymethyl methacrylate, a styrene-based polymer such as polystyrene or an acrylonitrile-styrene copolymer (an AS resin), and the like are able to be used. In addition, a polymer film is prepared by using one type or two or more types of polymers which are selected from polyolefin such as polyethylene and polypropylene, a polyolefin-based polymer such as an ethylene-propylene copolymer, a cycloolefin polymer, a vinyl chloride-based polymer, an amide-based polymer such as nylon or aromatic polyamide, an imide-based polymer, a sulfone-based polymer, a polyether sulfone-based polymer, a polyether ether ketone-based polymer, a polyphenylene sulfide-based polymer, a vinylidene chloride-based polymer, a vinyl alcohol-based polymer, a vinyl butyral-based polymer, an arylate-based polymer, a polyoxy methylene-based polymer, an epoxy-based polymer, or a polymer in which the polymers described above are mixed as a main component, and the polymers are able to be used for preparing an optical film in a combination of satisfying the properties described above.

In a case where the λ/2 plate and the λ/4 plate are a laminated body of the polymer film (the transparent support) and the optical anisotropic layer, it is preferable that the optical anisotropic layer includes at least one layer formed of a composition containing a liquid crystal compound. That is, it is preferable that the λ/4 plate is a laminated body of the polymer film (the transparent support) and the optical anisotropic layer formed of the composition containing the liquid crystal compound. A polymer film having small optical anisotropy may be used in the transparent support, or a polymer film in which optical anisotropy is expressed by a stretching treatment or the like may be used. It is preferable that the support has light transmittance of greater than or equal to 80%.

The type of liquid crystal compound used for forming the optical anisotropic layer which may be included in the λ/2 plate and the λ/4 plate described above is not particularly limited. For example, an optical anisotropic layer which is obtained by forming a low molecular liquid crystal compound in nematic alignment in a liquid crystal state, and then, by immobilizing the alignment by photocross-linking or thermal cross-linking or an optical anisotropic layer which is obtained by forming a high molecular liquid crystal compound in nematic alignment in a liquid crystal state, and then, by immobilizing the alignment by cooling is able to be used. Furthermore, in the present invention, even when the liquid crystal compound is used in the optical anisotropic layer, the optical anisotropic layer is a layer formed by immobilizing the liquid crystal compound by polymerization or the like, and it is not necessary to exhibit liquid crystallinity any more after the layer is formed. A polymerizable liquid crystal compound may be a multifunctional polymerizable liquid crystal compound or a monofunctional polymerizable liquid crystal compound. In addition, the liquid crystal compound may be a discotic liquid crystal compound or a rod-like liquid crystal compound.

In general, the liquid crystal compound is able to be classified into a rod-like liquid crystal compound and a disk-like liquid crystal compound according to the shape thereof. Further, each of the rod-like liquid crystal compound and the disk-like liquid crystal compound has a low molecular type and a high molecular type. In general, the polymer indicates that the degree of polymerization is greater than or equal to 100 (Polymer Physics and Phase Transition Dynamics, written by Masao DOI, Page. 2, published by Iwanami Shoten, Publishers., 1992).

In the present invention, any liquid crystal compound is able to be used, and it is preferable to use the rod-like liquid crystal compound or the disk-like liquid crystal compound. Two or more types of rod-like liquid crystal compounds, two or more types of disk-like liquid crystal compounds, or a mixture of the rod-like liquid crystal compound and the disk-like liquid crystal compound may be used. It is more preferable that the rod-like liquid crystal compound or the disk-like liquid crystal compound having a reactive group is used for forming the optical anisotropic layer, and it is even more preferable that at least one of the rod-like liquid crystal compound or the disk-like liquid crystal compound has two or more reactive groups in liquid crystal molecules, from the viewpoint of enabling a change in temperature or humidity to decrease. The liquid crystal compound may be a mixture of two or more types of liquid crystal compounds, and in this case, it is preferable that at least one of the liquid crystal compounds has two or more reactive groups.

For example, a rod-like liquid crystal compound disclosed in JP1999-513019A (JP-H11-513019A) or JP2007-279688A is able to be preferably used as the rod-like liquid crystal compound, and for example, a discotic liquid crystal compound disclosed in JP2007-108732A or JP2010-244038A is able to be preferably used as the discotic liquid crystal compound, but the rod-like liquid crystal compound and the disk-like liquid crystal compound are not particularly limited, and it is preferable that the rod-like liquid crystal compound and the disk-like liquid crystal compound described below are used.

—Rod-Like Liquid Crystal Compound—

Azomethines, azoxys, cyanobiphenyls, cyanophenyl esters, benzoic acid esters, phenyl cyclohexane carboxylic acid esters, cyanophenyl cyclohexanes, cyano-substituted phenyl pyrimidines, alkoxy-substituted phenyl pyrimidines, phenyl dioxanes, trans, and alkenyl cyclohexyl benzonitriles are preferably used as the rod-like liquid crystal compound. It is possible to use not only low molecular liquid crystalline molecules described above but also high molecular liquid crystalline molecules.

It is more preferable that alignment is immobilized by polymerizing the rod-like liquid crystal compound, and compound disclosed in Makromol. Chem., Vol. 190, p. 2255 (1989), Advanced Materials, Vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-64627, and the like are able to be used as a polymerizable rod-like liquid crystal compound. Further, for example, a rod-like liquid crystal compound disclosed in JP1999-513019A (JP-H11-513019A) or JP2007-279688A is able to be preferably used as the rod-like liquid crystal compound.

—Disk-Like Liquid Crystal Compound—

Hereinafter, the light reflection layer formed by immobilizing the cholesteric liquid crystalline phase using the disk-like liquid crystal compound as the cholesteric liquid crystal material will be described.

A disk-like liquid crystal compound disclosed in JP2007-108732A or JP2010-244038A is able to be preferably used as the disk-like liquid crystal compound, but the disk-like liquid crystal compound is not limited thereto.

Hereinafter, a preferred example of the disk-like liquid crystal compound will be described, but the present invention is not limited thereto.

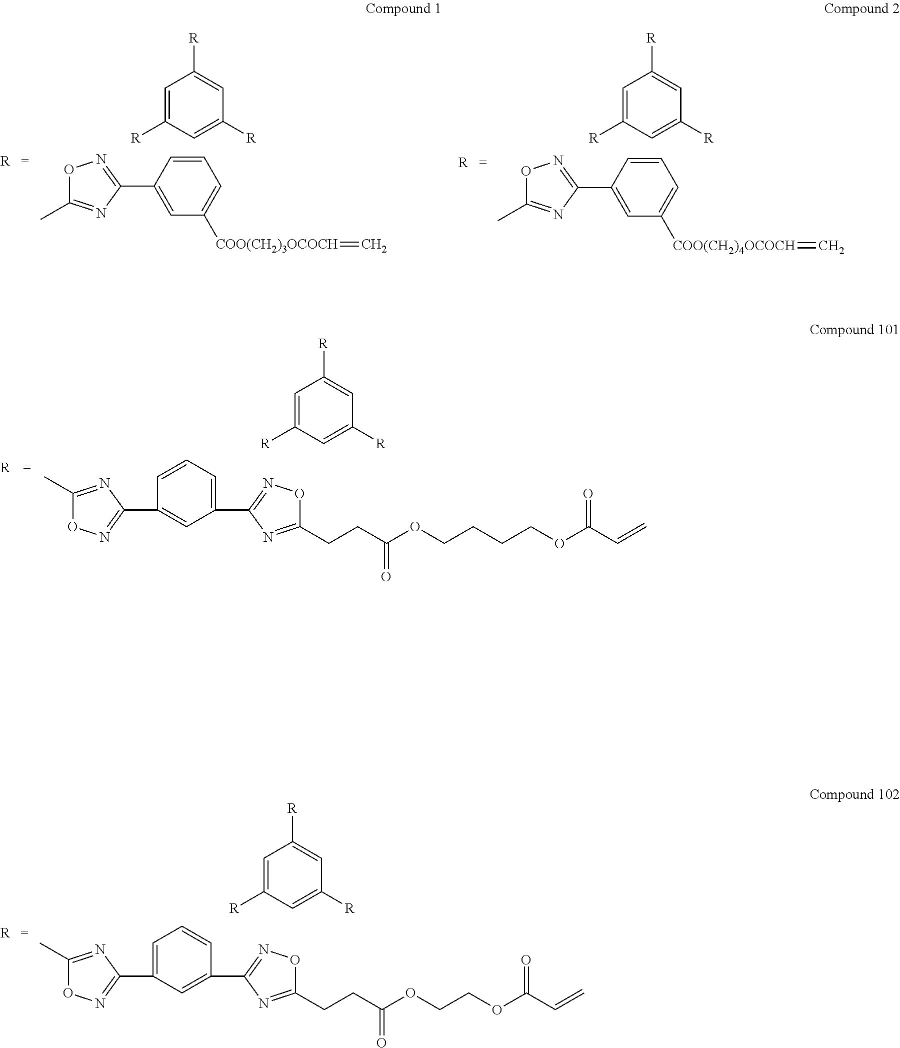

—Other Components—

A composition used for forming the light reflection layer formed by immobilizing the cholesteric liquid crystalline phase may contain other components such as a chiral agent, an alignment control agent, a polymerization initiator, and an alignment aid in addition to the cholesteric liquid crystal material.

The chiral agent described above is able to be selected from various known chiral agents (for example, a chiral agent disclosed in Liquid Crystal Device Handbook, Chapter 3, Section 4-3, a chiral agent for TN and STN, and a chiral agent disclosed in p. 199, Japan Society for the Promotion of Science edited by the 142nd committee in 1989). In general, the chiral agent includes an asymmetric carbon atom, but an axial asymmetric compound or a planar asymmetric compound which does not include the asymmetric carbon atom is also able to be used as the chiral agent. In an example of the axial asymmetric compound or the planar asymmetric compound, binaphthyl, helicene, paracyclophane, and a derivative thereof are included. The chiral agent may have a polymerizable group. In a case where the chiral agent has a polymerizable group and the rod-like liquid crystal compound used together also has a polymerizable group, a repeating unit derived from the rod-like liquid crystal compound and a polymer having a repeating unit derived from the chiral agent are able to be formed by a polymerization reaction between the chiral agent having a polymerizable group and a polymerizable rod-like liquid crystal compound. In this embodiment, it is preferable that the polymerizable group of the chiral agent having a polymerizable group is identical to the polymerizable group of the polymerizable rod-like liquid crystal compound. Accordingly, the polymerizable group of the chiral agent is preferably an unsaturated polymerizable group, an epoxy group, or an aziridinyl group, is more preferably an unsaturated polymerizable group, and is particularly preferably an ethylenically unsaturated polymerizable group.

In addition, the chiral agent described above may be a liquid crystal compound.

Examples of the chiral agent exhibiting a strong twisting force include chiral agents disclosed JP2010-181852A, JP2003-287623A, JP2002-80851A, JP2002-80478A, and JP2002-302487A, and the chiral agents are able to be preferably used in the present invention. Further, isomannide compounds having a corresponding structure are able to be used as isosorbide compounds disclosed in the publications, and isosorbide compounds having a corresponding structure are able to be used as isomannide compounds disclosed in the publications.

In an example of the alignment control agent described above, a compound exemplified in [0092] and [0093] of JP2005-99248A, a compound exemplified in [0076] to and [0082] to [0085] JP2002-129162A, a compound exemplified in [0094] and [0095] of JP2005-99248A, and a compound exemplified in [0096] of JP2005-99248A are included.

A compound denoted by General Formula (I) described below is preferable as a fluorine-based alignment control agent.

(Hb¹¹-Sp¹¹-L¹¹-Sp¹²-L¹²)ₘ₁₁-A¹¹-L¹³-T¹¹-L¹⁴-A¹²-(L¹⁵-Sp¹³-L¹⁶-Sp¹⁴-Hb¹¹)ₙ₁₁ General Formula (I)

In General Formula (I), L¹¹, L¹², L¹³, L¹⁴, L¹⁵, and L¹⁶ each independently represent a single bond, —O—, —S—, —CO—, —COO—, —COS—, —SCO—, —NRCO—, and —CONR— (in General Formula (I), R represents a hydrogen atom or an alkyl group having 1 to 6 carbon atoms), but —NRCO— and —CONR— have an effect of decreasing solubility and tend to increase a haze value at the time of forming a film, and thus, —O—, —S—, —CO—, —COO—, —OCO—, —COS—, and —SCO— are more preferable, and —O—, —CO—, —COO—, and —OCO— are even more preferable from the viewpoint of stability of the compound. The alkyl group of R described above may be a straight-chain alkyl group or a branched alkyl group. It is more preferable that the alkyl group has 1 to 3 carbon atoms, and a methyl group, an ethyl group, and an n-propyl group are able to be exemplified as the alkyl group.

Sp₁₁, Sp¹², Sp¹³, and Sp¹⁴ each independently represent a single bond or an alkylene group having 1 to 10 carbon atoms, more preferably represent a single bond or an alkylene group having 1 to 7 carbon atoms, and even more preferably represent a single bond or an alkylene group having 1 to 4 carbon atoms. Here, the hydrogen atom of the alkylene group may be substituted with a fluorine atom. The alkylene group may have or may not have a branch, and it is preferable that the alkylene group is a straight-chain alkylene group not having a branch. It is preferable that Sp¹¹ and Sp¹⁴ are identical to each other and Sp¹² and Sp¹³ are identical to each other from the viewpoint of synthesis.

A¹¹ and A¹² represent a trivalent or tetravalent aromatic hydrocarbon. The number of carbon atoms of the trivalent or tetravalent aromatic hydrocarbon group is preferably 6 to 22, is more preferably 6 to 14, is even more preferably 6 to 10, and is still more preferably 6. The trivalent or tetravalent aromatic hydrocarbon group represented by A¹¹ and A¹² may have a substituent group. Examples of such a substituent group are able to include an alkyl group having 1 to 8 carbon atoms, an alkoxy group, a halogen atom, a cyano group, or an ester group. The description and the preferred range of the groups can be referred to the description corresponding to T described below. Examples of the substituent group with respect to the trivalent or tetravalent aromatic hydrocarbon group represented by A¹¹ and A¹² are able to include a methyl group, an ethyl group, a methoxy group, an ethoxy group, a bromine atom, a chlorine atom, a cyano group, and the like. Molecules having a large amount of perfluoroalkyl portion in the molecules are able to align liquid crystals in a small added amount and cause a decrease in haze, and thus, it is preferable that A¹¹ and A¹² represent the tetravalent aromatic hydrocarbon group such that a large amount of perfluoroalkyl group is included in the molecules. It is preferable that A¹¹ and A¹² are identical to each other from the viewpoint of synthesis.

It is preferable that T¹¹ represents a bivalent group or a bivalent aromatic heterocyclic group (X included in T¹¹ described above represents an alkyl group having 1 to 8 carbon atoms, an alkoxy group, a halogen atom, a cyano group, or an ester group, and Ya, Yb, Yc, and Yd each independently represent a hydrogen atom or an alkyl group having 1 to 4 carbon atoms) denoted by

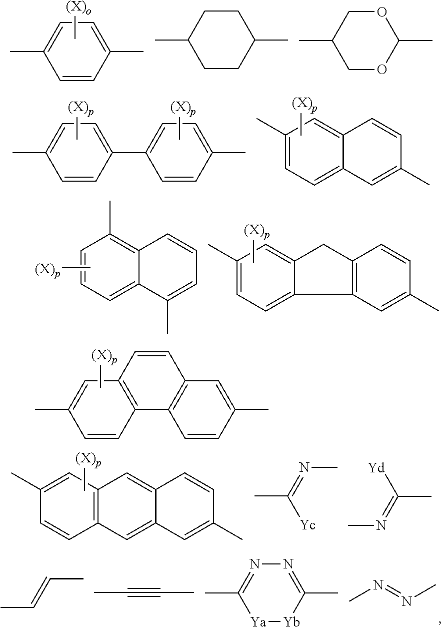

it is more preferable that T¹¹ represents

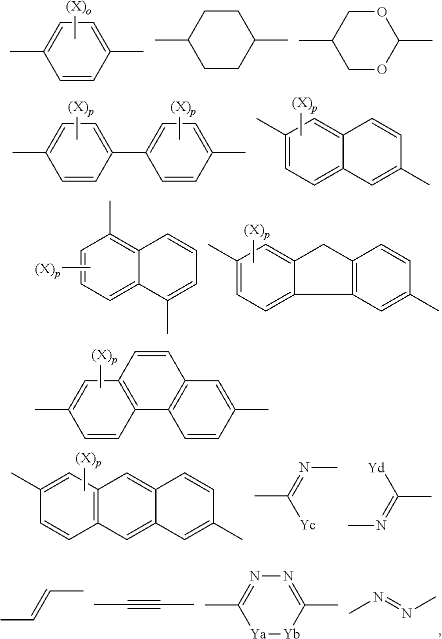

it is even more preferable that T¹¹ represents

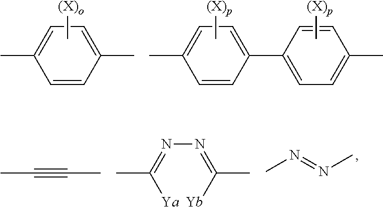

and it is still more preferable that T¹¹ represents

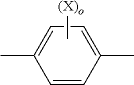

The number of carbon atoms of the alkyl group of X included in T¹¹ described above is 1 to 8, is preferably 1 to 5, and is more preferably 1 to 3. The alkyl group may be any one of a straight-chain alkyl group, a branched alkyl group, and a cyclic alkyl group, and the straight-chain alkyl group or the branched alkyl group is preferable. A methyl group, an ethyl group, an n-propyl group, an isopropyl group, and the like are able to be exemplified as a preferred alkyl group, and among them, the methyl group is preferable. An alkyl portion of the alkoxy group of X included in T¹¹ described above can be referred to the description and the preferred range of the alkyl group of X included in T¹¹ described above. Examples of the halogen atom of X included in T¹¹ described above are able to include a fluorine atom, a chlorine atom, a bromine atom, and an iodine atom, and the chlorine atom and the bromine atom are preferable. A group denoted by R′COO— is able to be exemplified as the ester group of X included in T¹¹ described above. Examples of R′ are able to include an alkyl group having 1 to 8 carbon atoms. The description and the preferred range of the alkyl group of R′ can be referred to the description and the preferred range of the alkyl group of X included in T¹¹ described above. Specific examples of ester are able to include CH₃COO— and C₂H₅COO—. The alkyl group having 1 to 4 carbon atoms of Ya, Yb, Yc, and Yd may be a straight-chain alkyl group or a branched alkyl group. For example, a methyl group, an ethyl group, an n-propyl group, an isopropyl group, and the like are able to be exemplified as the alkyl group.

It is preferable that the bivalent aromatic heterocyclic group has a 5-membered hetero ring, a 6-membered hetero ring, or a 7-membered hetero ring. The 5-membered ring or the 6-membered ring is more preferable, and the 6-membered ring is most preferable. A nitrogen atom, an oxygen atom, and a sulfur atom are preferable as a hetero atom configuring the hetero ring. It is preferable that the hetero ring is an aromatic hetero ring. In general, the aromatic hetero ring is an unsaturated hetero ring. It is more preferable that the unsaturated hetero ring is an unsaturated hetero ring having the maximum number of double bonds. Examples of the hetero ring include a furan ring, a thiophene ring, a pyrrole ring, a pyrroline ring, a pyrrolidine ring, an oxazole ring, an isooxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a thiopyrane ring, a pyridine ring, a piperidine ring, an oxazine ring, a morpholine ring, a thiazine ring, a pyridazine ring, a pyrimidine ring, a pyrazine ring, a piperazine ring, and a triazine ring. The bivalent heterocyclic group may have a substituent group. The description and the preferred range of such examples of the substituent group can be referred to the description and the disclosure of the substituent group of the trivalent aromatic hydrocarbon or the tetravalent aromatic hydrocarbon of A¹¹ and A¹² described above.

Hb¹¹ represents a perfluoroalkyl group having 2 to 30 carbon atoms, more preferable represents a perfluoroalkyl group having 3 to 20 carbon atoms, and even more preferable represents a perfluoroalkyl group having 3 to 10 carbon atoms. The perfluoroalkyl group may be any one of a straight-chain perfluoroalkyl group, a branched perfluoroalkyl group, and a cyclic perfluoroalkyl group, the straight-chain perfluoroalkyl group or the branched perfluoroalkyl group is preferable, and the straight-chain perfluoroalkyl group is more preferable.

m11 and n11 each independently represent an integer of 0 to 3, and m11+n11≧1. At this time, a plurality of structures within the parenthesis may be identical to each other or different from each other, it is preferable that the plurality of structures are identical to each other. In General Formula (I), m11 and n11 are determined according to the valence of A¹¹ and A¹², and the preferred range thereof is also determined according to the preferred range of the valence of A¹¹ and A¹².

o and p included in T¹¹ each independently represent an integer of greater than or equal to 0, and when o and p are greater than or equal to 2, a plurality of X's may be identical to each other or different from each other. It is preferable that o included in T¹¹ is 1 or 2. It is preferable that p included in T¹¹ is an integer of any one of 1 to 4, and it is more preferable that p is 1 or 2.

In the compound denoted by General Formula (I), a molecular structure may have symmetry or may not have symmetry. Furthermore, here, symmetry indicates symmetry which corresponds to any one of point symmetry, line symmetry, and rotational symmetry, and asymmetry indicates symmetry which does not correspond to any one of the point symmetry, the line symmetry, and the rotational symmetry.

The compound denoted by General Formula (I) is a compound in which the perfluoroalkyl group (Hb¹¹) described above, linking groups of -(-Sp-L¹¹-Sp¹²-L¹²)ₘ₁₁-A¹¹-L¹³- and -L¹⁴-A¹²-(L¹⁵-Sp¹³-L¹⁶-Sp¹⁴-)ₙ₁₁-, and preferably a compound combined with T which is a bivalent group having an excluded volume effect. It is preferable that two perfluoroalkyl groups (Hb¹¹) in the molecules are identical to each other, and the linking groups of -(-Sp¹¹-L¹¹-Sp¹²-L¹²)ₘ₁₁-A¹¹-L¹³- and -L¹⁴-A¹²-(L¹⁵-Sp¹³-L¹⁶-Sp¹⁴)ₙ₁₁- in the molecules are also identical to each other. It is preferable that Hb¹¹-Sp¹¹-L¹¹-Sp¹²- and -Sp¹³-L¹⁶-Sp¹⁴-Hb¹¹ on a terminal are groups denoted by any one of the following general formulas.

(CₐF₂ₐ₊₁)—(C_{b}H_{2b})—

(CₐF₂ₐ₊₁)—(C_{b}H_{2b})—O—(CᵣH₂ᵣ)—

(CₐF₂ₐ₊₁)—(C_{b}H_{2b})—COO—(CᵣH₂ᵣ)—

(CₐF₂ₐ₊₁)—(C_{b}H_{2b})—OCO—(CᵣH₂ᵣ)—

In the above description, a preferably represents 2 to 30, more preferably represents 3 to 20, and even more preferably represents 3 to 10. b preferably represents 0 to 20, more preferably represents 0 to 10, and even more preferably represents 0 to 5. a+b represents 3 to 30. r preferably represents 1 to 10, and more preferably represents 1 to 4.

In addition, it is preferable that Hb¹¹-Sp¹¹-L¹¹-Sp¹²-L¹²- and -L¹⁴-Sp¹³-L¹⁶-Sp¹⁴-Hb¹¹ on the terminal of General Formula (I) are groups denoted by any one of the following general formulas.

(CₐF₂ₐ₊₁)—(C_{b}H_{2b})—O—

(CₐF₂ₐ₊₁)—(C_{b}H_{2b})—COO—

(CₐF₂ₐ₊₁)—(C_{b}H_{2b})—O—(CᵣH₂ᵣ)—O—

(CₐF₂ₐ₊₁)—(C_{b}H_{2b})—COO—(CᵣH₂ᵣ)—COO—

(CₐF₂ₐ₊₁)—(C_{b}H_{2b})—OCO—(CᵣH₂ᵣ)—COO—

In the above description, the definition of a, b, and r is identical to the definition described above.

Examples of a photopolymerization initiator include an α-carbonyl compound (disclosed in each of the specifications of U.S. Pat. No. 2,367,661A and U.S. Pat. No. 2,367,670A), acyloin ether (disclosed in the specification of U.S. Pat. No. 2,448,828A), α-hydrocarbon-substituted aromatic acyloin compounds (disclosed in the specification of U.S. Pat. No. 2,722,512A), a polynuclear quinone compound (disclosed in each of the specifications of U.S. Pat. No. 3,046,127A and U.S. Pat. No. 2,951,758A), a combination of a triarylimidazole dimer and p-amino phenyl ketone (disclosed in the specification of U.S. Pat. No. 3,549,367A), an acridine compound and a phenazine compound (disclosed in JP1985-105667A (JP-S60-105667A) and in the specification of U.S. Pat. No. 4,239,850A) and an oxadiazole compound (disclosed in the specification of U.S. Pat. No. 4,212,970A), an acyl phosphine oxide compound (disclosed in JP1988-40799B (JP-S63-40799B), JP1993-29234B (JP-H05-29234B), JP1998-95788A (JP-H10-95788A), and JP1998-29997A (JP-H10-29997A)), and the like.

Solvent:

An organic solvent is preferably used as a solvent of a composition for forming each of the light reflection layers. Examples of the organic solvent include amide (for example, N,N-dimethyl formamide), sulfoxide (for example, dimethyl sulfoxide), a hetero ring compound (for example, pyridine), hydrocarbon (for example, benzene and hexane), alkyl halide (for example, chloroform and dichloromethane), ester (for example, methyl acetate and butyl acetate), ketone (for example, acetone, methyl ethyl ketone, and cyclohexanone), and ether (for example, tetrahydrofuran and 1,2-dimethoxyethane). The alkyl halide and the ketone are preferable. Two or more types of organic solvents may be used together.

The brightness enhancement film of the present invention includes the first light reflection layer, the second light reflection layer, and the third light reflection layer which are liquid crystal films formed by immobilizing a cholesteric liquid crystalline phase formed by polymerizing a mixture of a liquid crystal compound and the like which are cholesteric liquid crystal materials.

It is also preferable that the brightness enhancement film of the present invention includes the support, and may include the liquid crystal film formed by immobilizing the cholesteric liquid crystalline phase formed by polymerizing the mixture of the liquid crystal compound and the like which are the liquid crystal materials on the support. However, in the present invention, the liquid crystal film formed by immobilizing the cholesteric liquid crystalline phase may be formed by using the λ/4 plate itself included in the brightness enhancement film of the present invention as the support, and the liquid crystal film formed by immobilizing the cholesteric liquid crystalline phase may be formed by using the entire λ/4 plate formed on the support as the support.

On the other hand, the brightness enhancement film of the present invention may not include the support at the time of forming the first light reflection layer, the second light reflection layer, and the third light reflection layer, and for example, the first light reflection layer, the second light reflection layer, and the third light reflection layer are formed by using glass or a transparent film as the support at the time of forming the first light reflection layer, the second light reflection layer, and the third light reflection layer, and then, only the first light reflection layer, the second light reflection layer, and the third light reflection layer are peeled off from the support at the time of film formation and are used in the brightness enhancement film of the present invention. Furthermore, in a case where only the first light reflection layer, the second light reflection layer, and the third light reflection layer are peeled off from the support at the time of film formation after the first light reflection layer, the second light reflection layer, and the third light reflection layer are formed, it is preferable that the first light reflection layer, the second light reflection layer, and the third light reflection layer which have been peeled off are bonded to the adhesive layer by using a film in which the λ/4 plate and the adhesive layer (and/or a pressure sensitive adhesive material) are laminated, and thus, the brightness enhancement film of the present invention is formed.

In addition, it is preferable that a film in which the λ/4 plate and the first light reflection layer are formed on the support in this order and a film in which the third light reflection layer and the second light reflection layer are formed on the support in this order are bonded to each other by disposing the adhesive layer (and/or the pressure sensitive adhesive material) between the first light reflection layer and the second light reflection layer, and thus, brightness enhancement film of the present invention is formed. At this time, the support may be peeled off after the adhesion.

The first light reflection layer, the second light reflection layer, and the third light reflection layer which are used in the brightness enhancement film by being formed using a method of applying a mixture of liquid crystal compound and the like are able to be formed. The mixture of the liquid crystal compound and the like is applied onto the alignment layer, and the liquid crystal layer is formed, and thus, an optical anisotropy element is able to be prepared.

The light reflection layer formed by immobilizing the cholesteric liquid crystalline phase is formed by a suitable method such as a method of directly applying the mixture onto the λ/4 plate or other light reflection layers, as necessary, through a suitable alignment layer such as an oblique vapor deposition layer of polyimide or polyvinyl alcohol, and SiO, and a method of applying the mixture onto the support which is not modified at an alignment temperature of a liquid crystal and is formed of a transparent film or the like, as necessary, through the alignment layer. In addition, a method of superposing the cholesteric liquid crystal layer through the alignment layer, and the like are able to be adopted.

Furthermore, the mixture of the liquid crystal compound and the like is able to be applied by a suitable method such as a method of spreading a liquid material such as solution of a solvent or a melting liquid solvent due to heating using a roll coating method or a gravure printing method, a spin coating method, and the like. The liquid crystalline molecules are immobilized by maintaining the alignment state. It is preferable that the immobilizing is performed by a polymerization reaction of a polymerizable group which is introduced into the liquid crystalline molecules.

In the polymerization reaction, a thermal polymerization reaction using a thermal polymerization initiator and a photopolymerization reaction using a photopolymerization initiator are included. The photopolymerization reaction is preferable. It is preferable that an ultraviolet ray is used in light irradiation for polymerizing the liquid crystalline molecules. The irradiation energy is preferably 20 mJ/cm² to 50 J/cm², and is more preferably 100 mJ/cm² to 800 mJ/cm². In order to accelerate the photopolymerization reaction, the light irradiation may be performed under heating conditions. The thickness of the light reflection layer to be formed, which is formed by immobilizing the cholesteric liquid crystalline phase is preferably 0.1 μm to 100 μm, is more preferably 0.5 μm to 50 μm, is even more preferably 1 μm to 30 μm, and is most preferably 2 μm to 20 μm, from the viewpoint of preventing selective reflection properties, alignment disorder, a decrease in transmittance, and the like.

In a case where each of the light reflection layers of the brightness enhancement film of the present invention is formed by coating, it is preferable that the coating liquid described above is applied, and then, is dried by a known method and is solidified, and thus, each of the light reflection layers is formed. Drying due to heating is preferable as the drying method.

An example of the manufacturing method of each of the light reflection layers is a manufacturing method including at least
(1) applying a polymerizable liquid crystal composition onto the surface of the substrate or the like to be in a state of a cholesteric liquid crystalline phase, and
(2) irradiating the polymerizable liquid crystal composition described above with an ultraviolet ray to be subjected to a curing reaction, and forming each of the light reflection layers by immobilizing the cholesteric liquid crystalline phase.

Steps of (1) and (2) are repeated two times on one surface of the substrate, and thus, a laminated body of the light reflection layer formed by immobilizing the cholesteric liquid crystalline phase is able to be prepared in which the number of laminations increases.

Furthermore, a turning direction of the cholesteric liquid crystalline phase is able to be adjusted according to the type of liquid crystal to be used or the type of chiral agent to be added, a spiral pitch (that is, a selective reflection wavelength) is able to be adjusted by the concentration of the material. In addition, it is known that a wavelength in a specific region which is reflected on each of the light reflection layer is able to be shifted according to various factors of the manufacturing method, and is able to be shifted according to conditions and the like such as a temperature, irradiance, and an irradiation time at the time of immobilizing the cholesteric liquid crystalline phase in addition to the concentration of the chiral agent or the like to be added.

It is preferable that an undercoat layer is formed on the surface of the support such as a transparent plastic resin film by coating. At this time, a coating method is not particularly limited, and a known method is able to be used as the coating method.

The alignment layer is able to be disposed by means such as a rubbing treatment of an organic compound (preferably a polymer), an oblique vapor deposition of an inorganic compound, and formation of a layer having microgrooves. Further, an alignment layer which has an alignment function by applying an electric field, by applying a magnetic field, or by light irradiation is known. It is preferable that the alignment layer is formed by performing a rubbing treatment with respect to the surface of the film of the polymer. It is preferable that the alignment layer is peeled off along with the support.

Even in a case where the alignment layer is not disposed, the support is directly subjected to an alignment treatment (for example, a rubbing treatment) according to the type of polymer used in the support, and thus, the support is able to function as the alignment layer. Examples of such a support are able to include polyethylene terephthalate (PET).

In addition, in a case where a direct liquid crystal layer is laminated on the liquid crystal layer, the liquid crystal layer on the lower layer may align the liquid crystal on the upper layer which functions as the alignment layer. In this case, even in a case where the alignment layer is not disposed and even in a case where a special alignment treatment (for example, a rubbing treatment) is not performed, the liquid crystal on the upper layer is able to be aligned.

—Rubbing Treatment—

It is preferable that the surface of the alignment layer or the support is subjected to a rubbing treatment. In addition, the surface of the optical anisotropic layer, as necessary, is able to be subjected to a rubbing treatment. In general, the rubbing treatment is able to be performed by rubbing the surface of a film containing a polymer as a main component with paper or cloth in a constant direction. A general method of the rubbing treatment, for example, is disclosed in “Liquid Crystal Handbook” (published by Maruzen Company, Limited, Oct. 30, 2000).

A method disclosed in “Liquid Crystal Handbook” (published by Maruzen Company, Limited) is able to be used as a method of changing a rubbing density. A rubbing density (L) is able to be quantified by Expression (A) described below.

L=Nl(1+2πrn/60v) Expression (A)

In Expression (A), N represents the number of rubbing treatments, l represents a contact length of a rubbing roller, r represents the radius of the roller, n represents the number of rotations of the roller (rpm), and v represents stage shifting speed (per second).

In order to increase the rubbing density, the number of rubbing treatments may increase, the contact length of the rubbing roller may increase, the radius of the roller may increase, the number of rotations of the roller may increase, and the stage shifting speed may decrease, and in order to decrease the rubbing density, these factors are adjusted vice versa. In addition, conditions at the time of performing the rubbing treatment can be referred to conditions disclosed in JP4052558B.

In the step of (1) described above, first, the polymerizable liquid crystal composition described above is applied onto the surface of the support, the substrate, or the like, or the light reflection layer on the lower layer. It is preferable that the polymerizable liquid crystal composition described above is prepared as a coating liquid in which a material is dissolved and/or dispersed in a solvent. The coating liquid described above is applied by various methods such as a wire bar coating method, an extrusion coating method, a direct gravure coating method, a reverse gravure coating method, and a die coating method. In addition, the liquid crystal composition is ejected from a nozzle by using an ink jet device, and thus, a coated film is able to be formed.

Next, the polymerizable liquid crystal composition which is applied onto the surface, and thus, becomes the coated film is in a state of a cholesteric liquid crystalline phase. In an embodiment where the polymerizable liquid crystal composition described above is prepared as a coating liquid including a solvent, the solvent is removed by drying the coated film, and thus, the polymerizable liquid crystal composition may be in the state of the cholesteric liquid crystalline phase. In addition, in order to set a transition temperature with respect to the cholesteric liquid crystalline phase, as desired, the coated film described above may be heated. For example, first, the coated film is heated to the temperature of an isotropic phase, and then, is cooled to a cholesteric liquid crystalline phase transition temperature, and thus, it is possible to stably set the polymerizable liquid crystal composition in the state of the cholesteric liquid crystalline phase. The liquid crystalline phase transition temperature of the polymerizable liquid crystal composition described above is preferably in a range of 10° C. to 250° C., and is more preferably in a range of 10° C. to 150° C., from the viewpoint of manufacturing suitability or the like. In a case where the liquid crystalline phase transition temperature is lower than 10° C., a cooling step is necessary in order to decrease the temperature to a temperature range at which a liquid crystalline phase is exhibited. In addition, in a case where the liquid crystalline phase transition temperature is higher than 200° C., first, a high temperature is required in order to set the polymerizable liquid crystal composition in an isotropic liquid state of which the temperature is higher than the temperature range at which the crystalline phase is exhibited, and thus, setting the liquid crystalline phase transition temperature to be higher than 200° C. is disadvantageous from the viewpoint of waste of thermal energy, deformation of a substrate, modification, and the like.

Next, in the step of (2), the coated film which is in the state of the cholesteric liquid crystalline phase is irradiated with an ultraviolet ray, and thus, is subjected to a curing reaction. In ultraviolet irradiation, a light source such as an ultraviolet lamp is used. In this step, polymerizable liquid crystal composition described above is subjected to the curing reaction by being irradiated with the ultraviolet ray, and the cholesteric liquid crystalline phase is immobilized, and thus, the light reflection layer is formed.

The amount of irradiation energy of the ultraviolet ray is not particularly limited, but in general, it is preferable that the amount of irradiation energy is approximately 100 mJ/cm² to 800 mJ/cm². In addition, a time for irradiating the coated film described above with the ultraviolet ray is not particularly limited, and will be determined from the viewpoint of both of sufficient strength and productivity of a cured film.

In order to accelerate the curing reaction, the ultraviolet irradiation may be performed under heating conditions. In addition, it is preferable that temperature at the time of performing the ultraviolet irradiation is maintained to be in a temperature range at which the cholesteric liquid crystalline phase is exhibited such that the cholesteric liquid crystalline phase is not disordered. In addition, an oxygen concentration in the atmosphere relates to the degree of polymerization, and thus, a desired degree of polymerization is not obtained in the air, and in a case where the strength of the film is insufficient, it is preferable that the oxygen concentration in the atmosphere decreases by a method such as nitrogen substitution. The oxygen concentration is preferably less than or equal to 10%, is more preferably less than or equal to 7%, and is most preferably less than or equal to 3%. A reaction rate of the curing reaction (for example, a polymerization reaction) performed by the ultraviolet irradiation is preferably greater than or equal to 70%, is more preferably greater than or equal to 80%, and is even more preferably greater than or equal to 90%, from the viewpoint of maintaining mechanical strength of the layer or preventing an unreacted substance from being eluted from the layer. In order to enhance the reaction rate, a method of increasing the irradiation dose of the ultraviolet ray to be emitted or polymerization under a nitrogen atmosphere or under heating conditions is effective. In addition, a method in which first, the polymerization is performed, and then, the temperature is maintained in a high temperature state which is higher than the polymerization temperature, and thus, the reaction is further performed by a thermal polymerization reaction or a method in which the ultraviolet irradiation is performed again (here, the ultraviolet irradiation is performed in conditions satisfying the conditions of the present invention) is able to be used. The reaction rate is able to be measured by comparing absorption intensities of infrared vibration spectrums of a reactive group (for example, a polymerizable group) before and after the reaction.

In the step described above, the cholesteric liquid crystalline phase is immobilized, and thus, each of the light reflection layers is formed. Here, a state where the alignment of the liquid crystal compound in the cholesteric liquid crystalline phase is maintained is the most typical and preferred embodiment as the state where the liquid crystalline phase is “immobilized”. The state is not limited thereto, and specifically indicates a state where the shape of alignment is able to be stably and continuously maintained in a temperature range of generally 0° C. to 50° C., and in a temperature range of −30° C. to 70° C. under more rigorous conditions without fluidity in the layer or without a change in the shape of the alignment due to an external field or an external force. In the present invention, it is preferable that the alignment state of the cholesteric liquid crystalline phase is immobilized by the curing reaction which is performed by the ultraviolet irradiation.

Furthermore, in the present invention, it is sufficient, insofar as optical properties of the cholesteric liquid crystalline phase are maintained in the layer, and finally, it is not necessary that the liquid crystal composition of each of the light reflection layers exhibits liquid crystallinity anymore. For example, the liquid crystal composition has a high molecular weight due to the curing reaction, and thus, the liquid crystallinity may not be exhibited any more.

In the optical anisotropic layer described above, it is preferable that the molecules of the liquid crystal compound are immobilized in any one alignment state of a vertical alignment, a horizontal alignment, a hybrid alignment, and an oblique alignment. In order to prepare a retardation plate having symmetric view angle dependency, it is preferable that a disk surface of the discotic liquid crystal compound is substantially vertical to a film surface (the surface of the optical anisotropic layer), or a long axis of the rod-like liquid crystal compound is substantially horizontal to the film surface (the surface of the optical anisotropic layer). The discotic liquid crystal compound being substantially vertical to the film surface indicates that the average value of an angle between the film surface (the surface of the optical anisotropic layer) and the disk surface of the discotic liquid crystal compound is in a range of 70° to 90°. The average value of the angle is more preferably 80° to 90°, and is even more preferably 85° to 90°. The rod-like liquid crystal compound being substantially horizontal to the film surface indicates that an angle between the film surface (the surface of the optical anisotropic layer) and a director of the rod-like liquid crystal compound is in a range of 0° to 20°. The angle is more preferably 0° to 10°, and is even more preferably 0° to 5°.

In a case where the λ/2 plate and the λ/4 plate described above include the optical anisotropic layer containing the liquid crystal compound, the optical anisotropic layer may be formed of one layer, or may be a laminated body of two or more optical anisotropic layers.

The optical anisotropic layer described above is able to be formed by applying a coating liquid containing the liquid crystal compound such as the rod-like liquid crystal compound or the discotic liquid crystal compound, and as desired, a polymerization initiator or an alignment control agent described below, or other additives onto the support. It is preferable that the optical anisotropic layer is formed by forming the alignment film on the support, and by coating the surface of the alignment film with the coating liquid described above.

In the present invention, it is preferable that the molecules of the liquid crystal compound are aligned by coating the surface of the alignment film with the composition described above. The alignment film has a function of defining the alignment direction of the liquid crystal compound, and thus, it is preferable that the alignment film is used for realizing a preferred embodiment of the present invention. However, in a case where the liquid crystal compound is aligned, and then, the alignment state is immobilized, the alignment film has the function, and thus, it is not necessary that the alignment film is essential as a constituent of the present invention. That is, it is possible to prepare the polarizing plate of the present invention by transferring only the optical anisotropic layer on the alignment film in which the alignment state is immobilized onto a polarizing layer or the support. It is preferable that the alignment film is formed by a rubbing treatment of a polymer.

Examples of the polymer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxy methyl cellulose, polycarbonate, and the like disclosed in paragraph [0022] of the specification of JP1996-338913A (JP-H08-338913A). A silane coupling agent is able to be used as the polymer.

A water-soluble polymer (for example, poly(N-methylol acrylamide), carboxy methyl cellulose, gelatin, polyvinyl alcohol, and modified polyvinyl alcohol) is preferable, the gelatin, the polyvinyl alcohol, and the modified polyvinyl alcohol are more preferable, and the polyvinyl alcohol and the modified polyvinyl alcohol are most preferable. A treatment method which has been widely adopted as a liquid crystal alignment treatment step of LCD is able to be applied to the rubbing treatment described above. That is, a method is able to be used in which the alignment is able to be performed by rubbing the surface of the alignment film with paper or gauze, felt, rubber or nylon, polyester fiber, and the like in a constant direction. In general, the alignment is performed by rubbing the surface of the alignment film with cloth or the like in which fiber having even length and even thickness is flocked on average approximately a plurality of times.

A rubbing treatment surface of the alignment film is coated with the composition described above, and thus, the molecules of the liquid crystal compound are aligned.

After that, as necessary, the polymer of the alignment film reacts with a multifunctional monomer included in the optical anisotropic layer or the polymer of the alignment film is cross-linked by using a cross-linking agent, and thus, the optical anisotropic layer described above is able to be formed.

It is preferable that the film thickness of the alignment film is in a range of 0.1 μm to 10 μm.

In-plane retardation (Re) of the transparent support (the polymer film) supporting the optical anisotropic layer is preferably 0 nm to 50 nm, is more preferably 0 nm to 30 nm, and is even more preferably 0 nm to 10 nm. In a case where the in-plane retardation (Re) of the support is set to be in the range described above, it is preferable that the light leakage of the reflected light is able to be reduced to the extent of being invisible.

In addition, it is preferable that retardation (Rth) of the support in the thickness direction is selected according to a combination with the optical anisotropic layer disposed on or under the support. Accordingly, the light leakage of the reflected light and shading at the time of being observed from the oblique direction are able to be reduced.

Example of the polymer include a cellulose acylate film (for example, a cellulose triacetate film (a refractive index of 1.48), a cellulose diacetate film, a cellulose acetate butyrate film, a cellulose acetate propionate film), polyolefin such as polyethylene and polypropylene, a polyester-based resin film such as polyethylene terephthalate or polyethylene naphthalate, polyether sulfone film, a polyacrylic resin film such as a polyether sulfone film and polymethyl methacrylate, a polyurethane-based resin film, a polyester film, a polycarbonate film, a polysulfone film, a polyether film, a polymethyl pentene film, a polyether ketone film, a (meth)acrylonitrile film, polyolefin, and polymer having an alicyclic structure (a norbornene-based resin (ARTON: Product Name, manufactured by JSR Corporation), amorphous polyolefin (ZEONEX: Product Name, manufactured by Zeon Corporation)), and the like. Among them, the triacetyl cellulose, the polyethylene terephthalate, and the polymer having an alicyclic structure are preferable, and the triacetyl cellulose is particularly preferable.

A transparent support having a thickness of approximately 10 μm to 200 μm is able to be used, and the thickness of the transparent support is preferably 10 μm to 80 μm, and is more preferably 20 μm to 60 μm. In addition, the transparent support may be formed by laminating a plurality of layers. In order to suppress external light reflection, it is preferable that the thickness of the transparent support is thin, but in a case where the thickness is less than 10 μm, the strength of the film becomes weaker, and thus, setting the thickness to be less than 10 μm does not tend to be preferable. In order to improve adhesion between the transparent support and a layer disposed on the transparent support (the adhesive layer, the vertical alignment layer, or a retardation layer), the transparent support may be subjected to a surface treatment (for example, a glow discharge treatment, a corona discharge treatment, an ultraviolet ray (UV) treatment, and a flame treatment). The adhesive layer (the undercoat layer) may be disposed on the transparent support. In addition, it is preferable that a transparent support to which slidability is applied in a transporting step or a transparent support which is formed by applying a polymer layer in which inorganic particles having an average particle diameter of approximately 10 nm to 100 nm are mixed at a mass ratio of solid contents of 5% to 40% onto one surface of the support or by cocasting with the support in order to prevent a back surface from being bonded to the surface after being wound is used in the transparent support or a long transparent support.

Furthermore, in the above description, the λ/2 plate or the λ/4 plate having a structure of a laminated body in which the optical anisotropic layer is disposed on the support has been described, but the present invention is not limited to the embodiment, and the λ/2 plate and the λ/4 plate may be laminated on one surface of one transparent support, or the λ/2 plate may be laminated on one surface of one transparent support, and the λ/4 plate may be laminated on the other surface. Further, the λ/2 plate or the λ/4 plate may be formed only of a stretched polymer film (the optical anisotropic support), or may be formed only of the liquid crystal film which is formed of the composition containing the liquid crystal compound. A preferred example of the liquid crystal film is also identical to that of the optical anisotropic layer described above.

It is preferable that the λ/2 plate and the λ/4 plate described above are continuously manufactured in a state of a long film. At this time, it is preferable that an angle of the slow axis of the λ/2 plate or the λ/4 plate is 15°±8° or 75° with respect to a longitudinal direction of the long film described above. Thus, in the manufacturing of an optical laminated body described below, the long film is able to be bonded to the polarizing film by the roll to roll process by setting the longitudinal direction of the long film described above to be coincident with the longitudinal direction of the polarizing film, and thus, it is possible to manufacture a circular polarizing plate or an elliptical polarizing plate having high accuracy of the bonding axis angle and high productivity. Furthermore, in a case where the optical anisotropic layer is formed of the liquid crystal compound, the angle of the slow axis of the optical anisotropic layer is able to be adjusted by a rubbing angle. In addition, in a case where the λ/2 plate or the λ/4 plate is formed of the polymer film (the optical anisotropic support) which has been subjected to the stretching treatment, the angle of the slow axis is able to be adjusted by a stretching direction.

### Embodiment (ii)

### Wavelength Selective Reflective Polarizer

Next, the embodiment (ii) will be described. Examples of the wavelength selective reflective polarizer of the embodiment (ii) are able to include a multi-layer film in which a plurality of layers having different refractive indices are laminated. The layer configuring the multi-layer film may be an inorganic layer, or may be an organic layer. For example, a dielectric multi-layer film configured by sequentially laminating materials having different refractive indices (a high refractive index material and a low refractive index material) is able to be preferably used. Further, a metal/dielectric multi-layer film in which a metal film is added to the configuration of the dielectric multi-layer film may be used. Furthermore, the multi-layer film described above is able to be formed by sedimenting a plurality of film formation materials on a substrate using a known film formation method such as electron beam (EB) vapor deposition and sputtering. In addition, the multi-layer film including the organic layer is able to be formed by a known film formation method such as coating and lamination. For example, a stretched film is able to be used as the organic layer. It is preferable that the wavelength selective reflective polarizer of the embodiment (ii) is the dielectric multi-layer film.

It is preferable that the dielectric multi-layer film which is used in the embodiment (ii) has a reflection center wavelength in a wavelength range of 430 nm to 480 nm and a reflectivity peak having a half band width of less than or equal to 100 nm, a reflection center wavelength in a wavelength range of 500 nm to 600 nm and a reflectivity peak having a half band width of less than or equal to 100 nm, and a reflection center wavelength in a wavelength range of 600 nm to 650 nm and a reflectivity peak having a half band width of less than or equal to 100 nm A case of having approximately constant one flat reflectivity peak with respect to a wavelength in all of the wavelength ranges is also included in this embodiment.

FIG. 2 illustrates an embodiment in which a dielectric multi-layer film 11 is used as a reflection polarizing plate 15. However, the present invention is not limited to such a specific example, and the dielectric multi-layer film 11 is illustrated as a laminated body of a single-layer in the drawing for the sake of convenience, but the number of layers to be laminated is able to be suitably changed in order to attain desired reflectivity.

It is preferable that the dielectric multi-layer film which is used in the embodiment (ii) only has a reflection center wavelength in a wavelength range of 430 nm to 480 nm and a reflectivity peak having a half band width of less than or equal to 100 nm, a reflection center wavelength in a wavelength range of 500 nm to 600 nm and a reflectivity peak having a half band width of less than or equal to 100 nm, and a reflection center wavelength in a wavelength range of 600 nm to 650 nm and a reflectivity peak having a half band width of less than or equal to 100 nm, that is, it is more preferable that the dielectric multi-layer film does not have a reflectivity peak in a visible light range other than the reflectivity peak described above.

It is preferable that the film thickness of the dielectric multi-layer film which is used in the embodiment (ii) is thin. The film thickness of the dielectric multi-layer film which is used in the embodiment (ii) is preferably 5 μm to 100 μm, is more preferably 10 μm to 50 μm, and is particularly preferably 5 μm to 20 μm.

A manufacturing method of the dielectric multi-layer film which is used in the embodiment (ii) is not particularly limited, and for example, the dielectric multi-layer film is able to be manufactured with reference to methods disclosed in JP3187821B, JP3704364B, JP4037835B, JP4091978B, JP3709402B, JP4860729B, JP3448626B, and the like, and the contents of the publications are incorporated in the present invention. Furthermore, the dielectric multi-layer film indicates a dielectric multi-layer reflection polarizing plate or a birefringence interference polarizer of an alternate multi-layer film.

<Light Reflection Member and Light Absorption Member>

In the preferred embodiment of the optical sheet member of the present invention, light in ranges of 470 nm to 510 nm, 560 nm to 610 nm, and 660 nm to 780 nm is not able to exit (be reflected or absorbed), and thus, a color reproduction range is able to further widen.

Light recycling in a reflection manner (re-excitation of a fluorescent material in the optical conversion sheet using reflected light in wavelength ranges of 470 nm to 510 nm, 560 nm to 610 nm, and 660 nm to 780 nm) rather than in an absorption manner is preferable from the viewpoint of improving brightness.

Hereinafter, preferred embodiments of a light reflection member in a case of adopting the light recycling in the reflection manner and a light absorption member in a case of adopting the light recycling in the absorption manner will be sequentially described.

(Light Reflection Member)

In a case where the light recycling in the reflection manner is adopted, in the optical sheet member of the present invention, the light reflection member further arranged between the optical conversion sheet described above and the wavelength selective reflective polarizer described above or the wavelength selective reflective polarizer described above has a wavelength range having reflectivity of greater than or equal to 60% in at least one wavelength range of wavelength ranges of 470 nm to 510 nm, 560 nm to 610 nm, and 660 nm to 780 nm.

FIG. 10 illustrates a display device of an embodiment in which the wavelength selective reflective polarizer described above has a wavelength range having reflectivity of greater than or equal to 60% in at least one wavelength range of wavelength ranges of 470 nm to 510 nm, 560 nm to 610 nm, and 660 nm to 780 nm.

In FIG. 10, the wavelength selective reflective polarizer described above is a wavelength selective reflective polarizer 13B having a reflection band of greater than or equal to 60%, which has a wavelength range having reflectivity of greater than or equal to 60% in at least one wavelength range of wavelength ranges of 470 nm to 510 nm, 560 nm to 610 nm, and 660 nm to 780 nm.

In order to have a wavelength range having reflectivity of greater than or equal to 60% in at least one wavelength range of wavelength ranges of 470 nm to 510 nm, 560 nm to 610 nm, and 660 nm to 780 nm, it is preferable to have a reflection peak in a desired wavelength range. The light reflection member further arranged between the optical conversion sheet described above and the wavelength selective reflective polarizer described above having a reflection peak in at least one wavelength range of wavelength ranges of 470 nm to 510 nm, 560 nm to 610 nm, and 660 nm to 780 nm is able to be easily realized by laminating light reflection layers formed by immobilizing cholesteric liquid crystalline phases having a twist in the opposite direction to the twist of the light reflection layer formed by immobilizing the cholesteric liquid crystalline phase used in the wavelength selective reflective polarizer in a desired wavelength range.

In a case where the light reflection member further arranged between the optical conversion sheet described above and the wavelength selective reflective polarizer described above is formed by a method of laminating the light reflection layers formed by immobilizing the cholesteric liquid crystalline phases, a preferred material, a preferred manufacturing method, and the like of the light reflection member are identical to the preferred material, the preferred manufacturing method, and the like of the light reflection layer formed by immobilizing the cholesteric liquid crystalline phase used in the wavelength selective reflective polarizer.

(Light Absorption Member)

In a case where the absorption manner is adopted, it is preferable that the optical sheet member of the present invention has light absorption properties in at least one wavelength range of wavelength ranges of 470 nm to 510 nm, 560 nm to 610 nm, and 660 nm to 780 nm from the viewpoint of obtaining absorption properties of realizing an effect of further widening a color reproduction range. In the optical sheet member of the present invention, it is more preferable that the light absorption member further arranged between the optical conversion sheet described above and the wavelength selective reflective polarizer described above or the wavelength selective reflective polarizer described above has light absorption properties in at least one wavelength range of wavelength ranges of 470 nm to 510 nm, 560 nm to 610 nm, and 660 nm to 780 nm, and it is particularly preferable that the wavelength selective reflective polarizer has light absorption properties in a wavelength range of 660 nm to 780 nm.

In the optical sheet member of the present invention, it is particularly preferable that the absorption properties described above are properties having an absorption range of light absorbance of greater than or equal to 0.1, more preferably greater than or equal to 1, and even more preferably greater than or equal to 2 in at least one wavelength range of wavelength ranges 470 nm to 510 nm, 560 nm to 610 nm, and 660 nm to 780 nm.

Here, light absorbance A is −log₁₀ (transmittance).

Furthermore, in the display device of the present invention, a member other than the light absorption member further arranged between the optical conversion sheet described above and the wavelength selective reflective polarizer described above or the wavelength selective reflective polarizer described above may have light absorption properties in at least one wavelength range of wavelength ranges of 470 nm to 510 nm, 560 nm to 610 nm, and 660 nm to 780 nm.

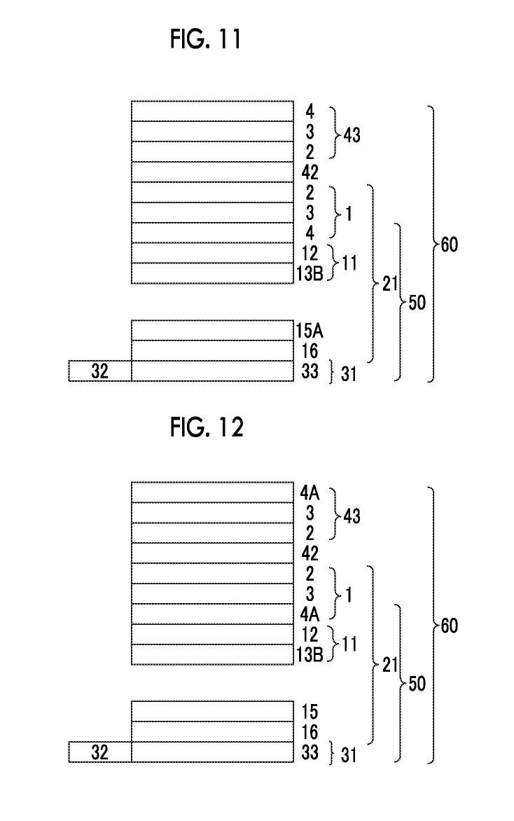

FIG. 11 to FIG. 15 illustrate a display device of an embodiment having light absorption properties in at least one wavelength range of wavelength ranges of 470 nm to 510 nm, 560 nm to 610 nm, and 660 nm to 780 nm.

In FIG. 11, the optical conversion sheet of described above is an optical conversion sheet 15A having an absorption range, which has light absorption properties in at least one wavelength range of wavelength ranges of 470 nm to 510 nm, 560 nm to 610 nm, and 660 nm to 780 nm.

In FIG. 12, the polarizing plate protective film of the backlight side polarizing plate 1 is a polarizing plate protective film 4A having an absorption range, which has light absorption properties in at least one wavelength range of wavelength ranges of 470 nm to 510 nm, 560 nm to 610 nm, and 660 nm to 780 nm.

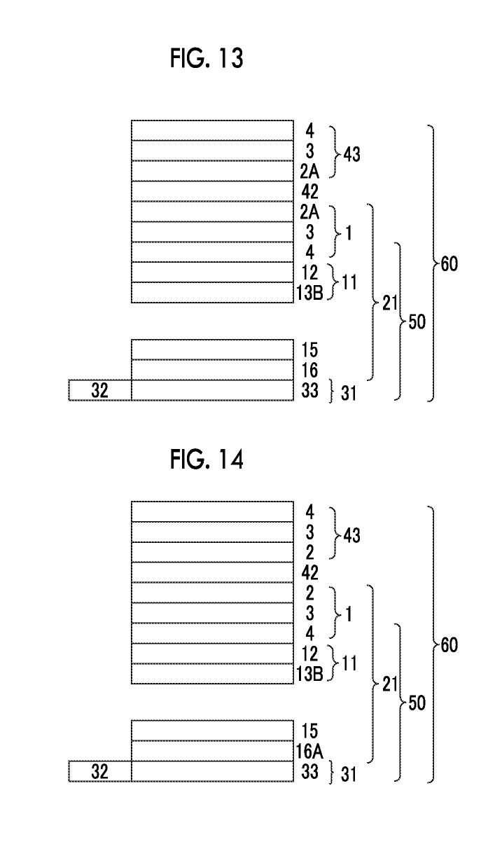

In FIG. 13, the retardation film of backlight side polarizing plate 1 is a retardation film 2A having an absorption range, which has light absorption properties in at least one wavelength range of wavelength ranges of 470 nm to 510 nm, 560 nm to 610 nm, and 660 nm to 780 nm.

In FIG. 14, the optical sheet an optical sheet 16A having an absorption range, which has light absorption properties in at least one wavelength range of wavelength ranges of 470 nm to 510 nm, 560 nm to 610 nm, and 660 nm to 780 nm.

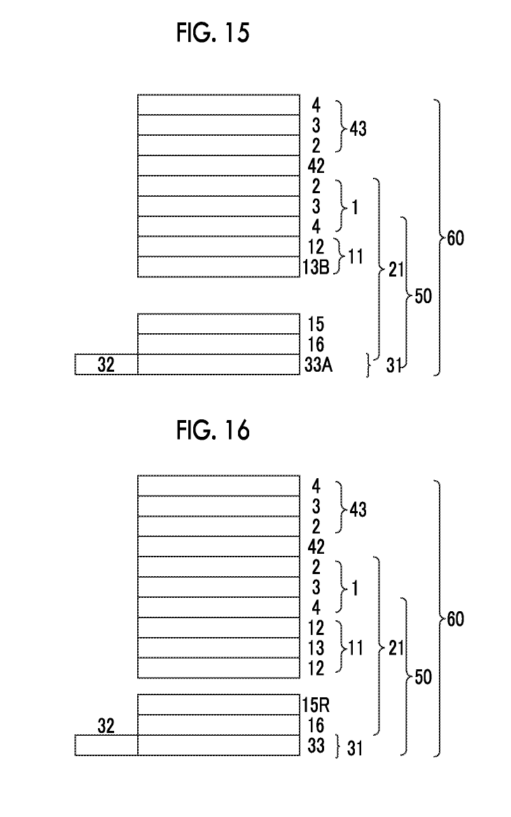

In FIG. 15, a light guide plate is a light guide plate 33A having an absorption range, which has light absorption properties in at least one wavelength range of wavelength ranges of 470 nm to 510 nm, 560 nm to 610 nm, and 660 nm to 780 nm.

A preferred absorptive compound which is used in the light absorption member isphthalocyanine, cyanine, diimonium, quaterrylen, a dithiol Ni complex, indoaniline, an azo methine complex, aminoanthraquinone, naphthalocyanine, oxonol, squarylium, and a croconium pigment, and specific examples of the absorptive compound include a pigment disclosed in “Chemical Reviews” published in 1992, Vol. 92, No. 6, Pages 1197 to 1226, “Absorption Spectra Of Dyes for Diode Lasers JOEM Handbook 2” published in 1990 by bunshin-publishing), or “Development of Infrared Absorption Pigment for Optical Disk” Fine Chemical published in 1999, Vol. 23, No. 3, which has the maximal absorption wavelength (in other words from the other viewpoint, the maximum absorption wavelength) in the wavelength range described above.

Specific examples of the absorptive compound include:

Diimonium Pigment disclosed in [0072] to [0115] of JP2008-069260A;

Cyanine Pigment disclosed in [0020] to [0051] of JP2009-108267A; and

Phthalocyanine Pigment disclosed in [0010] to [0019] of JP2013-182028A.

In the light absorption member, a layer containing the absorption material may be formed of one layer or two or more layers. In the light absorption member, one of the layers configuring the layer containing the absorption material may be a layer containing a pigment having absorption properties in a wavelength range of 660 nm to 780 nm, and a first absorption material described below and a second absorption material described below, or each of a plurality of layers configuring the layer containing the absorption material may contain each type of a pigment having absorption properties in a wavelength range of 660 nm to 780 nm, and the first absorption material described above and the second absorption material described above.

The pigment having absorption properties in the wavelength range of 660 nm to 780 nm, and the first absorption material described above and the second absorption material described above are preferably a dye or a pigment, and are more preferably a dye.

—Dye—

Examples of the pigment having absorption properties in a wavelength range of 660 nm to 780 nm are able to include a phthalocyanine pigment.

Examples of a preferred phthalocyanine pigment are able to include a phthalocyanine pigment denoted by General Formula (I) described below.

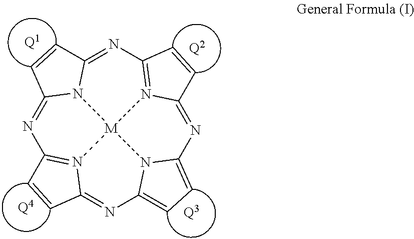

In General Formula (I), Q¹ to Q⁴ each independently represent an aryl group or a heterocyclic group, and at least one of Q¹ to Q⁴ is a nitrogen-containing heterocyclic group. M represents a metal atom. It is preferable that two or three of Q¹ to Q⁴ are aryl groups, and the remaining one or two are nitrogen-containing heterocyclic groups.

The aryl group may be a single ring, or may be a condensed ring, and it is preferable that the aryl group is the single ring. A benzyl group is particularly preferable as the aryl group.

It is preferable that a heterocyclic group is the nitrogen-containing heterocyclic group. The nitrogen-containing heterocyclic group may include a hetero atom other than a nitrogen atom. Examples of such a hetero atom are able to include a sulfur atom. It is preferable that the nitrogen-containing heterocyclic group includes only a nitrogen atom as a hetero atom. It is preferable that the nitrogen-containing heterocyclic group is a nitrogen-containing heterocyclic group having 5-membered ring or a 6-membered ring, and it is more preferable that the nitrogen-containing heterocyclic group is a nitrogen-containing heterocyclic group having a 6-membered ring. The number of hetero atoms in the nitrogen-containing heterocyclic group is preferably 1 to 5, is more preferably 2 to 4, and is even more preferably 2 or 3.

The aryl group and the heterocyclic group may have a substituent group. The details of the substituent group can be referred to those disclosed in paragraphs 0010 and 0011 of JP2013-182028A.

In the phthalocyanine pigment denoted by General Formula (I), it is preferable that at least one of Q¹ to Q⁴ is the nitrogen-containing heterocyclic group, and the remaining is denoted by General Formula (I-1) described below.

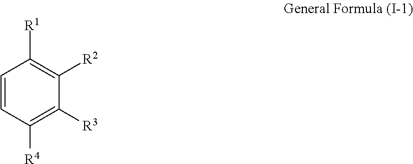

In General Formula (I-1), R¹, R², R³, and R⁴ each independently represent a hydrogen atom or a substituent group, and is bonded to a center skeleton in the position of:

It is preferable that one or two of R¹, R², R³, and R⁴ is a substituent group other than the halogen atom, and the remaining is a hydrogen atom or a halogen atom, and it is more preferable that one of R¹, R², R³, and R⁴ is a substituent group, and the remaining is a hydrogen atom. A fluorine atom is preferable as the halogen atom.

In each of R¹, R², R³, and R⁴, the mass of the group thereof (the molecular weight at the time of assuming the group as one molecule) is preferably 30 to 400, and is more preferably 30 to 200.

In General Formula (I), a metal atom represented by M is preferably Cu, Zn, Pb, Fe, Ni, Co, AlCl, AlI, InCl, InI, GaCl, GaI, TiCl₂, Ti═O, VCl₂, V═O, SnCl₂, or GeCl₂, is more preferably Cu, V═O, Mg, Zn, and Ti═O, and is particularly preferably Cu and V═O.

The phthalocyanine pigment is able to be synthesized by a known method. For example, the phthalocyanine pigment is able to be synthesized according to the description of Phthalocyanine Chemistry and Function (IPC CO., LTD). In addition, a commercially available product is able to be used. In addition, the phthalocyanine pigment is available as a commercially available product.

Hereinafter, specific examples of the phthalocyanine pigment denoted by General Formula (I) will be described, but the present invention is not limited thereto. In addition, among exemplary compounds described below, a compound in which a center metal atom is substituted with Cu, Zn, Pb, Fe, Ni, Co, AlCl, AlI, InCl, InI, GaCl, GaI, TiCl₂, Ti═O, VCl₂, V═O, SnCl₂, or GeCl₂ is also preferably used. Further, in an exemplary compound A described below, only one of the rings corresponding to Q¹ to Q⁴ of General Formula (I) is formed of a nitrogen-containing ring, and a case where two or more of the rings are formed of a nitrogen-containing ring is also preferable. The same can apply to the other exemplary compounds.

In addition, the exemplary compounds described below, for example, is able to be synthesized by cyclizing two or more types of nitrile compounds. In a case where the compound is synthesized as described above, the compound is obtained as a mixture, but in the following description, only a representative structure will be described for the sake of convenience. For example, an exemplary compound B described below is able to be obtained by allowing a nitrile compound a described below to react with a nitric compound b described below at a molar ratio of 1:3, and on synthesis, the exemplary compound B includes a phthalocyanine pigment configured of a partial structure derived from the nitric compound a:a partial structure derived from the nitrile compound b=0:4 to 4:0. In addition, the exemplary compound B also includes an isomer structure in which the arrangements of functional groups are different from each other.

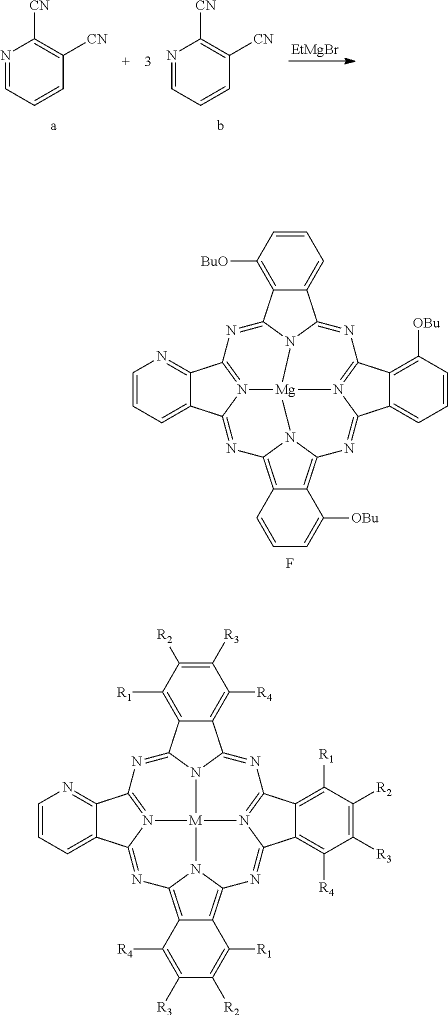

TABLE 1

| | | | | | | Maximum |
|---|---|---|---|---|---|---|
| | | | | | | Absorption |
| Compound | M | R¹ | R² | R³ | R⁴ | Wavelength |
| A | Cu | OPh | H | H | H | 682 |
| B | Cu | OBu | H | H | H | 685 |
| C | Cu | SPh | H | H | H | 699 |
| D | Cu | 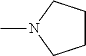 | H | H | H | 720 |
| E | VO | OBu | H | H | H | 697 |
| F | Mg | OBu | H | H | H | 683 |
| G | Zn | OBu | H | H | H | 682 |
| H | TiO | OBu | H | H | H | 688 |
| I | Cu | H | 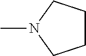 | H | H | 689 |
| J | Cu | OBu | H | H | OBu | 710 |
| K | Cu | F | F | 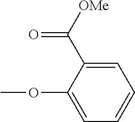 | F | 682 |

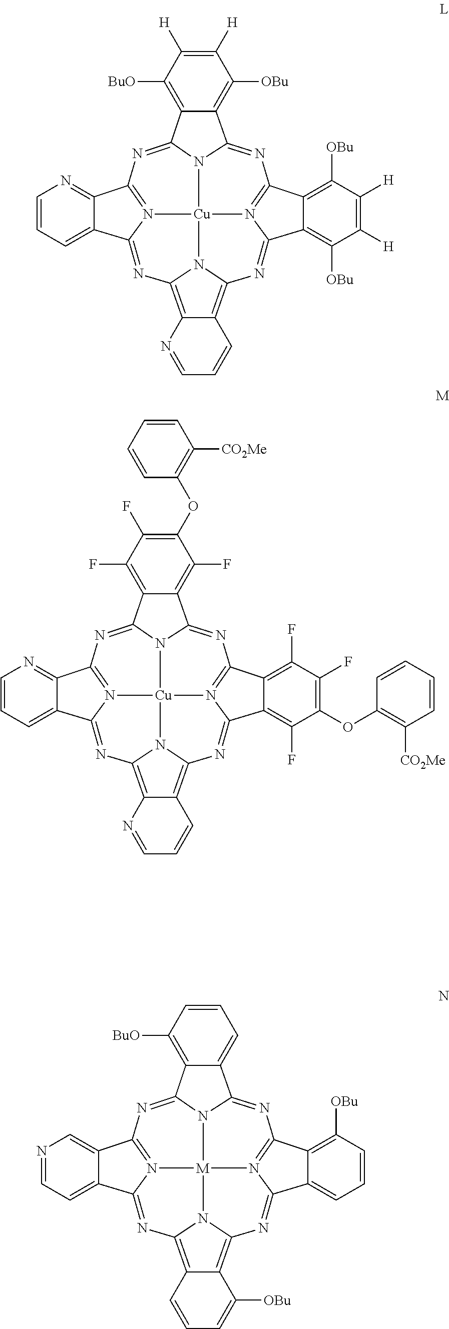

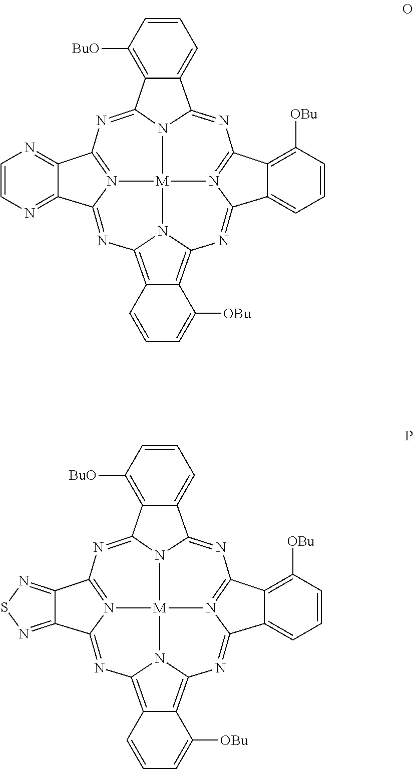

(In the above formulas, M is a copper atom.)

A squarylium-based compound, an azo methine-based compound, a cyanine-based compound, an oxonol-based compound, an anthraquinone-based compound, an azo-based compound, or a benzylidene-based compound is preferably used as the first absorption material (a dye or a pigment) which has the maximum value (hereinafter, also referred to as maximal absorption) of light absorbance in a wavelength range of 470 nm to 510 nm and has a light absorbance peak having a half band width of less than or equal to 50 nm Azo dyes disclosed in GB539703B, GB575691B, U.S. Pat. No. 2,956,879A, and “Reviews of Synthesized Dye” written by Hiroshi HORIGUCHI and published by SANKYO SHUPPAN Co., Ltd., and the like are able to be generally used as an azo dye. Examples of the first absorption material which has the maximal absorption in a range where a wavelength is 470 nm to 510 nm and a light absorbance peak having a half band width of less than or equal to 50 nm will be described below.

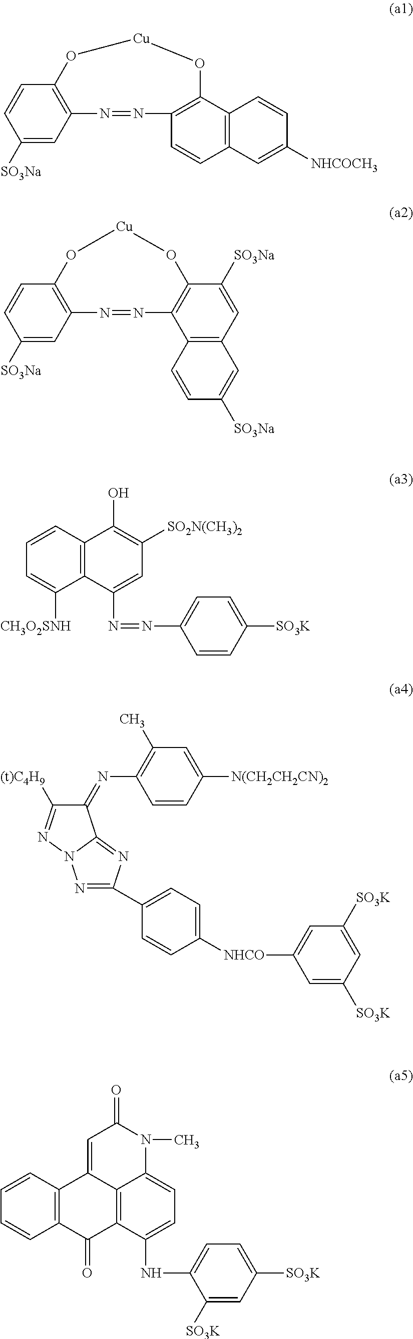

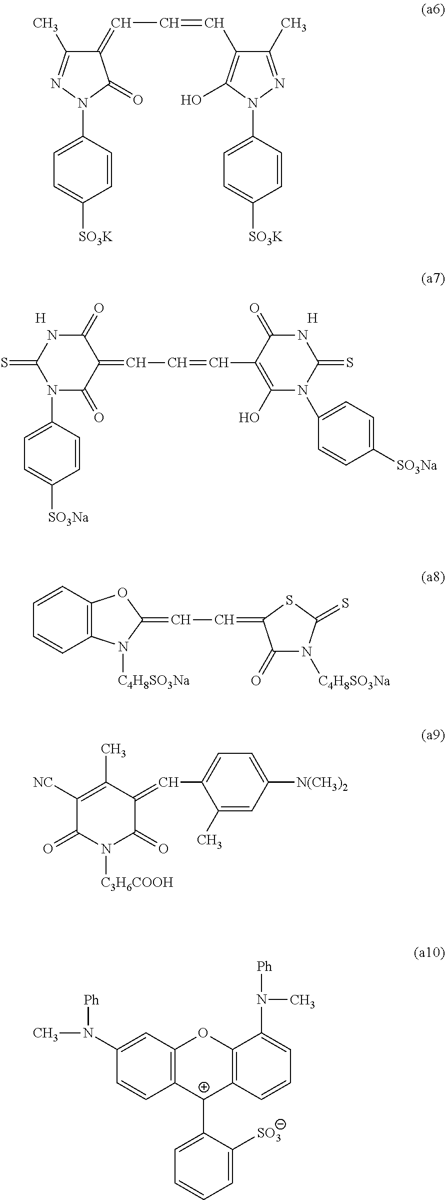

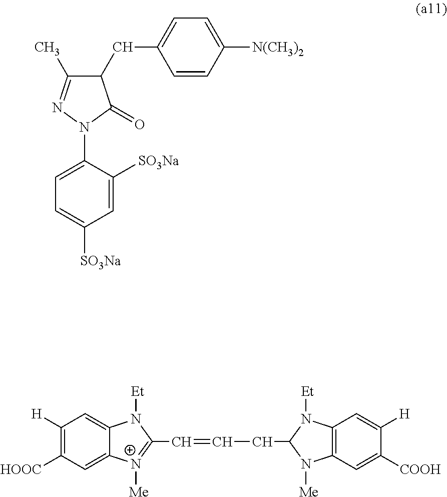

A cyanine-based compound, a squarylium-based compound, an azo methine-based compound, a xanthene-based compound, an oxonol-based compound, or an azo-based compound is preferable as the second absorption material (a dye or a pigment) which has the maximum value of light absorbance in a wavelength range of 560 nm to 610 nm and has a light absorbance peak having a half band width of less than or equal to 50 nm, and the cyanine-based pigment and the oxonol-based pigment are more preferably used. Examples of the second absorption material which has the maximal absorption in a range where a wavelength is 560 nm to 610 nm and a light absorbance peak having a half band width of less than or equal to 50 nm will be described below.

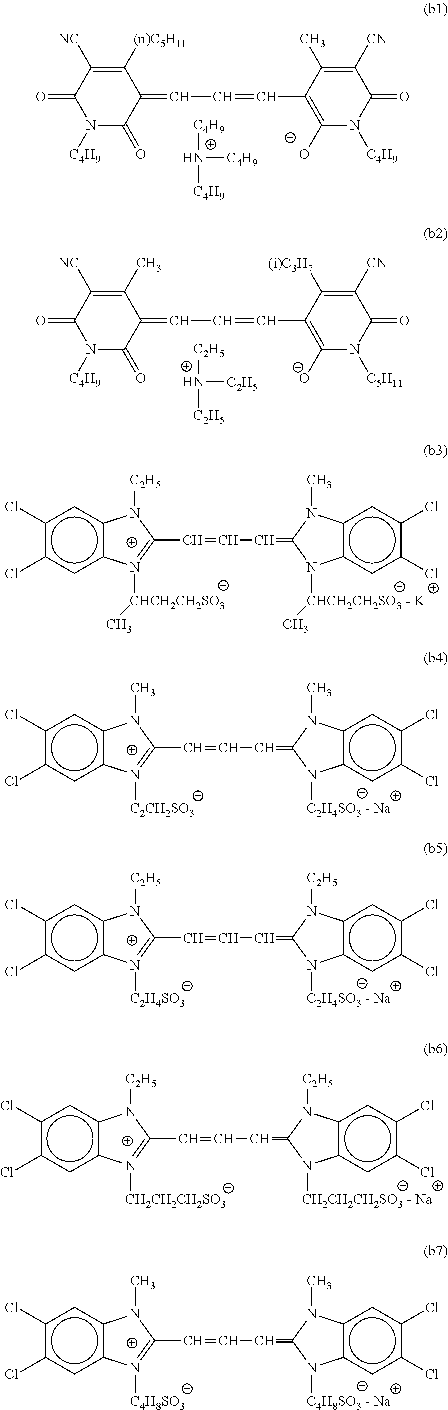

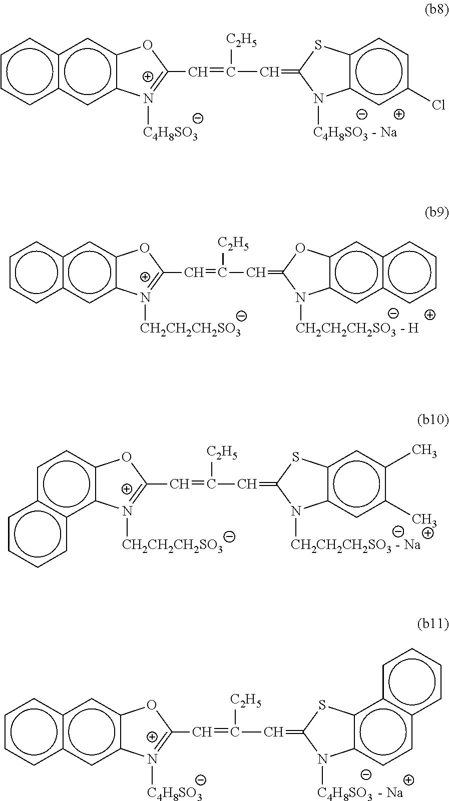

Synthesis of a cyanine dye can be referred to the description of each specification of JP1995-230671A (JP-H07-230671A), EP0778493B, and U.S. Pat. No. 5,459,265A. Synthesis of an azo dye can be referred to the description of each specification of GB539703B, GB575691B, and U.S. Pat. No. 2,956,879A, and “Reviews of Synthesized Dye” written by Hiroshi HORIGUCHI (published by SANKYO SHUPPAN Co., Ltd. in 1968). Synthesis of an azo methine dye can be referred to the description of each publication of JP1987-3250A (JP-S62-3250A), JP1992-178646A (JP-H04-178646A), and JP1993-323501A (JP-H05-323501A). An oxonol dye is able to be synthesized with reference to the description of each specification of JP1995-230671A (JP-H07-230671A), EP0778493B, and U.S. Pat. No. 5,459,265A. Synthesis of a merocyanine dye can be referred to the description of the specification of U.S. Pat. No. 2,170,806A and each publication of JP1980-155350A (JP-S55-155350A) and JP1980-161232A (JP-S55-161232A). Synthesis of an anthraquinone dye can be referred to the description of each specification of GB710060B and U.S. Pat. No. 3,575,704A, JP1973-5425A (JP-S48-5425A), and “Reviews of Synthesized Dye” written by Hiroshi HORIGUCHI (published by SANKYO SHUPPAN Co., Ltd. in 1968). Other dyes are able to be synthesized with reference to the description of “Heterocyclic Compounds-Cyanine Dyes and Related Compounds” written by F. M. Harmer and published by John Wiley and Sons, New York, London, 1964, “Heterocyclic Compounds-Special Topics in Heterocyclic Chemistry” written by D. M. Sturmer and published by John Wiley and Sons, New York, London, 1977, Chapter 18, Section 14, Pages 482 to 515; “Rodd’ Chemistry of Carbon Compounds” published by Elsevier Science Publishing Company Inc., New York, 1977, The Second Edition, Vol. 4, Part B, Chapter 15, Pages 369 to 422; and each publication of JP1993-88293A (JP-H05-88293A) and JP1994-313939A (JP-H06-313939A).

As described above, a combination of two or more types of pigments is able to be used as the dye. In addition, it is possible to use a pigment having maximal absorption in two or more ranges of a wavelength range of 380 nm to 420 nm, a wavelength range of 470 nm to 510 nm, and a wavelength range of 560 nm to 610 nm. For example, in a case where the pigment is in an associate state as described below, in general, a wavelength is shifted to a long wavelength side, and a peak is shifted. For this reason, examples of a pigment having maximal absorption in a range where a wavelength is 470 nm to 510 nm include a pigment of which the associate has maximal absorption in a range of 560 nm to 610 nm. In a case where such a pigment is used in a state of partially forming an associate, the maximal absorption is able to be obtained in both of a range where a wavelength is 470 nm to 510 nm and a range where a wavelength is 560 nm to 610 nm Examples of such a pigment will be described below. Furthermore, examples of other compounds having maximal absorption in a wavelength range of 380 nm to 420 nm are able to include a compound disclosed in [0016] and [0017] of JP2008-203436A.

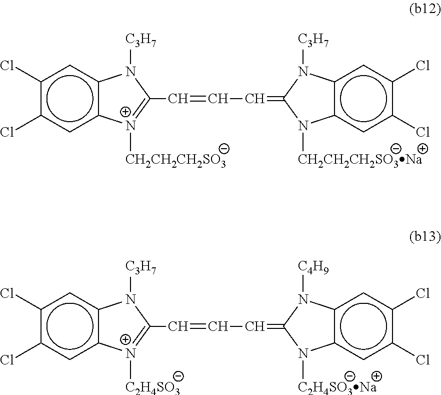

Examples of other first absorption materials and second absorption materials are able to include pigment compounds disclosed in JP2000-321419A, JP2002-122729A, and JP4504496B, and the contents of the publications are incorporated in the present invention. The wavelength range of obtaining the maximal absorption of the first absorption material which has the maximal absorption in the wavelength range of 470 nm to 510 nm is preferably 475 nm to 510 nm, and is more preferably 480 nm to 505 nm.

The wavelength range of obtaining the maximal absorption of the second absorption material which has the maximal absorption in the wavelength range of 560 nm to 610 nm is preferably 570 nm to 605 nm, and is more preferably 580 nm to 600 nm.

The content of the dye in the layer containing the absorption material is preferably 0.001 mass % to 0.05 mass %, and is more preferably 0.001 mass % to 0.01 mass %, with respect to the total mass of the layer containing the absorption material.

—Half Band Width—

It is preferable that the absorption spectrums of the first absorption material having maximal absorption in a wavelength range of 470 nm to 510 nm, the second absorption material having maximal absorption in a wavelength range of 560 nm to 610 nm, and the pigment having absorption properties in a wavelength range of 660 nm to 780 nm are sharp in order to selectively cut light such that the blue light, the green light, and the red light described above are not affected. Specifically, the half band width of the absorption spectrum of the first absorption material having maximal absorption in a wavelength range of 470 nm to 510 nm (the width of a wavelength range indicating half light absorbance of the light absorbance in the maximal absorption) is preferably less than or equal to 50 nm, is more preferably 5 nm to 40 nm, and is even more preferably 10 nm to 30 nm. The half band width of the absorption spectrum of the second absorption material having maximal absorption in a wavelength range of 560 nm to 610 nm is preferably less than or equal to 50 nm, is more preferably 5 nm to 40 nm, and is even more preferably 10 nm to 30 nm. The half band width of the absorption spectrum of the pigment having absorption properties in a wavelength range of 660 nm to 780 nm is preferably less than or equal to 50 nm, is more preferably 5 nm to 40 nm, and is even more preferably 10 nm to 30 nm.

Examples of means for setting the half band width to be in such a range include means for containing a plurality of dyes or pigments having different maximal absorption in one wavelength range in the absorption material, containing an associate of dyes in the absorption material, or the like.

Specifically, a methine dye (for example, cyanine, merocyanine, oxonol, pyrromethene, styryl, and arylidene), a diphenyl methane dye, a triphenyl methane dye, a xanthene dye, a squarylium dye, a croconium dye, an azine dye, an acridine dye, a thiazine dye, an oxazine dye, and the like are able to be selected as the dye. It is preferable that the dyes are used in an associate.

The dye in the associate state forms a so-called J band and exhibits a sharp absorption spectrum peak. The associate and the J band of the dye are disclosed in various literatures (for example, Photographic Science and Engineering Vol. 18, No. 323-335 (1974)). The maximal absorption of the dye in a J associate state is moved to a wavelength side which is longer than the maximal absorption of the dye in a solution state. Accordingly, it is possible to easily determine whether the dye contained in the layer containing the absorption material is in an associate state or in a non-associate state by measuring the maximal absorption. The movement of the maximal absorption of the dye in the associate state is preferably greater than or equal to 30 nm, is more preferably greater than or equal to 40 nm, and is most preferably greater than or equal to 45 nm.

The dye used in the associate state is preferably a methine dye, and is most preferably a cyanine dye or an oxonol dye. Examples of the dyes include a compound which forms an associate by only being dissolved in water, but in general, the associate is able to be formed by adding gelatin or a salt (for example, barium chloride, calcium chloride, and sodium chloride) to an aqueous solution of the dye. A method of adding the gelatin to the aqueous solution of the dye is particularly preferable as a forming method of the associate. Each of the plurality of dyes having different maximal absorption is dispersed in the aqueous solution to which the gelatin is added, and then, is mixed, and thus, a sample containing a plurality of associates having different maximal absorption is able to be prepared. In addition, according to the dye, it is possible to form an associate by only dispersing each of the plurality of dyes in the aqueous solution to which the gelatin is added. The associate of the dye is able to be formed as a solid fine particle dispersion of the dye. In order to form the solid fine particle dispersion, it is possible to use a known dispersing machine. Examples of a dispersing machine include a ball mill, a vibrating ball mill, a planetary ball mill, a sand mill, a colloid mill, a jet mill, and a roller mill. The dispersing machine is disclosed in JP1977-92716A (JP-S52-92716A) and the specification of WO88/074794A. A vertical type medium dispersing machine or a horizontal type medium dispersing machine is preferable.

—Additive—

In addition, an additive such as an infrared absorbent or an ultraviolet absorbent may be added to the layer containing the absorption material, and an additive disclosed in [0031] of JP2008-203436A is able to be used.

—Binder—

In order to control stability and reflection properties of the pigment having absorption properties in a wavelength range of 660 nm to 780 nm, the first absorption material described above, and the second absorption material described above, or the like, it is preferable that the layer containing the absorption material includes a polymer binder. A binder known to a person skilled in the art is able to be used as the polymer binder, and it is preferable that an aqueous binder is used in order to more easily perform a dispersion operation. Examples of the aqueous binder include gelatin, polyvinyl alcohol, polyacrylamide, polyethylene glycol, and the like. In particular, in order to form the layer containing the absorption material in a state where the associate is formed, in general, it is preferable to use the gelatin which has been known as having excellent protective colloid properties with respect to dispersion particles.

The gelatin is not particularly limited, gelatin having a mass average molecular weight of greater than or equal to 100000 which is extracted and refined by a general acid treatment or alkali treatment may be used. In general, an aqueous solution of approximately 10 mass % of the gelatin is subjected to gelation at 25° C. in which fluidity of a liquid is lost. In order to set the aqueous solution of the gelatin to be in a state where coating is able to be performed, it is necessary that the temperature of a coating liquid decreases or a gelatin concentration of the coating liquid decreases, and in both cases, the associate of the pigment tends to be unstable. Accordingly, in the gelatin which is used in the binder, the viscosity of the aqueous solution of 10 mass % at 25° C. is preferably 5 mPa·s to 100 mPa·s, and is more preferably 5 mPa·s to 50 mPa·s. In a case where the viscosity is less than 5 mPa·s, wind unevenness easily occurs in a drying step, and in contrast, in a case where the viscosity is greater than 100 mPa·s, leveling is rarely obtained after coating to drying, and a planar failure easily occurs. The gelatin may be independently used, or may be a mixed product of two or more types of gelatins insofar as the viscosity is in the range described above. Viscosity measurement is performed in conditions of No. 1 rotor and 60 rpm by using a B type viscometer manufactured by TOKYO KEIKI INC.

The mass average molecular weight of the gelatin which is used in the binder is preferably in a range of 2000 to 50000, and is more preferably in a range of 2000 to 20000. The average molecular weight is measured according to a molecular weight distribution measurement method using a gel filtration method disclosed in a PAGI method (a photographic gelatin test method).

Specific examples of the gelatin include #860, #880, and #881 (all are manufactured by Nitta Gelatin Inc.). One type of the gelatin may be independently used, and as necessary, two or more types thereof may be used by being mixed.

The content of the binder in the layer containing the absorption material is preferably 95 mass % to 99 mass %, and is more preferably 97 mass % to 99 mass %, with respect to the total mass of the layer containing the absorption material.

<Adhesive Layer (Pressure Sensitive Adhesive Layer)>

In the optical sheet member of the present invention, it is preferable that the polarizing plate and the wavelength selective reflective polarizer (B) are laminated directly in contact with each other or through the adhesive layer.

In the optical sheet member of the present invention, it is preferable that the polarizing plate, the λ/4 plate (C), and the wavelength selective reflective polarizer (B) are laminated in this order directly in contact with each other or through the adhesive layer.

Examples of a method in which the members are laminated by being directly in contact with each other are able to include a method in which the members are laminated by coating the surface of one member with the other member.

In addition, the adhesive layer (the pressure sensitive adhesive layer) may be arranged between these members. The pressure sensitive adhesive layer which is used for laminating the optical anisotropic layer and the polarizing plate, for example, indicates a substance having a ratio (tan=G″/G′) of a modulus of loss elasticity G″ to a modulus of storage elasticity G′ measured by a dynamic viscoelasticity measurement device of 0.001 to 1.5, and includes a so-called pressure sensitive adhesive agent, a substance which is easy to creep, or the like. Examples of the pressure sensitive adhesive agent which is able to be used in the present invention include an acrylic pressure sensitive adhesive agent and a polyvinyl alcohol-based adhesive agent, but are not limited thereto.

In the optical sheet member of the present invention, a difference in the refractive indices between the wavelength selective reflective polarizer (B) and a layer adjacent to the wavelength selective reflective polarizer (B) on the polarizing plate side is preferably less than or equal to 0.15, is more preferably less than or equal to 0.10, and is particularly preferably less than or equal to 0.05. Examples of the layer described above which is adjacent to the wavelength selective reflective polarizer (B) on the polarizing plate side are able to include the adhesive layer described above.

An adjustment method of the refractive index of the adhesive layer is not particularly limited, and for example, a method disclosed in JP1999-223712A (JP-H11-223712A) is able to be used. In the method disclosed in JP1999-223712A (JP-H11-223712A), the following embodiment is particularly preferable.

Examples of the pressure sensitive adhesive agent used in the adhesive layer described above are able to include resins such as a polyester-based resin, an epoxy-based resin, a polyurethane-based resin, a silicone-based resin, and an acrylic resin. The resins may be independently used or two or more types thereof may be used by being mixed. In particular, the acrylic resin is preferable from a viewpoint of excellent reliability with respect to water resistance, heat resistance, light fastness, and the like, an excellent adhesion force and excellent transparency, and ease of adjusting the refractive index to be suitable for a liquid crystal display. Examples of the acrylic pressure sensitive adhesive agent are able to include a homopolymer or a copolymer of an acrylic monomer such as an acrylic acid and ester thereof, a methacrylic acid and ester thereof, acrylamide, and acrylonitrile, and a copolymer of at least one type of acrylic monomer described above and an aromatic vinyl monomer of vinyl acetate, maleic anhydride, styrene, and the like. In particular, a copolymer formed of main monomers such as ethylene acrylate, butyl acrylate, and 2-ethylhexyl acrylate which express pressure sensitive adhesiveness, a monomer such as vinyl acetate, acrylonitrile, acrylamide, styrene, methacrylate, and methyl acrylate which become an aggregation force component, and functional group-containing monomers such as a methacrylic acid, an acrylic acid, an itaconic acid, hydroxy ethyl methacrylate, hydroxy propyl methacrylate, dimethyl amino ethyl methacrylate, acrylamide, methylol acrylamide, glycidyl methacrylate, and maleic anhydride which enhance an adhesion force or apply a cross-linking starting point, in which a glass transition point (Tg) is in a range of −60° C. to −15° C., and a weight average molecular weight is in a range of 200000 to 1000000 is preferable.

For example, one type or two or more types of a metal chelate-based cross-linking agent, an isocyanate-based cross-linking agent, and an epoxy-based cross-linking agent are used by being mixed as the curing agent, as necessary. It is practically preferable that such an acrylic pressure sensitive adhesive agent is compounded in a state of containing a filler described below, such that a pressure sensitive adhesion force is in a range of 100 g/25 mm to 2000 g/25 mm. In a case where the pressure sensitive adhesion force is less than 100 g/25 mm, environment resistance deteriorates, and in particular, peeling may occur at high temperature and high humidity, and in contrast, in a case where the adhesion force is greater than 2000 g/25 mm, re-bonding is not able to be performed, and even in a case where the re-bonding is able to be performed, the pressure sensitive adhesive agent remains. The refractive index of the acrylic pressure sensitive adhesive agent (a B method according to JIS K-7142) is in a range of 1.45 to 1.70, and is particularly preferably in a range of 1.5 to 1.65.

A filler for adjusting a refractive index is contained in the pressure sensitive adhesive agent. Examples of the filler are able to include an inorganic-based white pigment such as silica, calcium carbonate, aluminum hydroxide, magnesium hydroxide, clay, talc, and titanium dioxide, an organic-based transparent or white pigment such as an acrylic resin, a polystyrene resin, a polyethylene resin, an epoxy resin, and a silicone resin, and the like. It is preferable that the acrylic pressure sensitive adhesive agent is selected since a silicon bead and an epoxy resin bead have excellent dispersion properties with respect to the acrylic pressure sensitive adhesive agent, and an even and excellent refractive index is able to be obtained. In addition, a filler in which light scattering is in the shape of an even sphere is preferable as the filler.

The particle diameter of such a filler (JIS B9921) is in a range of 0.1 μm to 20.0 μm, and is preferably in a range of 0.5 μm to 10.0 μm. The particle diameter is particularly preferably in a range of 1.0 μm to 10 μm.

In the present invention, the refractive index of the filler (a B method according to JIS K-7142) preferably has a difference of 0.05 to 0.5, and more preferably has a difference of 0.05 to 0.3, with respect to the refractive index of the pressure sensitive adhesive agent.

The content of the filler in a scattering pressure sensitive adhesive layer is preferably 1.0 mass % to 40.0 mass %, and is particularly preferably 3.0 mass % to 20 mass %.

<Layer of Changing Polarization State of Light>

The brightness enhancement film may include a layer of changing the polarization state of light on a side of the reflection polarizer opposite to the λ/4 plate layer side. The layer of changing the polarization state of light will be described below.

[Display Device]

The display device of the present invention includes at least a light source having an light emission wavelength in at least a part of a wavelength range of 380 nm to 480 nm, and the optical sheet member of the present invention.

In the display device of the present invention, it is preferable that the light source described above, the optical conversion sheet described above of the optical sheet member described above, and the wavelength selective reflective polarizer described above of the optical sheet member described above are arranged in this order.

A preferred configuration of the display device of the present invention is illustrated in FIGS. 1 to 16.

A difference between a wavelength providing an light emission intensity peak of blue light, green light, and red light of the backlight unit and a wavelength providing a reflectivity peak of light having each color of the wavelength selective reflective polarizer in the brightness enhancement film is preferably less than or equal to 50 nm, and is more preferably less than or equal to 20 nm.

In the liquid crystal display device, it is preferable that the layer changing the polarization state of the light is arranged between the third light reflection layer of the brightness improvement film and the backlight unit. The layer changing the polarization state of the light functions as a layer changing a polarization state of light reflected from the light reflection layer, and is able to improve brightness. Examples of the layer changing the polarization state of the light include a polymer layer having a refractive index higher than that of an air layer, and examples of the polymer layer having a refractive index higher than that of the air layer include various low reflection layers such as a hard coat (HC) treatment layer, an anti-glare (AG) treatment layer, and a low reflection (AR) treatment layer, a triacetyl cellulose (TAC) film, an acrylic resin film, a cycloolefin polymer (COP) resin film, a stretched PET film, and the like. The layer changing the polarization state of the light may also function as a support. A relationship of the average refractive index of the layer changing the polarization state of the light reflected from the light reflection layer and the average refractive index of the third light reflection layer, is preferably described below.

0<|Average Refractive Index of Layer Changing Polarization State of Light−Average Refractive Index of Third Light Reflection Layer|<0.8, more preferably, 0<|Average Refractive Index of Layer Changing Polarization State of Light−Average Refractive Index of Third Light Reflection Layer|<0.4, and even more preferably, 0<|Average Refractive Index of Layer Changing Polarization State of Light−Average Refractive Index of Third Light Reflection Layer|<0.2.

The layer changing the polarization state of the light may be integrated with the brightness improvement film, or may be disposed separately from the brightness improvement film.

<Light Source and Backlight Unit>

The display device of the present invention includes at least the light source having a light emission wavelength in at least a part of a wavelength range of 380 nm to 480 nm Among them, the following embodiments are preferable as the light emission wavelength of the light source described above.

It is preferable that the half band width of the light source is narrow from the viewpoint of a color reproduction range, and the half band width of the light source is preferably less than or equal to 100 nm, is more preferably less than or equal to 50 nm, and is even more preferably less than or equal to 20 nm. An LED emitting blue light is preferable, and a blue laser light source is more preferable, from the viewpoint of the color reproduction range.

The configuration of the backlight unit may be an edge light mode backlight unit including a light guide plate, a reflection plate, and the like as a configuration member, or may be a direct backlight mode backlight unit. FIG. 1 illustrates an example of a display device using an edge light mode surface light source BL unit 31. FIG. 8 illustrates an example of a display device which uses a direct backlight mode surface light source BL unit 34 and includes an optical sheet 16 between the optical conversion sheet described above and the wavelength selective reflective polarizer described above.

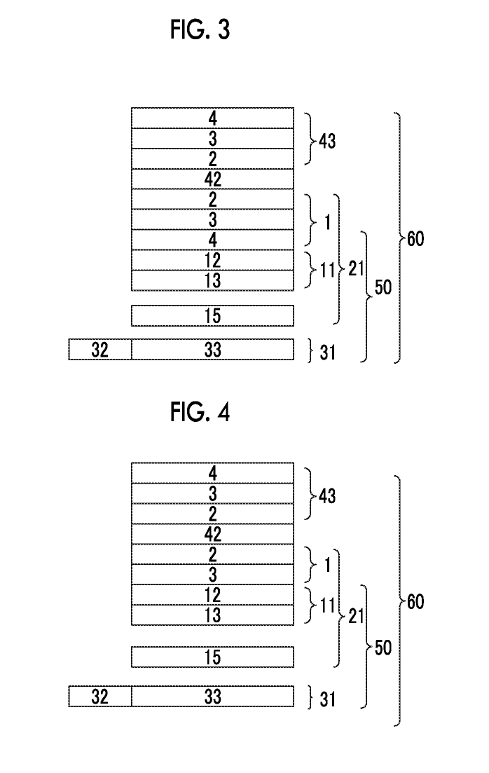

It is preferable that the backlight unit includes a reflection member converting and reflecting the polarization state of light which is emitted from the light source and reflected by the optical sheet member in the rear portion of the light source. Such a reflection member is not particularly limited, but known reflection members disclosed in JP3416302B, JP3363565B, JP4091978B, JP3448626B, and the like are able to be used, and the contents of the publications are incorporated in the present invention. FIG. 3 illustrates an example of a display device including a light guide plate 33 bonded to a light source (a blue LED light source module) 32 emitting blue light of 380 nm to 480 nm.

In the present invention, it is preferable that the light source of the backlight includes a blue light emission diode emitting the blue light described above. In the display device of the present invention, it is preferable that the light source described above includes a blue LED, the optical conversion sheet described above has a light emission center wavelength in a wavelength range of 500 nm to 600 nm, and a fluorescent material having a light emission wavelength of green light which has a light emission intensity peak having a half band width of less than or equal to 100 nm and red light which has a light emission center wavelength in a wavelength range of 600 nm to 650 nm and a half band width of less than or equal to 100 nm.

The half band width of light emitted from the light source and light re-emitted from the optical conversion sheet is preferably 2 nm to 70 nm, and is more preferably 2 nm to 30 nm.

Furthermore, as the light source of the backlight, a blue light emission diode emitting the blue light described above, a green light emission diode emitting the green light described above, and a red light emission diode emitting the red light described above may be used.

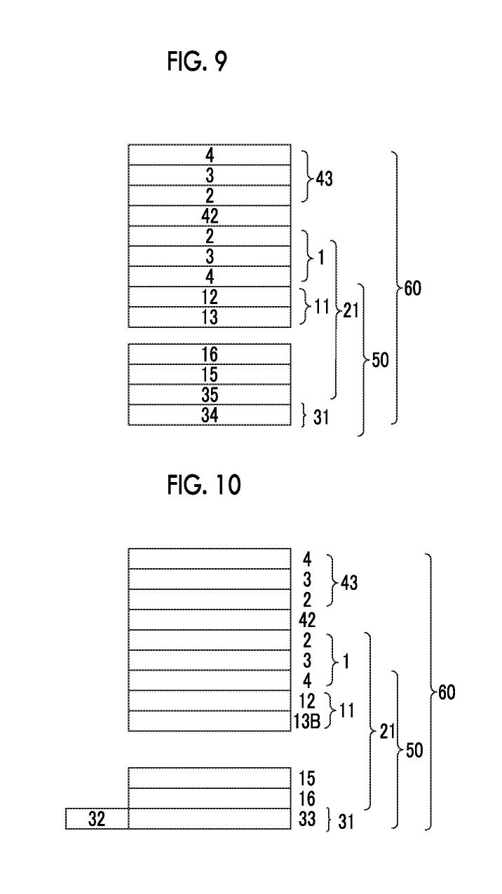

It is preferable that the backlight unit further includes a known scattering plate or a known scattering sheet, a prism sheet (for example, BEF or the like), and a light guide device. FIG. 9 illustrates an example of a display device which uses the direct backlight mode surface light source BL unit 34, includes a scattering plate 35 between the light guide plate described above and the optical conversion sheet described above, and includes the optical sheet 16 between the optical conversion sheet described above and the wavelength selective reflective polarizer described above.

Other members are disclosed in JP3416302B, JP3363565B, JP4091978B, JP3448626B, and the like, and the contents of the publications are incorporated in the present invention.

<Display Panel>

The display device of the present invention may be an illumination device or an image display device, and is preferably an image display device.

Examples of the image display device of described above are able to include a liquid crystal display (LCD), a plasma display (PDP), an electroluminescence display (OELD or IELD), a field emission display (FED), a touch panel, electronic paper, and the like.

It is preferable that the display device of the present invention includes an optical switching device switching light of the light source described above, and it is preferable that the optical switching device described above is a liquid crystal driving device. In addition, in a case where the optical switching device described above is the liquid crystal driving device, it is more preferable that the polarizing plate is disposed between the wavelength selective reflective polarizer described above and the liquid crystal driving device described above.

In the display device of the present invention, it is preferable that the polarizing plate described above and the wavelength selective reflective polarizer described above are laminated directly in contact with each other or through the adhesive layer.

In the display device of the present invention, it is preferable that the optical sheet member described above includes a λ/4 plate satisfying at least one of Expressions (1) to (3) described below, the polarizing plate described above, the λ/4 plate described above, and the wavelength selective reflective polarizer described above are laminated in this order directly in contact with each other or through the adhesive layer;

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

In Expressions (1) to (3), Re(λ) represents retardation in the in-plane direction at a wavelength of λ nm, and the unit of Re(λ) is nm.

An example of a preferred display panel of the image display device described above is a transmission mode liquid crystal panel, and includes a pair of polarizers, and a liquid crystal cell between the polarizers. In general, the retardation film for compensating a view angle is arranged between each of the polarizers and the liquid crystal cell. The configuration of the liquid crystal cell is not particularly limited, and a liquid crystal cell having a general configuration is able to be adopted. The liquid crystal cell, for example, includes a pair of substrates which are arranged to face each other, and a liquid crystal layer interposed between the pair of substrates, and as necessary, may include a color filter layer and the like. The driving mode of the liquid crystal cell is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode are able to be used.

It is preferable that the liquid crystal cell which is used in the display device of the present invention is in the VA mode, the OCB mode, the IPS mode, or the TN mode, but the liquid crystal cell is not limited thereto.

In the liquid crystal cell of the TN mode, rod-like liquid crystalline molecules are substantially subjected to horizontal alignment at the time of not applying a voltage, and are subjected to twist alignment at 60° to 120°. The liquid crystal cell of the TN mode is most generally used as a color TFT liquid crystal display device, and is disclosed in a plurality of literatures.

In the liquid crystal cell of the VA mode, the rod-like liquid crystalline molecules are substantially subjected to vertical alignment at the time of not applying a voltage. In the liquid crystal cell of the VA mode, (1) a liquid crystal cell of a VA mode (disclosed in JP1990-176625A (JPH02-176625A)) in the narrow sense in which rod-like liquid crystalline molecules are substantially subjected to vertical alignment at the time of not applying a voltage, and are substantially subjected to horizontal alignment at the time of applying a voltage, (2) a liquid crystal cell (of an MVA mode) (disclosed in SID97, Digest of Tech. Papers (Proceedings) 28(1997)845) in which a VA mode is subjected to multi-domain in order to widen a view angle, (3) a liquid crystal cell (of an n-ASM mode) (disclosed in Proceedings of Japan Liquid Crystal Debating Society 58 to 59(1998)) in which rod-like liquid crystalline molecules are substantially subjected to vertical alignment at the time of not applying a voltage, and are subjected to twist multi-domain alignment at the time of applying a voltage, and (4) a liquid crystal cell of a SURVIVAL mode (published in LCD International 98). In addition, the liquid crystal cell of the VA mode may be any one of a patterned vertical alignment (PVA) type liquid crystal cell, an optical alignment type liquid crystal cell, and a polymer-sustained alignment (PSA) type liquid crystal cell. The details of the mode are disclosed in JP2006-215326A and JP2008-538819A.

In the liquid crystal cell of the IPS mode, rod-like liquid crystal molecules are aligned to be substantially parallel to the substrate, and an electric field parallel to a substrate surface is applied, and thus, the liquid crystal molecules planarly respond. In the IPS mode, black display is performed in a state of not applying an electric field, and the absorption axes of a pair of upper and lower polarizing plates are orthogonal to each other. A method of improving a view angle by reducing light leakage at the time of black display in an oblique direction using an optical compensation sheet is disclosed in JP1998-54982A (JP-H10-54982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

It is preferable that an embodiment of the liquid crystal display device includes a liquid crystal cell in which a liquid crystal layer is interposed between facing substrates of which at least one includes an electrode, and the liquid crystal cell is configured by being arranged between two polarizing plates. The liquid crystal display device includes the liquid crystal cell in which a liquid crystal is sealed between upper and lower substrates, changes the alignment state of the liquid crystal by applying a voltage, and thus, displays an image.

Further, as necessary, the liquid crystal display device includes an associated functional layer such as a polarizing plate protective film or an optical compensation member performing optical compensation, and an adhesive layer. In addition, the display device of the present invention may include other members. For example, a surface layer such as a forward scattering layer, a primer layer, an antistatic layer, and an undercoat layer may be arranged along with (or instead of) a color filter substrate, a thin layer transistor substrate, a lens film, a diffusion sheet, a hard coat layer, an anti-reflection layer, a low reflection layer, an antiglare layer, and the like.

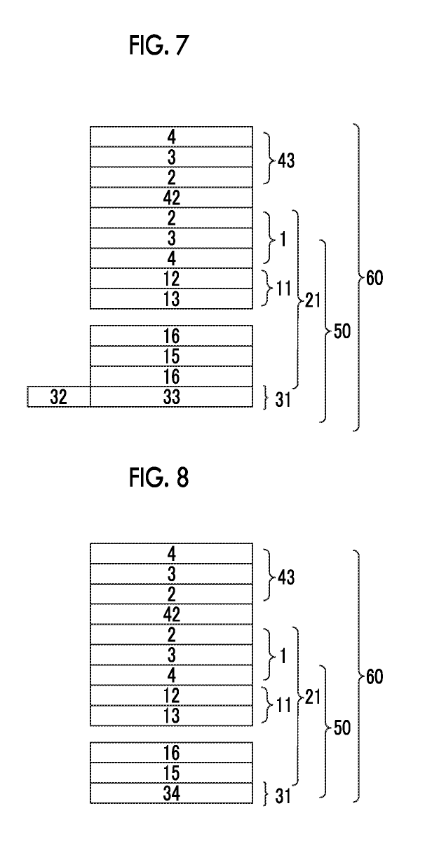

The display device of the present invention includes a light guide plate bonded to the light source described above, and it is preferable that the display device further includes an optical sheet in at least one position between the light guide plate described above and the optical conversion sheet described above, between the optical conversion sheet described above and the wavelength selective reflective polarizer described above, and between the wavelength selective reflective polarizer described above and the polarizing plate described above. In the display device of the present invention, it is more preferable that the optical sheet described above is a single-layer optical sheet or a laminated optical sheet selected from any one or more of a prism sheet, a lens sheet, and a scattering sheet. FIG. 6 illustrates an example of an embodiment including the optical sheet 16 between the optical conversion sheet described above and the wavelength selective reflective polarizer described above. FIG. 7 illustrates an example of an embodiment including a first optical sheet 16 between the light guide plate described above and the optical conversion sheet and a second optical sheet 16 between the optical conversion sheet described above and the wavelength selective reflective polarizer described above.

In the display device, it is preferable that the backlight unit, the optical sheet member of the present invention, the thin layer transistor substrate, the liquid crystal cell, the color filter substrate, and a display side polarizing plate 43 are laminated in this order.

In the display device of the present invention, it is preferable that the optical conversion sheet described above includes a fluorescent material member in which the fluorescent material described above is dispersed in a polymer matrix between two base films on which an oxygen gas barrier layer is disposed, and the optical conversion sheet described above is arranged between the wavelength selective reflective polarizer described above and the light source described above.

Furthermore, the display device of the present invention is not limited to such an example.

(Color Filter)

In a case where the light source uses visible B (blue light) of less than or equal to 500 nm, a pixel of the present invention is able to be formed by using known various methods as an RGB pixel forming method. For example, a desired black matrix, and pixel patterns of R, G, and B are able to be formed on a glass substrate by using a photomask and a photoresist, and an ink composition is discharged in a black matrix having a predetermined width and in a region (a concave portion surrounded by a convex portion) which is divided by an n-th black matrix having a width wider than that of the black matrix described above by using coloring inks for a pixel of R, G, and B until a desired concentration is obtained by using a printing device of an inkjet method, and a color filter formed of patterns of R, G, and B is able to be prepared. Each pixel and black matrix may be completely cured by performing baking or the like after image coloring. Preferred properties of the color filter are disclosed in JP2008-083611A and the like, and the contents of the publication are incorporated in the present invention.

For example, it is preferable that one wavelength which is the half transmittance of the maximum transmittance in a color filter exhibiting a green color is greater than or equal to 590 nm and less than or equal to 610 nm, and the other wavelength is greater than or equal to 470 nm and less than or equal to 500 nm. In addition, it is preferable that one wavelength which is the half transmittance of the maximum transmittance described above in the color filter exhibiting a green color is greater than or equal to 590 nm and less than or equal to 600 nm. Further, the maximum transmittance in the color filter exhibiting a green color is greater than or equal to 80%. It is preferable that the wavelength which is the maximum transmittance in the color filter exhibiting a green color is greater than or equal to 530 nm and less than or equal to 560 nm.

In the light source of the light source unit described above, it is preferable that the wavelength of an emission peak in a wavelength range of greater than or equal to 600 nm and less than or equal to 700 nm is greater than or equal to 620 nm and less than or equal to 650 nm. It is preferable that the light source of the light source unit described above has an emission peak in a wavelength range of greater than or equal to 600 nm and less than or equal to 700 nm, and it is preferable that the transmittance at the wavelength of the emission peak described above is less than or equal to 10% of the maximum transmittance in the color filter exhibiting a green color described above.

In the color filter exhibiting a red color described above, it is preferable that the transmittance in a wavelength range of greater than or equal to 580 nm and less than or equal to 590 nm is less than or equal to 10% of the maximum transmittance.

In a blue color, complementary pigment C. I. and Pigment Violet 23 are used in C. I. Pigment Blue 15:6 as a pigment for a color filter. In a red color, C. I. Pigment Yellow 139 as a complementary color is used in C. I. Pigment Red 254. C. I. Pigment Yellow 150, C. I. Pigment Yellow 138, or the like as a complementary pigment is used in general C. I. Pigment Green 36 (copper bromide phthalocyanine green) and C. I. Pigment Green 7 (copper chloride phthalocyanine green) as a green pigment. The composition of the pigment is able to be controlled by being adjusted. The composition of the complementary pigment increases in a small amount compared to a comparative example, and thus, a half-value wavelength on a long wavelength side is able to be set to be in a range of 590 nm to 600 nm. Furthermore, currently, a pigment is generally used, but a color filter using a dye may be used insofar as the pigment is a pigment in which a spectrum is able to be controlled and process stability and reliability are able to be ensured.

(Black Matrix)

In the display device of the present invention, the black matrix is arranged between the respective pixels. Examples of a material forming a black stripe include a sputtering film of metal such as chromium, a light shielding photosensitive composition in which a photosensitive resin, a black coloring agent, and the like are combined, and the like. Specific examples of the black coloring agent include carbon black, titanium carbon, iron oxide, titanium oxide, black lead, and the like, and among them, the carbon black is preferable.

(Thin Layer Transistor)

It is preferable that the display device of the present invention further includes a TFT substrate including a thin layer transistor (hereinafter, also referred to as TFT).

It is preferable that the thin layer transistor described above includes an oxide semiconductor layer having a carrier concentration of less than 1×10¹⁴/cm³. A preferred embodiment of the thin layer transistor described above is disclosed in JP2011-141522A, and the contents of the publication are incorporated in the present invention.

<Bonding Method of Optical Sheet Member to Display Device>

A known method is able to be used as a method of bonding the optical sheet member of the present invention to the display device such as a liquid crystal display device. In addition, a roll to panel manufacturing method is able to be used, and is preferable from the viewpoint of improving productivity and a yield. The roll to panel manufacturing method is disclosed in JP2011-48381A, JP2009-175653A, JP4628488B, JP4729647B, WO2012/014602A, WO2012/014571A, and the like, but is not limited thereto.

### Other Embodiments

Other embodiments of the present invention are also able to include the following embodiments.

[1]

An optical sheet member including an optical conversion sheet containing a fluorescent material which absorbs at least a part of light in a wavelength range of 380 nm to 480 nm, converts the absorbed light into light in a wavelength range longer than that of the light described above, and re-emits the converted light; and a wavelength selective reflective polarizer functioning in at least a part of the wavelength range described above.

[2]

The wavelength selective reflective polarizer described above is a light reflection layer formed by immobilizing a cholesteric liquid crystalline phase which reflects light in at least a part of the wavelength range of 380 nm to 480 nm, and a half band width of a reflection range of the reflection polarizer described above is 15 nm to 200 nm, the wavelength selective reflective polarizer described above includes a λ/4 plate satisfying at least one of Expressions (1) to (3) described below (more preferably, all of Expressions (1) to (3)), wavelength dispersion of the λ/4 plate may be forward dispersion “Re(450)> Re(550)”, flat dispersion “Re(450) Re(550)” is able to be preferably used as the wavelength dispersion of the λ/4 plate, and reverse dispersion “Re(450)<Re(550)” is able to be more preferably used as the wavelength dispersion of the λ/4 plate.

450 nm/4−60 nm<Re(450)<450 nm/4+60 nm Expression (1)

550 nm/4−60 nm<Re(550)<550 nm/4+60 nm Expression (2)

630 nm/4−60 nm<Re(630)<630 nm/4+60 nm Expression (3)

(In Expressions (1) to (3), Re(λ) represents retardation (unit: nm) in the in-plane direction at a wavelength of λ nm.)

[3]

The optical sheet member according to [1], in which the wavelength selective reflective polarizer described above is a light reflection layer formed by immobilizing a cholesteric liquid crystalline phase which reflects light in at least a part of the wavelength range of 380 nm to 480 nm, and a half band width of a reflection range of the reflection polarizer described above is 15 nm to 200 nm, and the wavelength selective reflective polarizer described above includes a λ/4 plate satisfying at least one of Expressions (1) to (4) described below (more preferably, all of Expressions (1) to (3)).

450 nm/4−40 nm<Re(450)<450 nm/4+40 nm Expression (1)

550 nm/4−40 nm<Re(550)<550 nm/4+40 nm Expression (2)

630 nm/4−40 nm<Re(630)<630 nm/4+40 nm Expression (3)

Re(450)<Re(550)<Re(630) Expression (4)

(In Expressions (1) to (4), Re(λ) represents retardation (unit: nm) in the in-plane direction at a wavelength of λ nm.)

[4]

The optical sheet member according to [2] or [3], in which λ/4 retardation layer described above is a retardation film containing at least one of a (approximately optically monoaxial or biaxial) retardation film or a liquid crystal compound (a discotic liquid crystal, a rod-like liquid crystal, and a cholesteric liquid crystal).

[5]

The optical sheet member according to any one of [1] to [4], in which the wavelength selective reflective polarizer described above is a dielectric multi-layer film which has at least a reflection range in a wavelength range of 380 nm to 480 nm and has a half band width of 15 nm to 200 nm.

[6]

A light source unit for a display device including at least a light source having a wavelength of 380 nm to 480 nm, an optical conversion sheet containing at least one fluorescent material which absorbs at least a part of light emitted from the light source described above, converts the absorbed light into light in a wavelength range longer than that of the light source described above, and re-emits the converted light, and a wavelength selective reflective polarizer functioning in at least a part of the wavelength range of the light source described above.

[7]

A display device including the light source unit for a display device according to [6] which includes the wavelength selective reflective polarizer, and a device switching light of the light source described above.

[8]

A liquid crystal display device, in which the optical switching device according to [7] is a liquid crystal driving device, and the liquid crystal display device includes a polarizing plate between the reflection polarizing plate described above and the liquid crystal driving device.

[9]

An optical sheet member and a liquid crystal display device using the optical sheet member, in which the light source according to any one of [6] to [8] includes a blue LED, the optical conversion sheet includes a fluorescent material having a light emission wavelength of green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a half band width of less than or equal to 100 nm.

[10]

An optical sheet member and a liquid crystal display device using the optical sheet member, in which the polarizing plate and the wavelength selective reflective polarizer according to any one of [1] to [9] are laminated directly in contact with each other or through an adhesive layer.

[11]

The liquid crystal display device according to any one of [1] to [10], the polarizing plate, the λ/4 plate, and the wavelength selective reflective polarizer are laminated in this order directly in contact with each other or through the adhesive layer.

[12]

The liquid crystal display device according to any one of [1] to [11], in which the liquid crystal display device includes a light guide plate (LGP) bonded to a blue light source, and an optical sheet at least one position between the light guide plate and the optical conversion sheet, between the optical conversion sheet and the wavelength selective reflective polarizing plate, and between the wavelength selective reflective polarizing plate and a polarizing plate of a liquid crystal panel.

[13]

A liquid crystal display device, in which the optical sheet according to [12] is an optical sheet or a laminated optical sheet selected from one or more a prism sheet, a lens sheet, and a scattering sheet.

[14]

An optical sheet member and a liquid crystal display device using the optical sheet member, in which the optical conversion sheet according to any one of [1] to [13], a fluorescent material (quantum dot) member in which a fluorescent material is dispersed in a polymer matrix is arranged between two base films on which an oxygen gas barrier layer is disposed, and the optical conversion sheet is arranged between the wavelength selective reflective polarizer and the blue light source.

[15]

The liquid crystal display device according to any one of [8] to [14], in which the liquid crystal display device further includes a thin layer transistor, and the thin layer transistor includes an oxide semiconductor layer having a carrier concentration of less than 1×10¹⁴/cm³.

### EXAMPLES

Hereinafter, the characteristics of the present invention will be more specifically described with reference to examples and comparative examples. Materials, used amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

### Manufacturing Example 1

### Preparation of Polarizing Plate

A commercially available cellulose acylate-based film “TD60” (manufactured by Fujifilm Corporation) was prepared as a front-side polarizing plate protective film of a backlight side polarizing plate.

A commercially available cellulose acylate-based film “TD60” (manufactured by Fujifilm Corporation) was used as a rear-side polarizing plate protective film of the backlight side polarizing plate.

A polarizer was manufactured by the same method as that in [0219] to [0220] of JP2006-293275A, the retardation film and the polarizing plate protective film described above were bonded to both surfaces of the polarizer, and thus, a polarizing plate was manufactured. In addition, the polarizing plate protective film on one surface may function as a λ/4 layer, and the polarizing plate protective film on one surface is able to be omitted from the viewpoint of reducing the thickness.

### Manufacturing Example 2

### Preparation of Polarizing Plate

A retardation film and a polarizing plate protective film were respectively bonded to both surfaces of a polarizer, and thus, a polarizing plate was manufactured by the same method as that in Manufacturing Example 1 except that a long film 1 having a thickness of 40 μm, which was formed by supplying a pellet of a mixture having Tg of 127° C. of 90 parts by mass of an acrylic resin having a lactone ring structure {Copolymerization Monomer Mass Ratio=Methyl Methacrylate/Methyl 2-(Hydroxy Methyl) Acrylate=8/2, a lactone cyclization rate of approximately 100%, a content ratio of the lactone ring structure of 19.4%, a weight average molecular weight of 133000, a melt flow rate of 6.5 g/10 minutes (240° C., 10 kgf), Tg of 131° C.} and 10 parts by mass of an acrylonitrile-styrene (AS) resin {TOYO AS AS20, manufactured by TOYO STYRENE Co., Ltd.} to a biaxial extruder, and by performing melting extrusion at a temperature of approximately 280° C. into the shape of a sheet, was used as the rear-side polarizing plate protective film of the backlight side polarizing plate. In addition, the polarizing plate protective film on one surface may function as a λ/4 layer, and the polarizing plate protective film on one surface is able to be omitted from the viewpoint of reducing the thickness.

### Manufacturing Example 3

### Preparation of Polarizing Plate

A retardation film and a polarizing plate protective film were respectively bonded to both surfaces of a polarizer, and thus, a polarizing plate was manufactured by the same method as that in Manufacturing Example 1 except that a commercially available COP film “ZEONOR ZF14” (manufactured by Zeon Corporation) was used as the rear-side polarizing plate protective film of the backlight side polarizing plate. In addition, the polarizing plate protective film on one surface may function as a λ/4 layer, and the polarizing plate protective film on one surface is able to be omitted from the viewpoint of reducing the thickness.

### Example 1A

### Formation of Wavelength Selective Reflective Polarizer

A wavelength selective reflective polarizer for an optical sheet member of Example 1A including a light reflection layer formed by immobilizing a cholesteric liquid crystalline phase having a reflection center wavelength of 500 nm and a half band width of 140 nm was formed by changing the added amount of a chiral agent using a liquid crystal having Δn of 0.4 on a polarizing plate protective film (a commercially available cellulose acylate-based film “TD60” (manufactured by Fujifilm Corporation)) with reference to Fuji Film Research & Development No. 50 (2005) pp. 60-63. Furthermore, the used polarizing plate protective film had Re of 1 nm and Rth of 38 nm, and had a function of a λ/4 plate in a wavelength range of 380 nm to 760 nm.

In addition, the obtained total thickness was approximately 65 μm including the polarizing plate protective film.

In Manufacturing Example 1, a polarizing plate was prepared by the same method as that in Manufacturing Example 1 except that the wavelength selective reflective polarizer obtained as described above was used instead of one protective film of Manufacturing Example 1 described above, and the obtained polarizing plate was set to a BL side polarizing plate for a display device of Example 1A.

<Formation of Optical Conversion Sheet>

A quantum dot sheet (a quantum dot material (G,R)) emitting fluorescent light of green light having a center wavelength of 540 nm and a half band width of 40 nm and red light having a center wavelength of 645 nm and a half band width of 30 nm when blue light of a blue light emission diode was incident thereon was formed as an optical conversion sheet with reference to JP2012-169271A.

<Manufacturing of Liquid Crystal Display Device>

A commercially available liquid crystal display device (manufactured by Sony Corporation, Product Name: KDL-46W900A) was disassembled, the BL side polarizing plate for a display device of Example 1A (including the wavelength selective reflective polarizer) was used as a backlight side polarizing plate without disposing a dielectric multi-layer film (Product Name: DBEF (Registered Trademark), manufactured by 3M Company), and a backlight unit was changed to an RGB narrowband backlight unit described below, and thus, a display device of Example 1A was manufactured.

The RGB narrowband backlight unit was formed by disassembling the TV described above, by removing a quantum dot bar which was provided therein, by forming a blue light source BL including a blue light emission diode (a main wavelength of 446 nm and a half band width of 23 nm), by arranging a light guide plate, a scattering plate, and a prism sheet of BL, and by arranging the optical conversion sheet described above thereon. A laminated body of the obtained optical conversion sheet, the obtained wavelength selective reflective polarizer, and the obtained polarizing plate was set to an optical sheet member of Example 1.

In this example, the optical conversion sheet and the wavelength selective reflective polarizer are separately arranged, and it is more preferable that the optical conversion sheet is bonded to the light reflection layer by using an acrylic adhesive agent having a refractive index of 1.47 from the viewpoint of a light consumption rate and a reduction in the thickness.

The display device of Example 1A does not include a λ/4 plate, and thus, left circularly polarized light of blue light exiting from the RGB narrowband backlight unit passes through the light reflection layer formed by immobilizing the cholesteric liquid crystalline phase having a right twist, and then, is incident on the polarizer of the BL side polarizing plate in a state of the left circularly polarized light (which is not converted into linearly polarized light by the λ/4 plate). On the other hand, right circularly polarized light of the blue light exiting from the RGB narrowband backlight unit is reflected on the light reflection layer formed by immobilizing the cholesteric liquid crystalline phase having a right twist, is reflected on the reflection member which is provided in the commercially available liquid crystal display device by being converted into non-polarized blue light, and re-exits from the RGB narrowband backlight unit.

### Example 1B

### Formation of Forward Dispersion λ/4 Plate

A λ/4 plate was prepared on a commercially available cellulose acylate-based film “TD60” (manufactured by Fujifilm Corporation) by using a discotic liquid crystal with reference to JP2012-108471A. In the obtained λ/4 plate, Re(450) was 137 nm, Re(550) was 125 nm, and Re(630) was 120 nm, and the thickness of a liquid crystal layer was approximately 0.8 μm, and was approximately 60 μm including a support (TAC).

<Formation of Wavelength Selective Reflective Polarizer>

A wavelength selective reflective polarizer for an optical sheet member of Example 1B including a light reflection layer formed by immobilizing a cholesteric liquid crystalline phase having a half band width of 50 nm was formed on the λ/4 plate described above by changing the added amount of a chiral agent using a liquid crystal having Δn of 0.16 with reference to Fuji Film Research & Development No. 50 (2005) pp. 60-63, reflection center wavelength 450 nm.

In addition, the total thickness of the obtained λ/4 plate and the light reflection layer was approximately 63 μm including a polarizing plate protective film.

In Manufacturing Example 1, a polarizing plate was prepared by the same method as that in Manufacturing Example 1 except that the wavelength selective reflective polarizer obtained as described above was used instead of one protective film of Manufacturing Example 1 described above, and thus, the obtained polarizing plate was set to a BL side polarizing plate for a display device of Example 1B.

<Formation of Optical Conversion Sheet>

A quantum dot sheet (a quantum dot material (G,R)) emitting fluorescent light of green light having a center wavelength of 540 nm and a half band width of 40 nm and red light having a center wavelength of 645 nm and a half band width of 30 nm when blue light of a blue light emission diode was incident thereon was formed as an optical conversion sheet with reference to JP2012-169271A.

<Manufacturing of Liquid Crystal Display Device>

A commercially available liquid crystal display device (manufactured by Sony Corporation, Product Name: KDL-46W900A) was disassembled, the BL side polarizing plate for a display device of Example 1B (including the wavelength selective reflective polarizer) was used as a backlight side polarizing plate without disposing a dielectric multi-layer film (Product Name: DBEF (Registered Trademark), manufactured by 3M Company), and a backlight unit was changed to an RGB narrowband backlight unit described below, and thus, a display device of Example 1B was manufactured

The RGB narrowband backlight unit was formed by disassembling the TV described above, by removing a quantum dot bar which was provided therein, by forming a blue light source BL including a blue light emission diode (a main wavelength of 446 nm and a half band width of 23 nm), by arranging a light guide plate, a scattering plate, and a prism sheet of BL, and by arranging the optical conversion sheet described above thereon. A laminated body of the obtained optical conversion sheet, the obtained wavelength selective reflective polarizer, the obtained λ/4 plate, and the obtained the polarizing plate was set to an optical sheet member of Example 1B.

In this example, the optical conversion sheet and the wavelength selective reflective polarizer are separately arranged, and it is more preferable that the optical conversion sheet is bonded to the light reflection layer by using an acrylic adhesive agent having a refractive index of 1.47 from the viewpoint of a light consumption rate and a reduction in the thickness.

### Example 1C

### Formation of Forward Dispersion λ/4 Plate

A λ/4 plate was prepared on a commercially available cellulose acylate-based film “TD60” (manufactured by Fujifilm Corporation) by using a discotic liquid crystal with reference to JP2012-108471A. In the obtained λ/4 plate, Re(450) was 140 nm, Re(550) was 128 nm, and Re(630) was 123 nm, and the thickness of a liquid crystal layer was approximately 0.8 μm, and was approximately 60 μm including a support (TAC).

<Formation of Wavelength Selective Reflective Polarizer>

A first light reflection layer was formed on the obtained forward dispersion λ/4 plate by the following method as a light reflection layer formed by immobilizing a cholesteric liquid crystalline phase using a disk-like liquid crystal compound as a cholesteric liquid crystal material.

First, as an alignment layer, POVAL PVA-103 manufactured by KURARAY CO., LTD. was dissolved in pure water, and then, was applied onto a PET base with a bar by adjusting the concentration such that the thickness of the dried film was 0.5 μm, and after that, was heated at 100° C. for 5 minutes. Further, the surface thereof was subjected to a rubbing treatment, and thus, an alignment layer was formed.

Subsequently, a solute having compositions described below was dissolved in a mixed solvent of CH₂Cl₂ and C₂H₅OH at a mass ratio of 98:2 by adjusting the concentration such that the thickness of the dried film of the first light reflection layer was as shown in Table 2 described below, and thus, a coating liquid for forming a first light reflection layer including a disk-like liquid crystal compound was prepared. The coating liquid was applied onto the alignment layer described above with a bar, and the solvent was vaporized by being retained at 70° C. for 2 minutes, and then, was heated and matured at 100° C. for 4 minutes, and thus, an even alignment state was obtained.

After that, the coating film was retained at 80° C. and was subjected to ultraviolet irradiation by using a high pressure mercury lamp under nitrogen atmosphere, and thus, a light reflection layer was formed.

The light reflection layer was bonded onto the λ/4 plate described above by using the acrylic adhesive agent described above, the PET base and the alignment layer were peeled off, and thus, the first light reflection layer formed by immobilizing the cholesteric liquid crystalline phase was formed.

<<Solute Composition of Coating Liquid for Forming First Light Reflection Layer Including Disk-Like Liquid Crystal Compound>>

| | | |
|---|---|---|
| Disk-Like Liquid Crystal Compound | 35 | parts by mass |
| (Compound 1 Described below) | | |
| Disk-Like Liquid Crystal Compound | 35 | parts by mass |
| (Compound 2 Described below) | | |
| Chiral Agent (Compound 3 Described below) | 25 | parts by mass |
| Alignment Aid (Compound 4 Described below) | 1 | part by mass |
| Alignment Aid (Compound 5 Described below) | 1 | part by mass |
| Polymerization Initiator (Compound | 3 | parts by mass |
| 6 Described below) | | |

Compound 1 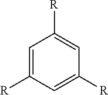 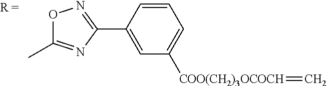
Compound 2 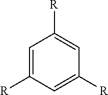 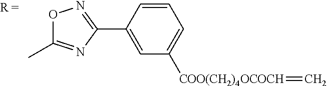
Compound 3 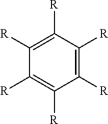 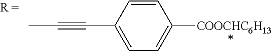
Compound 4 (In the following structural formula, a mixture of two types of compounds having different substitution positions of a methyl group in a benzene ring substituted with trimethyl. A mixed ratio of two types of compounds of 50:50 (Mass Ratio)) 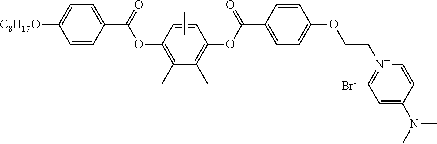
Compound 5 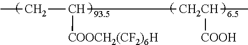
Compound 6

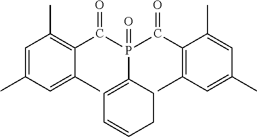

Further, the added amount of the used chiral agent with reference to JP2013-203827A (disclosed in [0016] to [0148]) and Fujifilm Research & Research No. 50 (2005) pp. 60 to 63 with respect to a cholesteric liquid crystalline mixture (R1) using a rod-like liquid crystal compound described below was changed, a second light reflection layer and a third light reflection layer which were the light reflection layer formed by immobilizing the cholesteric liquid crystalline phase using the rod-like liquid crystal compound as the cholesteric liquid crystal material were prepared on a PET film manufactured by Fujifilm Corporation, respectively, the second light reflection layer was bonded onto the first light reflection layer by using the acrylic adhesive agent, and then, the PET film was peeled off, and the third light reflection layer was bonded onto the second light reflection layer by using the acrylic adhesive agent, and then, the PET film was peeled off, and thus, the second light reflection layer and the third light reflection layer formed by immobilizing the cholesteric liquid crystalline phase were formed.

<Preparation of Cholesteric Liquid Crystalline Mixture (R1) Using Rod-Like Liquid Crystal Compound>

Compounds 11 and 12 described below, a fluorine-based horizontal alignment agent, a chiral agent, a polymerization initiator, and a methyl ethyl ketone solvent were mixed, and thus, a coating liquid having compositions described below was prepared. The obtained coating liquid was set to a coating liquid (R1) which was the cholesteric liquid crystalline mixture.

| | | |
|---|---|---|
| Compound 11 Described below | 80 | parts by mass |
| Compound 12 Described below | 20 | parts by mass |
| Fluorine-Based Horizontal Alignment Agent 1 Described below | 0.1 | parts by mass |
| Fluorine-Based Horizontal Alignment Agent 2 Described below | 0.007 | parts by mass |
| Right Turning Chiral Agent LC756 (manufactured by BASF SE) Described below Amount at which Reflection | | |
| Center Wavelength Shown in Table 2 Described below Was Obtained (Second Light Reflection Layer: | | |
| approximately 4.1 parts by mass, and Third Light Reflection Layer: approximately 7.0 parts by mass) | | |
| Polymerization Initiator IRGACURE 819 (manufactured by BASF SE) | 3 | parts by mass |
| Solvent (Methyl Ethyl Ketone) Amount at which Solute Concentration Became 30 mass % | | |

Compound 11 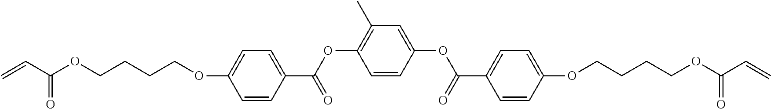 [SMILES: C=CC(=O)OCCCCOc1ccc(C(=O)Oc2ccc(OC(=O)c3ccc(OCCCCOC(=O)C=C)cc3)c(C)c2)cc1]
Compound 12 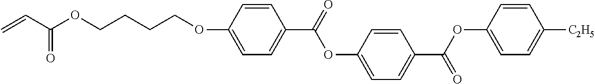 [SMILES: C=CC(=O)OCCCCOc1ccc(C(=O)Oc2ccc(C(=O)Oc3ccc(CC)cc3)cc2)cc1]
Fluorine-Based Horizontal Alignment Agent 1 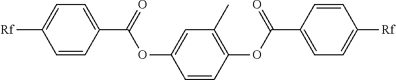 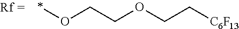
Fluorine-Based Horizontal Alignment Agent 2

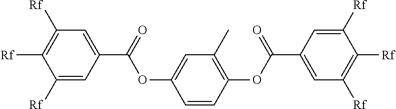

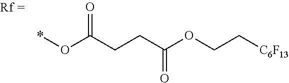

The reflection center wavelength of the maximum reflectivity peak of the obtained first light reflection layer was 450 nm, the half band width was 40 nm, and the film thickness was 1.8 μm.

The reflection center wavelength of the maximum reflectivity peak of the obtained second light reflection layer was 530 nm, the half band width was 50 nm, and the film thickness was 2.0 μm.

The reflection center wavelength of the maximum reflectivity peak of the obtained third light reflection layer was 650 nm, the half band width was 60 nm, and the film thickness was 2.5 μm.

Furthermore, the average refractive index of the first light reflection layer, the second light reflection layer, and the third light reflection layer was 1.57.

In addition, the total thickness of a brightness enhancement film which was a laminated body of the wavelength selective reflective polarizer including the obtained forward dispersion λ/4 plate and the obtained first light reflection layer to the obtained third light reflection layer was approximately 7 μm.

In Manufacturing Example 1, a polarizing plate was prepared by the same method as that in Manufacturing Example 1 except that the wavelength selective reflective polarizer obtained as described above was used instead of one protective film of Manufacturing Example 1 described above, and the obtained polarizing plate was set to a BL side polarizing plate for a display device of Example 1C.

In addition, it was found that it was preferable that at least one layer of the first light reflection layer to the third light reflection layer (the light reflection layer immobilizing the cholesteric liquid crystalline phase) was a light reflection layer formed by immobilizing a cholesteric liquid crystalline phase which was formed of a discotic liquid crystal, and the other light reflection layer was a light reflection layer formed by immobilizing a cholesteric liquid crystalline phase which was formed of a rod-like liquid crystal from the viewpoint of reducing color unevenness in an oblique azimuth.

<Formation of Optical Conversion Sheet>

A quantum dot sheet (a quantum dot material (G,R)) emitting fluorescent light of green light having a center wavelength of 535 nm and a half band width of 40 nm and red light having a center wavelength of 630 nm and a half band width of 40 nm when blue light of a blue light emission diode was incident thereon was formed as an optical conversion sheet with reference to JP2012-169271A.

<Manufacturing of Liquid Crystal Display Device>

A commercially available liquid crystal display device (manufactured by Panasonic Corporation, Product Name: TH-L42D2) was disassembled, the BL side polarizing plate for a display device of Example 1C was used as a backlight side polarizing plate without disposing a dielectric multi-layer film (Product Name: DBEF (Registered Trademark), manufactured by 3M Company), and a backlight unit was changed to an RGB narrowband backlight unit described below, and thus, a display device of Example 1C was manufactured.

The used RGB narrowband backlight unit includes a blue light emission diode (B-LED manufactured by NICHIA CORPORATION, a main wavelength of 465 nm and a half band width of 20 nm) as a light source. In addition, the optical conversion sheet described above is disposed in the front portion of the light source. A laminated body of the obtained optical conversion sheet, the obtained wavelength selective reflective polarizer, the obtained λ/4 plate, and the obtained polarizing plate was set to an optical sheet member of Example 1C.

### Comparative Example 1

A commercially available liquid crystal display device (manufactured by Panasonic Corporation, Product Name: TH-L42D2) was disassembled, the polarizing plate manufactured in Manufacturing Example 1 was used as a backlight side polarizing plate, was separated without disposing a dielectric multi-layer film (Product Name: DBEF (Registered Trademark), manufactured by 3M Company), and was arranged between the backlight side polarizing plate and a backlight unit, and thus, a display device of Comparative Example 1 was manufactured.

In the backlight light source of the display device, the emission peak wavelength of blue light was 450 nm. In a region of green to red, there was one emission peak, the peak wavelength was 550 nm, and the half band width was 100 nm.

### Comparative Example 2

In Example 1, a BL side polarizing plate for a display device of Comparative Example 2 was manufactured by the same method as that in Example 1 described below except that the same first light reflection layer to the same third light reflection layer formed by immobilizing the cholesteric liquid crystalline phase as those of Example 1 were laminated on TAC (Re of 1 nm and Rth of 38 nm) used as a polarizing plate protective film.

In addition, in the manufacturing of the display device of Example 1, an optical sheet member (not including an optical conversion sheet) of Comparative Example 2 and a display device of Comparative Example 2 were manufactured by the same method as that in Example 1 except that the BL side polarizing plate for a display device of Comparative Example 2 was used instead of the BL side polarizing plate for a display device of Example 1, and the same backlight unit as that in Comparative Example 1 was used without changing the backlight unit.

### Example 1

### Formation of Broadband λ/4 Plate

A broadband λ/4 plate was prepared as disclosed in [0020] to [0033] of JP2003-262727A. The broadband λ/4 plate was obtained by applying liquid crystal materials of two layers onto a substrate, by polymerizing the materials, and then, by peeling off the polymerized material from the substrate.

In the obtained broadband λ/4 plate, Re(450) was 110 nm, Re(550) was 125 nm, Re(630) was 140 nm, and the film thickness was 1.6 μm.

The obtained broadband λ/4 plate was bonded to the polarizing plate manufactured as described above by using an acrylic adhesive agent having a refractive index of 1.47.

<Formation of Wavelength Selective Reflective Polarizer>

A first light reflection layer formed by immobilizing a cholesteric liquid crystalline phase, a second light reflection layer formed by immobilizing a cholesteric liquid crystalline phase, and a third light reflection layer formed by immobilizing a cholesteric liquid crystalline phase were formed on the obtained broadband λ/4 plate by coating by changing the added amount of the used chiral agent with reference to Fuji Film Research & Development No. 50 (2005) pp. 60-63.

The reflection center wavelength of the maximum reflectivity peak of the obtained first light reflection layer was 450 nm, the half band width was 40 nm, and the film thickness was 1.8 μm.

The reflection center wavelength of the maximum reflectivity peak of the obtained second light reflection layer was 550 nm, the half band width was 50 nm, and the film thickness was 2.0 μm.

The reflection center wavelength of the maximum reflectivity peak of the obtained third light reflection layer was 630 nm, the half band width was 60 nm, and the film thickness was 2.1 μm.

Furthermore, the average refractive index of the first light reflection layer, the second light reflection layer, and the third light reflection layer was 1.57.

In addition, the total thickness of a brightness enhancement film including the obtained wavelength selective reflective polarizer which included the obtained forward dispersion λ/4 plate and the obtained first light reflection layer to the obtained third light reflection layer was approximately 7 μm.

The laminated body of the polarizing plate and the brightness enhancement film obtained as described above was set to a BL side polarizing plate for a display device of Example 1.

<Manufacturing of Liquid Crystal Display Device>

A commercially available liquid crystal display device (manufactured by Panasonic Corporation, Product Name: TH-L42D2) was disassembled, the BL side polarizing plate for a display device of Example 1 was used as a backlight side polarizing plate without disposing a dielectric multi-layer film (Product Name: DBEF (Registered Trademark), manufactured by 3M Company), and a backlight unit was changed to an RGB narrowband backlight unit described below, and thus, a display device of Example 1 was manufactured.

The used RGB narrowband backlight unit includes a blue light emission diode (B-LED manufactured by NICHIA CORPORATION, a main wavelength of 465 nm and a half band width of 20 nm) as a light source. In addition, a quantum dot member emitting fluorescent light of green light having a center wavelength of 535 nm and a half band width of 40 nm and red light having a center wavelength of 630 nm and a half band width of 40 nm when blue light of the blue light emission diode is incident thereon is disposed in the front portion of the light source. A laminated body of the obtained optical conversion sheet, the obtained wavelength selective reflective polarizer, the obtained λ/4 plate, and the obtained polarizing plate was set to an optical sheet member of Example 1. In addition, a reflection member converting and reflecting the polarization state of light which is emitted from the light source and is reflected on the wavelength selective reflective polarizer of the optical sheet member described above is disposed in the rear portion of the light source.

### Example 2

A ¼ wavelength plate in DLC vertical alignment was prepared. In the obtained ¼ wavelength plate, Re(550) was 128 nm.

A wavelength selective reflective polarizer having a reflection center wavelength of 465 nm and a half band width of 15 nm, which was prepared by using a liquid crystal having Δn of 0.06, was laminated on the obtained ¼ wavelength plate, and the ¼ wavelength plate was bonded to the wavelength selective reflective polarizer by using an acrylic adhesive agent having a refractive index of 1.47, and thus, a brightness enhancement film was formed.

In Example 1, an optical sheet member of Example 2 and a display device of Example 2 were manufactured by the same method as that in Example 1 except that the brightness enhancement film used in Example 1 was changed to the brightness enhancement film formed in Example 2.

### Example 3

A ¼ wavelength plate in DLC vertical alignment was prepared. In this example, the ¼ wavelength plate was formed on a low birefringence acrylic film (Re≦5 nm) prepared in [Manufacturing Example 2]. In the obtained ¼ wavelength plate, Re(550) was 127 nm

A wavelength selective reflective polarizer having a reflection center wavelength of 465 nm and a half band width of 60 nm, which was prepared by using a liquid crystal having Δn of 0.2, was laminated on the obtained ¼ wavelength plate, and thus, a brightness enhancement film was formed.

In Example 1B, an optical sheet member of Example 3 and a display device of Example 3 were manufactured by the same method as that in Example 1B except that the brightness enhancement film used in Example 1B was changed to the brightness enhancement film formed in Example 3.

### Example 4

A ¼ wavelength plate in DLC vertical alignment was prepared. In the obtained ¼ wavelength plate, Re(550) was 124 nm.

A wavelength selective reflective polarizer having a reflection center wavelength of 520 nm and a half band width of 150 nm (a reflection range corresponding to the half band width of the reflectivity peak, that is, a reflection range in which the reflectivity of the reflectivity peak was greater than or equal to 25% was 445 nm to 595 nm), which was prepared by using a liquid crystal having Δn of 0.5, was laminated on the obtained ¼ wavelength plate, and thus, a brightness enhancement film was formed.

In Example 1B, an optical sheet member of Example 4 and a display device of Example 4 were manufactured by the same method as that in Example 1B except that the brightness enhancement film used in Example 1B was changed to the brightness enhancement film formed in Example 4.

### Example 5

### Preparation of Support

First, a cellulose ester support for a λ/4 plate used in Example 5 was prepared.

(Preparation of Cellulose Acylate Film)

Compositions described below were put into a mixing tank and were stirred, and each component was dissolved, and thus, a cellulose acetate solution was prepared.

### Composition of Core Layer Cellulose Acylate Dope:

| | |
|---|---|
| Cellulose Acetate Having Degree of Acetyl Substitution of 2.88 | 100 parts by mass |
| Plasticizer 2 (structure described below) | 15 parts by mass |
| Methylene Chloride | 426 parts by mass |
| Methanol | 64 parts by mass |
| (Plasticizer 2) | |

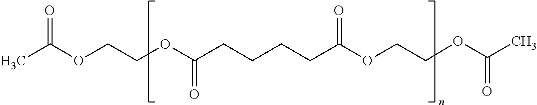

10 parts by mass of a matting agent solution described below was added to 90 parts by mass of the core layer cellulose acylate dope described above, and thus, an outer layer cellulose acetate solution was prepared.

Composition of Matting Agent Solution:

| | | |
|---|---|---|
| Silica Particles Having Average Particle Size | 2 | parts by mass |
| of 20 nm (AEROSIL R972, manufactured by | | |
| NIPPON AEROSIL CO., LTD.) | | |
| Methylene Chloride | 76 | parts by mass |
| Methanol | 11 | parts by mass |
| Core Layer Cellulose Acylate Dope | 1 | part by mass |

Three layers of the core layer cellulose acylate dope described above, and the outer layer cellulose acylate dopes on both sides of the core layer cellulose acylate dope were simultaneously casted from a casting port onto a drum at 20° C. Peeling off was performed in a state where a solvent content ratio was approximately 20 mass %, both ends of the film in a width direction were fixed by a tenter clip, and the film was dried while being stretched in a horizontal direction at a stretching ratio of 1.1 times in a state where a residual solvent was in the amount of 3% to 15%. After that, a cellulose acylate film having a thickness of 60 μm and Rth of 0 nm was prepared by being transported between rolls of a heat treatment device, and thus, a cellulose acylate film T2 was obtained.

(Alkali Saponification Treatment)

The cellulose acylate film T2 described above passed through dielectric heating rolls at a temperature of 60° C., and thus, the film surface temperature was heated to 40° C., and then, an alkali solution having compositions described below was applied onto the band surface of the film by using a bar coater at a coating amount of 14 ml/m² and transported under a steam type far infrared heater manufactured by Noritake Co., Ltd. which was heated to 110° C. for 10 seconds. Subsequently, pure water was applied thereon by using the same bar coater at a coating amount of 3 ml/m². Next, water washing of a fountain coater and water draining of an air knife were repeated three times, and then, the film was dried by being transported to a drying zone at 70° C. for 10 seconds, and thus, a cellulose acylate film which had been subjected to an alkali saponification treatment was prepared.

Alkali Solution Composition

| | | |
|---|---|---|
| Potassium Hydroxide | 4.7 | parts by mass |
| Water | 15.8 | parts by mass |
| Isopropanol | 63.7 | parts by mass |
| Surfactant SF-1: C₁₄H₂₉O(CH₂CH₂O)₂₀H | 1.0 | part by mass |
| Propylene Glycol | 14.8 | parts by mass |

<Formation of Alignment Film>

An alignment film coating liquid (A) having compositions described below of which the concentration was adjusted such that the thickness of the dried film became 0.5 μm was continuously applied onto the surface of the cellulose acylate film T2 to which the alkali saponification treatment had been performed by using a wire bar of #14. The alignment layer coating liquid (A) was dried by hot air at 60° C. for 60 seconds, and further dried by hot air at 100° C. for 120 seconds. The degree of saponification of the used modified polyvinyl alcohol was 96.8%.

Composition of Alignment Film Coating Liquid:

| | | |
|---|---|---|
| Modified Polyvinyl Alcohol Described above | 10 | parts by mass |
| Water | 308 | parts by mass |
| Methanol | 70 | parts by mass |
| Isopropanol | 29 | parts by mass |
| Photopolymerization Initiator (IRGACURE | 0.8 | parts by mass |
| 2959, manufactured by BASF SE) | | |

The alignment film prepared as described above was continuously subjected to a rubbing treatment. At this time, a longitudinal direction of a long film was parallel to a transport direction, and an angle between the longitudinal direction of the film and a rotational axis of a rubbing roller was approximately 45°.

<Formation of λ/4 Plate>

Subsequently, a solute having compositions described below was dissolved in MEK by adjusting the concentration such that the thickness of the dried film thickness became 1.2 μm, and thus, a coating liquid was prepared. The coating liquid was applied onto the alignment layer described above with a bar, and was heated and matured at 80° C. for 1 minute, and thus, an even alignment state was obtained. After that, the coating film was retained at 75° C. and was subjected to ultraviolet irradiation under nitrogen atmosphere by using a high pressure mercury lamp, and thus, a λ/4 plate was formed on a support. In a case where the retardation of the obtained film at 550 nm was measured, Re was 126 nm.

Solute Composition of Coating Liquid for λ/4 Plate:

| | | |
|---|---|---|
| Disk-Like Liquid Crystal Compound (Compound 101 Described above) | 80 | parts by mass |
| Disk-Like Liquid Crystal Compound (Compound 102 Described above) | 20 | parts by mass |
| Alignment Aid 1 Having Structure Described below | 0.9 | parts by mass |
| Alignment Aid 2 Having Structure Described above | 0.08 | parts by mass |
| Surfactant 1 Described above | 0.075 | parts by mass |
| Polymerization Initiator 1 Having Structure Described above | 3 | parts by mass |
| Polymerizable Monomer Having Structure Described above | 10 | parts by mass |
| Alignment Aid 1 | | |

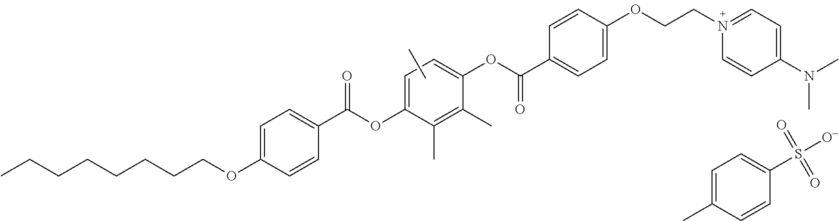

A wavelength selective reflective polarizer (a reflection range corresponding to the half band width of the reflectivity peak, that is, a reflection range in which the reflectivity of the reflectivity peak was greater than or equal to 25% was 445 nm to 595 nm) having a reflection center wavelength of 520 nm and a half band width of 150 nm, which was prepared by using a liquid crystal having Δn of 0.5, was laminated on the obtained ¼ wavelength plate in a laminated state of a TAC film, and thus, a brightness enhancement film was formed.

In Example 1, an optical sheet member of Example 5 and a display device of Example 5 were manufactured by the same method as that in Example 1 except that the brightness enhancement film used in Example 1 was changed to the brightness enhancement film formed in Example 5.

### Example 6

A ¼ wavelength plate in DLC vertical alignment was prepared. In the obtained ¼ wavelength plate, Re(550) was 124 nm.

A wavelength selective reflective polarizer was formed on the obtained ¼ wavelength plate by using a pitch gradient method and the following method with reference to a method disclosed in [0052] to [0053] of JP1994-281814A (JP-H06-281814A). A light reflection layer coating liquid was prepared by using a liquid crystal having Δn of 0.2, and by changing a ratio of a chiral and monomer component A in a method disclosed in [0052] of JP1994-281814A (JP-H06-281814A). The added amount of the chiral and monomer A was adjusted such that the reflection center wavelength of the reflection peak was 500 nm and the half band width was 200 nm (a reflection range corresponding to the half band width of the reflectivity peak, that is, a reflection range in which the reflectivity of the reflectivity peak was greater than or equal to 25% was 400 nm to 600 nm) by using a spectrophotometer UV3150 (manufactured by Shimadzu Corporation). PET which was a temporary support was subjected to a rubbing treatment, and then, a light reflection layer was disposed on the temporary support described above by using the prepared coating liquid.

A wavelength selective reflective polarizer having a half band width of 200 nm which was prepared by a pitch gradient method was transferred from the temporary support and was laminated on the ¼ wavelength plate described above which was in the DLC vertical alignment, and thus, a brightness enhancement film was formed.

In Example 1, an optical sheet member of Example 6 and a display device of Example 6 were manufactured by the same method as that in Example 1 except that the brightness enhancement film used in Example 1 was changed to the brightness enhancement film formed in Example 6.

### Example 6B

A ¼ wavelength plate in DLC vertical alignment was prepared by the same method as that in Example 6. In the obtained ¼ wavelength plate, Re(550) was 124 nm

A wavelength selective reflective polarizer was formed on the obtained ¼ wavelength plate by using a pitch gradient method and the following method with reference to a method disclosed in [0052] and [0053] of JP1994-281814A (JP-H06-281814A). A light reflection layer coating liquid was prepared by using a liquid crystal having Δn of 0.2, and by changing a ratio of a chiral and monomer component A in a method disclosed in [0052] of JP1994-281814A (JP-H06-281814A). The added amount of the chiral and monomer A was adjusted such that the reflection center wavelength of the reflection peak was 620 nm and the half band width was 400 nm (a reflection range corresponding to the half band width of the reflectivity peak, that is, a reflection range in which the reflectivity of the reflectivity peak was greater than or equal to 25% was 420 nm to 820 nm) by using a spectrophotometer UV3150 (manufactured by Shimadzu Corporation). PET which was a temporary support was subjected to a rubbing treatment, and then, a light reflection layer was disposed on the temporary support described above by using the prepared coating liquid.

A wavelength selective reflective polarizer having a half band width of 400 nm which was prepared by a pitch gradient method was transferred from the temporary support and was laminated on the ¼ wavelength plate described above which was in the DLC vertical alignment, and thus, a brightness enhancement film was formed.

In Example 1, an optical sheet member of Example 6B and a display device of Example 6B were manufactured by the same method as that in Example 1 except that the brightness enhancement film used in Example 1 was changed to the brightness enhancement film formed in Example 6B.

### Example 7

In Example 1C, an optical sheet member of Example 7 and a display device of Example 7 were manufactured by the same method as that in Example 1C except that the ¼ wavelength plate in the DLC vertical alignment which was used in Example 1C was replaced by a ¼ wavelength plate of a rod-like liquid crystal (in RLC horizontal alignment).

### Example 8

In Example 1C, an optical sheet member of Example 8 and a display device of Example 8 were manufactured by the same method as that in Example 1C except that a birefringence change in an inclination azimuth was reduced and color unevenness in an oblique azimuth was reduced by using a λ/4 plate which was manufactured by laminating a RLC vertical +C plate on the rod-like liquid crystal (in RLC horizontal alignment) of Example 7 instead of the ¼ wavelength plate in the DLC vertical alignment which was used in Example 1C.

### Example 9

In Example 8, an optical sheet member of Example 9 and a display device of Example 9 were manufactured by the same method as that in Example 8 except that a λ/4 plate which was manufactured by increasing the film thickness of the RLC vertical +C plate in the manufacturing of the λ/4 plate in Example 8 was used instead of the λ/4 plate used in Example 8, and the color unevenness in the oblique azimuth was reduced by further reducing the birefringence change in the inclination azimuth.

### Example 10

An optical sheet member of Example 10 and a display device of Example 10 were manufactured by the same method as that in Example 1B except that a monoaxially stretched COP retardation film was used in a ¼ wavelength plate and the polarizing plate prepared in Manufacturing Example 3 was used.

### Example 11

An of optical sheet member of Example 11 and a display device of Example 11 were manufactured by the same method as that in Example 1B except that a monoaxially stretched COP retardation film was used in a ¼ wavelength plate instead of RLC of Example 7 and the polarizing plate prepared in Manufacturing Example 3 was used.

### Example 12

An optical sheet member of Example 12 and a display device of Example 12 were manufactured by the same method as that in Example 11 except that the monoaxially stretched COP retardation film of Example 11 was replaced by a ¼ wavelength plate which was stretched at oblique 45 degrees and the protective film of the polarizing plate prepared in Manufacturing Example 3 functioned as the COP.

### Example 13

An optical sheet member of Example 13 and a display device of Example 13 were manufactured by the same method as that in Example 12 except that an optical sheet member was formed by forming a ¼ wavelength plate which was prepared by increasing the film thickness of the RLC vertical +C plate of Example 12, and by laminating a reflection polarizer having a half band width of 150 nm, which was prepared by using a liquid crystal having Δn of 0.5, on the ¼ wavelength plate.

### Example 14

### Formation of Forward Dispersion λ/4 Plate

A λ/4 plate was prepared on a commercially available cellulose acylate-based film “TD60” (manufactured by Fujifilm Corporation) by using a discotic liquid crystal with reference to JP2012-108471A. In the obtained λ/4 plate, Re(450) was 140 nm, Re(550) was 128 nm, Re(630) was 123 nm, and the thickness of a liquid crystal layer was approximately 0.8 μm, and was approximately 60 μm including a support (TAC)

<Formation of Wavelength Selective Reflective Polarizer>

A first light reflection layer formed by immobilizing a right twist cholesteric liquid crystalline phase, a second light reflection layer formed by immobilizing a right twist cholesteric liquid crystalline phase, and a third light reflection layer formed by immobilizing a right twist cholesteric liquid crystalline phase were formed on the obtained forward dispersion λ/4 plate by coating by changing the added amount of the used chiral agent with reference to Fuji Film Research & Development No. 50 (2005) pp. 60-63 and by using a liquid crystal having Δn of 0.15.

The reflection center wavelength of the maximum reflectivity peak of the obtained first light reflection layer was 450 nm, the half band width was 40 nm, and the film thickness was 1.8 μm.

The reflection center wavelength of the maximum reflectivity peak of the obtained second light reflection layer was 530 nm, the half band width was 50 nm, and the film thickness was 2.0 μm.

The reflection center wavelength of the maximum reflectivity peak of the obtained third light reflection layer was 650 nm, the half band width was 60 nm, and the film thickness was 2.5 μm.

Furthermore, the average refractive index of the first light reflection layer, the second light reflection layer, and the third light reflection layer was 1.57.

In addition, the total thickness of a brightness enhancement film which was a laminated body of the wavelength selective reflective polarizer including the obtained forward dispersion λ/4 plate and the obtained first light reflection layer to the obtained third light reflection layer was approximately 7 μm.

In Manufacturing Example 1, a polarizing plate was prepared by the same method as that in Manufacturing Example 1 except that the wavelength selective reflective polarizer obtained as described above was used instead of one protective film of Manufacturing Example 1 described above, and the obtained polarizing plate was set to a BL side polarizing plate for a display device of Example 14.

In addition, it was found that it was preferable that at least one layer of the first light reflection layer to the third light reflection layer (the light reflection layer immobilizing the cholesteric liquid crystalline phase) was a light reflection layer formed by immobilizing a cholesteric liquid crystalline phase which was formed of a discotic liquid crystal, and the other light reflection layer was a light reflection layer formed by immobilizing a cholesteric liquid crystalline phase which was formed of a rod-like liquid crystal from the viewpoint of reducing the color unevenness in the oblique azimuth.

<Formation of Optical Conversion Sheet>

An optical conversion sheet (an inorganic fluorescent body (G,R)) in which a non-quantum dot inorganic fluorescent body which emitted fluorescent light of green light having a center wavelength of 515 nm and a half band width of 100 nm when blue light of a blue light emission diode using a green inorganic fluorescent body (lutetium aluminum oxide: cerium) manufactured by U-VIX Corporation was incident thereon, and a non-quantum dot inorganic fluorescent body which emitted fluorescent light of red light having a center wavelength of 650 nm and a half band width of 100 nm using a red inorganic fluorescent body (calcium sulfide: europium) were dispersed was formed as an optical conversion sheet with reference to JP2008-41706A.

<Manufacturing of Liquid Crystal Display Device>

A commercially available liquid crystal display device (manufactured by Panasonic Corporation, Product Name: TH-L42D2) was disassembled, the BL side polarizing plate for a display device of Example 14 was used as a backlight side polarizing plate without disposing a dielectric multi-layer film (Product Name: DBEF (Registered Trademark), manufactured by 3M Company), and a backlight unit was changed to an RGB narrowband backlight unit described below, and thus, a display device of Example 14 was manufactured.

The used RGB narrowband backlight unit includes a blue light emission diode (B-LED manufactured by NICHIA CORPORATION, a main wavelength of 465 nm and a half band width of 20 nm) as a light source. In addition, the optical conversion sheet (the inorganic fluorescent body (G,R)) described above in which inorganic fluorescent body is dispersed is disposed in the front portion of the light source. A laminated body of the obtained optical conversion sheet, the obtained wavelength selective reflective polarizer, the obtained λ/4 plate, and the obtained polarizing plate was set to an optical sheet member of Example 14.

### Example 15

An optical sheet member of Example 15 and a display device of Example 15 were prepared by the same configuration as that in Example 14 except that a light reflection layer formed by immobilizing a reverse twist cholesteric (left twist cholesteric) liquid crystalline phase was further laminated on the wavelength selective reflective polarizer (the first light reflection layer, the second light reflection layer, and the third light reflection layer which were formed by immobilizing the right twist cholesteric liquid crystalline phase) which was used in the optical sheet member of Example 14 by changing the type of chiral agent to a left twist chiral agent with the same liquid crystal as that of the first light reflection layer such that a reflectivity peak having reflectivity of greater than or equal to 60% was obtained in a band of 560 nm to 610 nm.

### Example 16

An optical sheet member of Example 16 and a display device of Example 16 were prepared by the same configuration as that in Example 14 except that a light reflection layer formed by immobilizing a reverse twist cholesteric (left twist cholesteric) liquid crystalline phase was further laminated on the wavelength selective reflective polarizer (the first light reflection layer, the second light reflection layer, and the third light reflection layer which were formed by immobilizing the right twist cholesteric liquid crystalline phase) which was used in the optical sheet member of Example 14 by changing the type of chiral agent to a left twist chiral agent with the same liquid crystal as that of the first light reflection layer such that a reflectivity peak having reflectivity of greater than or equal to 60% was obtained in a band of 470 nm to 510 nm and 560 nm to 610 nm.

### Example 17

An optical sheet member of Example 17 and a display device of Example 17 were prepared by the same configuration as that in Example 14 except that a light reflection layer formed by immobilizing a reverse twist cholesteric (left twist cholesteric) liquid crystalline phase was further laminated on the wavelength selective reflective polarizer (the first light reflection layer, the second light reflection layer, and the third light reflection layer which were formed by immobilizing the right twist cholesteric liquid crystalline phase) which was used in the optical sheet member of Example 14 by changing the type of chiral agent to a left twist chiral agent with the same liquid crystal as that of the first light reflection layer such that a reflectivity peak having reflectivity of greater than or equal to 60% was obtained in a band of 470 nm to 510 nm, 560 nm to 610 nm, and 660 nm to 780 nm.

### Example 18

A liquid crystal display device of Example 18 were prepared by the same configuration as that in Example 16 except that a wavelength selective reflective polarizer in which a light absorption member (an absorption layer) mixed with an absorptive compound having a light absorbance peak in a band of 660 nm to 780 nm was formed was used in addition to the wavelength selective reflective polarizer (a laminated body in which the first light reflection layer, the second light reflection layer, and the third light reflection layer were formed by immobilizing the right twist cholesteric liquid crystalline phase, and two light reflection layers formed by immobilizing the reverse twist cholesteric (left twist cholesteric) liquid crystalline phase were laminated) which was used in the optical sheet member of Example 16.

Phthalocyanine A shown in Table 1 of [0018] of JP2013-182028A was used as an absorptive compound which was used in the light absorption member (the absorption layer). 5 parts by mass of the phthalocyanine A was added to 100 parts by mass of a monomer which was a hard coat material (DPHA), propylene glycol monomethyl ether acetate was used as a solvent, and a film was formed on the wavelength selective reflective polarizer used in the optical sheet member of Example 16 by a spin coating method, was dried and solidified, and thus, the light absorption member (the absorption layer) was formed.

In the obtained light absorption member, the light absorbance peak was 680 nm, and the absorption range having light absorbance of greater than or equal to 1 was 660 nm to 700 nm.

### Example 19

In Example 15, an optical member sheet of Example 19 and a display device of Example 19 were prepared by the same configuration as that in Example 15 except that the optical conversion sheet was changed to a quantum dot material (G,R) which emitted fluorescent light of green light having a center wavelength of 530 nm and a half band width of 38 nm and red light having a center wavelength of 632 nm and a half band width of 32 nm when blue light of a blue light emission diode was incident from the inorganic fluorescent body (G,R) used in Example 15.

### Example 20

In Example 16, an optical member sheet of Example 20 and a display device of Example 20 were prepared by the same configuration as that in Example 16 except that the optical conversion sheet was changed to the same quantum dot material (G,R) as that in Example 19.

### Example 21

In Example 17, an optical member sheet of Example 21 and a display device of Example 21 were prepared by the same configuration as that in Example 17 except that the optical conversion sheet was changed to the same quantum dot material (G,R) as that in Example 19.

### Example 22

In Example 18, an optical member sheet of Example 22 and a display device of Example 22 were prepared by the same configuration as that in Example 18 except that the optical conversion sheet was changed to the same quantum dot material (G,R) as that in Example 19.

### Example 23

In Example 20, an optical member sheet of Example 23 and a display device of Example 23 were prepared by the same configuration as that in Example 20 except that the optical conversion sheet used in the optical sheet member of Example 20 became a quantum rod material (G,R) dispersion stretched CA described below, and the cholesteric layer of the wavelength selective reflective polarizer was changed to a wavelength selective reflective polarizer in which a light reflection layer formed by immobilizing a reverse twist cholesteric (left twist cholesteric) liquid crystalline phase was further laminated on the wavelength selective reflective polarizer of the liquid crystal display device of Example 6B (the light reflection layer formed by immobilizing the right twist cholesteric liquid crystalline phase) such that a reflectivity peak having reflectivity of greater than or equal to 60% was obtained in a band of 470 nm to 510 nm and 560 nm to 610 nm, and included a λ/4 plate on both surfaces thereof.

<Optical Conversion Sheet; Quantum Rod Material (G,R) Dispersion Stretched CA>

At the time of manufacturing a cellulose acylate film disclosed in Example 1 of JP2011-121327A, 0.1 mass % of a quantum rod material which emitted fluorescent light of green light having a center wavelength of 530 nm and a half band width of 40 nm and red light having a center wavelength of 640 nm and a half band width of 40 nm when blue light of a blue light emission diode was incident thereon was dispersed with respect to cellulose acylate, and thus, a quantum rod material dispersion stretched cellulose acylate film (in the following table, described as quantum rod material (G,R) dispersion stretched CA) was prepared. In the quantum rod material dispersion stretched cellulose acylate film, the degree of polarization of fluorescent light which was emitted from the quantum rod material dispersion stretched cellulose acylate film when light having a degree of polarization of 99.9% was incident on the quantum rod material dispersion stretched cellulose acylate film was 80%. In addition, it is confirmed that the degree of polarization of the fluorescent light emitted from the quantum rod material dispersion stretched cellulose acylate film is improved according to a stretching ratio UP.

### Example 24

An optical sheet member of Example 24 and a display device of Example 24 were manufactured by changing the wavelength selective reflective polarizer (the cholesteric layer including the λ/4 plates on both surfaces thereof) used in the optical sheet member of Example 23 to a dielectric multi-layer film (manufactured by 3M Company, Registered Trade Name: DBEF), and by changing the configuration to the following configuration.

<Optical Conversion Sheet; Quantum Rod>

With reference to U.S. Pat. No. 7,303,628B, Research Papers (Peng, X. G.; Manna, L.; Yang, W. D.; Wickham, j.; Scher, E.; Kadavanich, A.; Alivisatos, A. P. Nature 2000, 404, 59-61), and Research Papers (Manna, L.; Scher, E. C.; Alivisatos, A. P. j. Am. Chem. Soc. 2000, 122, 12700-12706), a quantum rod 1 which emitted fluorescent light of green light having a center wavelength of 540 nm and a half band width of 40 nm when blue light of a blue light emission diode was incident thereon, and a quantum rod 2 which emitted fluorescent light of red light having a center wavelength of 645 nm and a half band width of 30 nm were formed. The quantum rods 1 and 2 were in the shape of a rectangular parallelepiped, and the average length of the major axis of the quantum rod was 30 nm. Furthermore, the average length of the major axis of the quantum rod was observed by a transmission type electron microscope.

Next, a quantum rod dispersion PVA sheet in which a quantum rod was dispersed was prepared by the following method.

A sheet of isophthalic acid copolymerized polyethylene terephthalate (hereinafter, referred to as “amorphous PET”) in which 6 mol % of a isophthalic acid was copolymerized was prepared as a substrate. The glass transition temperature of the amorphous PET is 75° C. A laminated body formed of the amorphous PET substrate and a quantum rod alignment layer was prepared as follows. Here, the quantum rod alignment layer includes the quantum rods 1 and 2 which was prepared by using polyvinyl alcohol (hereinafter, referred to as “PVA”) as a matrix. In addition, the glass transition temperature of PVA is 80° C.

A PVA powder having degree of polymerization of greater than or equal to 1000, a degree of saponification of greater than or equal to 99%, and a concentration of 4% to 5%, and the quantum rods 1 and 2 prepared as described above each having a concentration of 1% were dissolved in water, and thus, a quantum rod-containing PVA aqueous solution was prepared. In addition, the amorphous PET substrate having a thickness of 200 μm was prepared. Next, the quantum rod-containing PVA aqueous solution was applied onto the amorphous PET substrate having a thickness of 200 μm and was dried at a temperature of 50° C. to 60° C., and thus, a quantum rod-containing PVA layer having a thickness of 25 μm was formed on the amorphous PET substrate. A laminated body of the amorphous PET and the quantum rod-containing PVA will be referred to as a quantum rod dispersion PVA sheet.

In the prepared quantum rod dispersion PVA sheet, the degree of polarization of fluorescent light which was emitted from the quantum rod dispersion PVA sheet when light having a degree of polarization of 99.9% was incident thereon was 80%.

In Example 23, the display device of Example 24 was manufactured by the same method as that in Example 23 except that the quantum rod dispersion PVA sheet formed as described above (in the following table, described as quantum rod material (G,R) dispersion stretched PVA) was used instead of the quantum rod material dispersion stretched cellulose acylate film. An optical sheet member of Example 24 was manufactured by the same configuration as that in Example 23 and by using the quantum rod dispersion PVA sheet.

A liquid crystal display device including commercially available quantum dot type backlight (manufactured by Sony Corporation, Product Name: KDL-46W900A) was used, the optical sheet member of Example 24 was used as a backlight side polarizing plate, the TV described above was disassembled, a (glass containment bar type) quantum dot was taken out and was changed to a B narrowband (450 nm) backlight unit, and thus, the display device of Example 24 was manufactured.

### Example 25

A dielectric multi-layer film 1 prepared by the following method was bonded to the polarizing plate manufactured in Manufacturing Example 1 by using the same adhesive agent as that in Example 1, and thus, an optical sheet member of Example 25 was manufactured.

An RGB narrowband dielectric multi-layer film 1 was manufactured such that the total thickness of the brightness enhancement film was changed as shown in Table 4 described below, the reflection center wavelength of the maximum reflectivity peak in a wavelength range corresponding to blue light was 460 nm, and the half band width was 30 nm, with reference to IDW/AD '12, pp. 985 to 988 (2012). In the manufacturing of the liquid crystal display device of Example 1, a liquid crystal display device of Example 25 was manufactured by the same method as that in Example 1 except that the optical sheet member of Example 25 was used instead of the optical sheet member of Example 1.

[Evaluation]

The optical sheet member and the liquid crystal display device of each of the examples and the comparative Examples were evaluated on the basis of the following criteria. Furthermore, the examples were subjected to comparative evaluation on the basis of Comparative Example 1.

(1) Front Brightness

Front brightness of the liquid crystal display device was measured by a method disclosed in [0180] of JP2009-93166A. The results were collectively evaluated on the basis of the following criteria.

5: More excellent than the front brightness of the liquid crystal display device of Comparative Example 1 by greater than or equal to 30%.

4: More excellent than the front brightness of the liquid crystal display device of Comparative Example 1 by greater than or equal to 20% and less than 30%.

3: More excellent than the front brightness of the liquid crystal display device of Comparative Example 1 by greater than or equal to 10% and less than 20%.

2: 10% less than the front brightness of the liquid crystal display device of Comparative Example 1.

1: Less than or equal to the front brightness of the liquid crystal display device of Comparative Example 1.

(2) Color Reproduction Range

A color reproduction range of the liquid crystal display device was measured by a method disclosed in [0066] of JP2012-3073A. The results were collectively evaluation by the following criteria.

5: More excellent than the NTSC ratio of the liquid crystal display device of Comparative Example 1 by greater than or equal to 25%.

4: More excellent than the NTSC ratio of the liquid crystal display device of Comparative Example 1 by greater than or equal to 20% and less than 25%.

3: More excellent than the NTSC ratio of the liquid crystal display device of Comparative Example 1 by greater than or equal to 10% and less than 20%.

2: Less than or equal to the NTSC ratio of the liquid crystal display device of Comparative Example 1.

(3) Color Unevenness in Oblique Azimuth

An oblique change in the shade Δu′v′ of the liquid crystal display device was evaluated by the following method. A shade color difference Δu′v′ obtained by a difference between the values of shade coordinates u′ and v′ in a front surface (a polar angle of 0 degrees) and a direction at a polar angle of 60 degrees was measured in a direction of an azimuth angle of 0 degrees to 360 degrees, and the average value thereof was set to an evaluation index of the oblique change in the shade Δu′v′. The shade coordinates u′v′ were measured by using a measurement machine (EZ-Contrast 160D, manufactured by ELDIM Corporation). The results were collectively evaluated on the basis of the following criteria.

4: More excellent than the color unevenness in the oblique azimuth of the liquid crystal display device of Comparative Example 1 by greater than or equal to 10%.

3: More excellent than the color unevenness in the oblique azimuth of the liquid crystal display device of Comparative Example 1 by less than 10%.

2: Less than or equal to the color unevenness in the oblique azimuth of the liquid crystal display device of Comparative Example 1

TABLE 2

| | | | Comparative | Comparative | | | | |
|---|---|---|---|---|---|---|---|---|
| | | | Example 1 | Example 2 | Example 1A | Example 1B | Example 1C | Example 1 |
| Optical | BL Side | Polarizing Plate | TAC | TAC | TAC | TAC | TAC | TAC |
| Sheet | Polarizing Plate | Protective Film | | | | | | |
| Member | λ/4 Plate | Re and Rth of | None | None | None | DLC | DLC | DLC |
| | (Including Base | λ/4 Plate | | | | Vertical | Vertical | Vertical |
| | Film or Polarizing | | | | | Re = 125 | Re = 128 | Re = 125 |
| | Plate Protective | | | | | nm | nm | nm |
| | Film) | | | | | Rth = −62.5 | Rth = −62.5 | Rth = −62.5 |
| | | | | | | nm | nm | nm |
| | Wavelength | Type of Reflection | None | Cholesteric | Cholesteric | Cholesteric | Cholesteric | Cholesteric |
| | Selective | Polarizer | | Layer of Three | Layer | Layer | Layer of Three | Layer of Three |
| | Reflective | | | RGB Layers | (Δn of 0.4) | (Δn of 0.16) | RGB Layers | RGB Layers |
| | Polarizer | | | (Δn of 0.16) | | | (Δn of 0.16) | (Δn of 0.16) |
| | | Reflection Center | None | 450 nm, | 500 nm, | 450 nm, | 450 nm, | 450 nm, |
| | | Wavelength and | | 50 nm | 140 nm | 50 nm | 50 nm | 50 nm |
| | | Half Band Width | | 550 nm, | | | 530 nm, | 550 nm, |
| | | | | 55 nm | | | 55 nm | 55 nm |
| | | | | 650 nm, | | | 650 nm, | 630 nm, |
| | | | | 60 nm | | | 60 nm | 60 nm |
| | | Reflection Range | None | None | None | None | None | None |
| | | nm Having | | | | | | |
| | | Reflection Peak | | | | | | |
| | | of Greater than | | | | | | |
| | | or Equal to 60% | | | | | | |
| | Optical | Fluorescent | None | None | Quantum | Quantum | Quantum | Quantum |
| | Conversion Sheet | Material | | | Dot | Dot | Dot | Dot |
| | | | | | material | material | material | material |
| | | | | | (G, R) | (G, R) | (G, R) | (G, R) |
| | Light Absorption | Absorption | None | None | None | None | None | None |
| | Member | Range | | | | | | |
| Light | Backlight | Light Source | White LED | White LED | B-LED | B-LED | B-LED | B-LED |
| Source | | Light Source | Broad | Broad | 446 | 446 | 465 | 465 |
| | | Center | Light | Light | | | | |
| | | Wavelength | Source | Source | | | | |
| | | λb (nm) | | | | | | |

| | | | | | | | |
|---|---|---|---|---|---|---|---|
| Perfor- | Front Brightness | 1 | 1 | 2 | 2 | 3 | 3 |
| mance | Color Reproduction Range | 2 | 2 | 3 | 3 | 3 | 3 |
| | Color Unevenness In Oblique Azimuth | 2 | 2 | 2 | 3 | 3 | 4 |

| | | | Example 2 | Example 3 | Example 4 | Example 5 |
|---|---|---|---|---|---|---|
| Optical | BL Side | Polarizing Plate | TAC | Acryl | TAC | TAC |
| Sheet | Polarizing Plate | Protective Film | | | | |
| Member | λ/4 Plate | Re and Rth of | DLC | DLC | DLC | DLC |
| | (Including Base | λ/4 Plate | Vertical | Vertical | Vertical | Vertical + TAC |
| | Film or Polarizing | | Re = 128 | Re = 127 | Re = 124 | Re = 126 |
| | Plate Protective | | nm | nm | nm | nm |
| | Film) | | Rth = −64 | Rth = −63.5 | Rth = −62 | Rth = −2 |
| | | | nm | nm | nm | nm |
| | Wavelength | Type of Reflection | Cholesteric | Cholesteric | Cholesteric | Cholesteric |
| | Selective | Polarizer | Layer | Layer | Layer | Layer |
| | Reflective | | (Δn of 0.06) | (Δn of 0.2) | (Δn of 0.5) | (Δn of 0.5) |
| | Polarizer | | | | | |
| | | Reflection Center | 465 nm, | 465 nm, | 520 nm, | 520 nm, |
| | | Wavelength and | 15 nm | 60 nm | 150 nm | 150 nm |
| | | Half Band Width | | | | |
| | | Reflection Range | None | None | None | None |
| | | nm Having | | | | |
| | | Reflection Peak | | | | |
| | | of Greater than | | | | |
| | | or Equal to 60% | | | | |
| | Optical | Fluorescent | Quantum | Quantum | Quantum | Quantum |
| | Conversion Sheet | Material | Dot | Dot | Dot | Dot |
| | | | material | material | material | material |
| | | | (G, R) | (G, R) | (G, R) | (G, R) |
| | Light Absorption | Absorption | None | None | None | None |
| | Member | Range | | | | |
| Light | Backlight | Light Source | B-LED | B-LED | B-LED | B-LED |
| Source | | Light Source | 465 | 446 | 446 | 465 |
| | | Center | | | | |
| | | Wavelength | | | | |
| | | λb (nm) | | | | |

| | | | | | |
|---|---|---|---|---|---|
| Perfor- | Front Brightness | 2 | 3 | 4 | 4 |
| mance | Color Reproduction Range | 3 | 3 | 3 | 3 |
| | Color Unevenness In Oblique Azimuth | 3 | 4 | 4 | 3 |

TABLE 3

| | | | Example 6 | Example 6B | Example 7 | Example 8 | Example 9 |
|---|---|---|---|---|---|---|---|
| Optical | BL Side | Polarizing Plate | TAC | TAC | TAC | TAC | TAC |
| Sheet | Polarizing Plate | Protective Film | | | | | |
| Member | λ/4 Plate | Re and Rth of | DLC | DLC | RLC | RLC | RLC |
| | (Including Base | λ/4 Plate | Vertical | Vertical | Horizontal | Horizontal + C | Horizontal + C |
| | Film or Polarizing | | Re = 124 | Re = 124 | Re = 125 | Re = 127 | Re = 125 |
| | Plate Protective | | nm | nm | nm | nm | nm |
| | Film) | | Rth = −62 | Rth = −62 | Rth = 62.5 | Rth = 1 | Rth = −60 |
| | | | nm | nm | nm | nm | nm |
| | Wavelength | Type of Reflection | Cholesteric | Cholesteric | Cholesteric | Cholesteric | Cholesteric |
| | Selective | Polarizer | Layer (PG + | Layer (PG + | Layer of Three | Layer of Three | Layer of Three |
| | Reflective | | Δn of 0.2) | Δn of 0.2) | RGB Layers | RGB Layers | RGB Layers |
| | Polarizer | | | | (Δn of 0.16) | (Δn of 0.16) | (Δn of 0.16) |
| | | Reflection Center | 500 nm, | 620 nm, | 450 nm, | 450 nm, | 450 nm, |
| | | Wavelength and | 200 nm | 400 nm | 50 nm | 50 nm | 50 nm |
| | | Half Band Width | | | 530 nm, | 530 nm, | 530 nm, |
| | | | | | 55 nm | 55 nm | 55 nm |
| | | | | | 650 nm, | 650 nm, | 650 nm, |
| | | | | | 60 nm | 60 nm | 60 nm |
| | | Reflection Range | None | None | None | None | None |
| | | nm Having | | | | | |
| | | Reflection Peak | | | | | |
| | | of Greater than | | | | | |
| | | or Equal to 60% | | | | | |
| | Optical | Fluorescent | Quantum | Quantum | Quantum | Quantum | Quantum |
| | Conversion Sheet | Material | Dot | Dot | Dot | Dot | Dot |
| | | | material | material | material | material | material |
| | | | (G, R) | (G, R) | (G, R) | (G, R) | (G, R) |
| | Light Absorption | Absorption | None | None | None | None | None |
| | Member | Range | | | | | |
| Light | Backlight | Light Source | B-LED | B-LED | B-LED | B-LED | B-LED |
| Source | | Light Source | 465 | 465 | 465 | 465 | 465 |
| | | Center | | | | | |
| | | Wavelength | | | | | |
| | | λb (nm) | | | | | |

| | | | | | | |
|---|---|---|---|---|---|---|
| Perfor- | Front Brightness | 4 | 4 | 3 | 3 | 3 |
| mance | Color Reproduction Range | 3 | 3 | 3 | 3 | 3 |
| | Color Unevenness In Oblique Azimuth | 3 | 3 | 2 | 3 | 4 |

| | | | Example 10 | Example 11 | Example 12 | Example 13 |
|---|---|---|---|---|---|---|
| Optical | BL Side | Polarizing Plate | COP | COP | COP | COP |
| Sheet | Polarizing Plate | Protective Film | | | | |
| Member | λ/4 Plate | Re and Rth of | COP | COP | COP 45 | COP 45 |
| | (Including Base | λ/4 Plate | Monoaxial | Monoaxial + C | Degrees + C | Degrees + C |
| | Film or Polarizing | | Re = 140 | (RLC Vertical) | (RLC Vertical) | (RLC Vertical) |
| | Plate Protective | | nm | Re = 140 | Re = 140 | Re = 140 |
| | Film) | | Rth = 70 | nm | nm | nm |
| | | | nm | Rth = 0 | Rth = 0 | Rth = −60 |
| | | | | nm | nm | nm |
| | Wavelength | Type of Reflection | Cholesteric | Cholesteric | Cholesteric | Cholesteric |
| | Selective | Polarizer | Layer | Layer | Layer | Layer |
| | Reflective | | (Δn of 0.16) | (Δn of 0.16) | (Δn of 0.16) | (Δn of 0.5) |
| | Polarizer | | | | | |
| | | Reflection Center | 450 nm, | 450 nm, | 450 nm, | 520 nm, |
| | | Wavelength and | 50 nm | 50 nm | 50 nm | 150 nm |
| | | Half Band Width | (0.16) | (0.16) | (0.16) | (0.5) |
| | | Reflection Range | None | None | None | None |
| | | nm Having | | | | |
| | | Reflection Peak | | | | |
| | | of Greater than | | | | |
| | | or Equal to 60% | | | | |
| | Optical | Fluorescent | Quantum | Quantum | Quantum | Quantum |
| | Conversion Sheet | Material | Dot | Dot | Dot | Dot |
| | | | material | material | material | material |
| | | | (G, R) | (G, R) | (G, R) | (G, R) |
| | Light Absorption | Absorption | None | None | None | None |
| | Member | Range | | | | |
| Light | Backlight | Light Source | B-LED | B-LED | B-LED | B-LED |
| Source | | Light Source | 465 | 465 | 465 | 465 |
| | | Center | | | | |
| | | Wavelength | | | | |
| | | λb (nm) | | | | |

| | | | | | |
|---|---|---|---|---|---|
| Perfor- | Front Brightness | 2 | 2 | 2 | 4 |
| mance | Color Reproduction Range | 3 | 3 | 3 | 4 |
| | Color Unevenness In Oblique Azimuth | 2 | 3 | 3 | 3 |

TABLE 4

| | | | Example 14 | Example 15 | Example 16 | Example 17 | Example 18 |
|---|---|---|---|---|---|---|---|
| Optical | BL Side | Polarizing Plate | TAC | TAC | TAC | TAC | TAC |
| Sheet | Polarizing Plate | Protective Film | | | | | |
| Member | λ/4 Plate | Re and Rth of | DLC | DLC | DLC | DLC | DLC |
| | (Including Base | λ/4 Plate | Vertical | Vertical | Vertical | Vertical | Vertical |
| | or Polarizing | | Re = 128 | Re = 128 | Re = 128 | Re = 128 | Re = 128 |
| | Plate Protective | | nm | nm | nm | nm | nm |
| | Film) | | Rth = −62.5 | Rth = −62.5 | Rth = −62.5 | Rth = −62.5 | Rth = −62.5 |
| | | | nm | nm | nm | nm | nm |
| | Wavelength | Type of Reflection | Cholesteric | Cholesteric | Cholesteric | Cholesteric | Cholesteric |
| | Selective | Polarizer | Layer of | Layer of | Layer of | Layer of | Layer of |
| | Reflective | | Three RGB | Three RGB | Three RGB | Three RGB | Three RGB |
| | Polarizer | | Layers | Layers + | Layers + | Layers + | Layers + |
| | | | (Δn of 0.16) | One Reverse | Two Reverse | Three Reverse | Two Reverse |
| | | | | Twist Layer | Twist Layers | Twist Layers | Twist Layers |
| | | | | (Δn of 0.1 6) | (Δn of 0.16) | (Δn of 0.1 6) | (Δn of 0.16) |
| | | Reflection Center | 450 nm, | 450 nm, | 450 nm, | 450 nm, | 450 nm, |
| | | Wavelength and | 50 nm | 50 nm | 50 nm | 50 nm | 50 nm |
| | | Half Band Width | 530 nm, | 530 nm, | 530 nm, | 530 nm, | 530 nm, |
| | | | 55 nm | 55 nm | 55 nm | 55 nm | 55 nm |
| | | | 650 nm, | 650 nm, | 650 nm, | 650 nm, | 650 nm, |
| | | | 60 nm | 60 nm | 60 nm | 60 nm | 60 nm |
| | | Reflection Range | None | 560 nm to | 470 nm to | 470 nm to | 470 nm to |
| | | nm Having | | 610 nm | 510 nm | 510 nm | 510 nm |
| | | Reflection Peak | | | 560 nm to | 560 nm to | 560 nm to |
| | | of Greater than | | | 610 nm | 610 nm | 610 nm |
| | | or Equal to 60% | | | | 660 nm to | |
| | | | | | | 780 nm | |
| | Optical | Fluorescent | Inorganic | Inorganic | Inorganic | Inorganic | Inorganic |
| | Conversion Sheet | Material | Fluorescent | Fluorescent | Fluorescent | Ruorescent | Fluorescent |
| | | | Body (G, R) | Body (G, R) | Body (G, R) | Body (G, R) | Body (G, R) |
| | Light Absorption | Absorption | None | None | None | None | 660 nm to |
| | Member | Range | | | | | 780 nm |
| Light | Backlight | Light Source | B-LED | B-LED | B-LED | B-LED | B-LED |
| Source | | Light Source | 465 | 465 | 465 | 465 | 465 |
| | | Center | | | | | |
| | | Wavelength | | | | | |
| | | λb (nm) | | | | | |

| | | | | | | |
|---|---|---|---|---|---|---|
| Perfor- | Front Brightness | 3 | 3 | 4 | 4 | 3 |
| mance | Color Reproduction Range | 2 | 3 | 3 | 4 | 4 |
| | Color Unevenness In Oblique Azimuth | 3 | 3 | 3 | 3 | 3 |

| | | | Example 19 | Example 20 | Example 21 | Example 22 |
|---|---|---|---|---|---|---|
| Optical | BL Side | Polarizing Plate | TAC | TAC | TAC | TAC |
| Sheet | Polarizing Plate | Protective Film | | | | |
| Member | λ/4 Plate | Re and Rth of | DLC | DLC | DLC | DLC |
| | (Including Base | λ/4 Plate | Vertical | Vertical | Vertical | Vertical |
| | or Polarizing | | Re = 128 | Re = 128 | Re = 128 | Re = 128 |
| | Plate Protective | | nm | nm | nm | nm |
| | Film) | | Rth = −62.5 | Rth = −62.5 | Rth = −62.5 | Rth = −62.5 |
| | | | nm | nm | nm | nm |
| | Wavelength | Type of Reflection | Cholesteric | Cholesteric | Cholesteric | Cholesteric |
| | Selective | Polarizer | Layer of | Layer of | Layer of | Layer of |
| | Reflective | | Three RGB | Three RGB | Three RGB | Three RGB |
| | Polarizer | | Layers + | Layers + | Layers + | Layers + |
| | | | One Reverse | Two Reverse | Three Reverse | Two Reverse |
| | | | Twist Layer | Twist Layers | Twist Layers | Twist Layers |
| | | | (Δn of 0.16) | (Δn of 0.16) | (Δn of 0.16) | (Δn of 0.16) |
| | | Reflection Center | 450 nm, | 450 nm, | 450 nm, | 450 nm, |
| | | Wavelength and | 50 nm | 50 nm | 50 nm | 50 nm |
| | | Half Band Width | 530 nm, | 530 nm, | 530 nm, | 530 nm, |
| | | | 55 nm | 55 nm | 55 nm | 55 nm |
| | | | 650 nm, | 650 nm, | 650 nm, | 650 nm, |
| | | | 60 nm | 60 nm | 60 nm | 60 nm |
| | | Reflection Range | 560 nm to | 470 nm to | 470 nm to | 470 nm to |
| | | nm Having | 610 nm | 510 nm | 510 nm | 510 nm |
| | | Reflection Peak | | 560 nm to | 560 nm to | 560 nm to |
| | | of Greater than | | 610 nm | 610 nm | 610 nm |
| | | or Equal to 60% | | | 660 nm to | |
| | | | | | 780 nm | |
| | Optical | Fluorescent | Quantum | Quantum | Quantum | Quantum |
| | Conversion Sheet | Material | Dot | Dot | Dot | Dot |
| | | | material | material | material | material |
| | | | (G, R) | (G, R) | (G, R) | (G, R) |
| | Light Absorption | Absorption | None | None | None | 660 nm to |
| | Member | Range | | | | 780 nm |
| Light | Backlight | Light Source | B-LED | B-LED | B-LED | B-LED |
| Source | | Light Source | 465 | 465 | 465 | 465 |
| | | Center | | | | |
| | | Wavelength | | | | |
| | | λb (nm) | | | | |

| | | | | | |
|---|---|---|---|---|---|
| Perfor- | Front Brightness | 3 | 4 | 4 | 3 |
| mance | Color Reproduction Range | 3 | 3 | 4 | 5 |
| | Color Unevenness In Oblique Azimuth | 3 | 3 | 3 | 3 |

| | | | Example 23 | Example 24 | Example 25 |
|---|---|---|---|---|---|
| Optical | BL Side | Polarizing Plate | TAC | TAC | TAC |
| Sheet | Polarizing Plate | Protective Film | | | |
| Member | λ/4 Plate | Re and Rth of | DLC | DLC | None |
| | (Including Base | λ/4 Plate | Vertical | Vertical | |
| | or Polarizing | | Re = 128 | Re = 128 | |
| | Plate Protective | | nm | nm | |
| | Film) | | Rth = −62.5 | Rth = −62.5 | |
| | | | nm | nm | |
| | Wavelength | Type of Reflection | Cholesteric | Dielectric | Dielectric |
| | Selective | Polarizer | Layer (PG + | Multi-Layer | Multi-Layer |
| | Reflective | | Δn of 0.2) + | Film (DBEF) + | Film (DBEF) |
| | Polarizer | | Two Reverse | Two Reverse | |
| | | | Twist Layers | Twist Layers | |
| | | Reflection Center | 620 nm, | 400 nm to | 460 nm, |
| | | Wavelength and | 400 nm | 780 nm, | 30 nm |
| | | Half Band Width | | Half Band | |
| | | | | Width is | |
| | | | | Omitted | |
| | | Reflection Range | 470 nm to | 470-510 nm | None |
| | | nm Having | 510 nm | 560-610 nm | |
| | | Reflection Peak | 560 nm to | | |
| | | of Greater than | 610 nm | | |
| | | or Equal to 60% | | | |
| | Optical | Fluorescent | Quantum | Quantum | Quantum |
| | Conversion Sheet | Material | Rod | Rod | Dot |
| | | | material | material | material |
| | | | (G, R) | (G, R) | (G, R) |
| | | | Dispersion | Dispersion | |
| | | | Stretched CA | PVA | |
| | Light Absorption | Absorption | None | None | None |
| | Member | Range | | | |
| Light | Backlight | Light Source | B-LED | B-LED | B-LED |
| Source | | Light Source | 465 | 465 | 465 |
| | | Center | | | |
| | | Wavelength | | | |
| | | λb (nm) | | | |

| | | | | |
|---|---|---|---|---|
| Perfor- | Front Brightness | 5 | 5 | 3 |
| mance | Color Reproduction Range | 4 | 4 | 3 |
| | Color Unevenness In Oblique Azimuth | 3 | 3 | 2 |

From Tables 2 to 4 described above, in a case where the optical sheet member of the present invention was incorporated in a display device using backlight emitting light including at least a blue wavelength range, it was found that both of the front brightness and the color reproduction range were improved.

In contrast, from the Comparative Example 1, in a display device using a white LED of the related art (a so-called quasi white LED obtained by covering a blue light source with a yellow fluorescent body) as backlight without including an optical conversion sheet and a wavelength selective reflective polarizer, it was found that both of the front brightness and the color reproduction range were required to be improved.

From Comparative Example 2, in a display device using a white LED of the related art (a so-called quasi white LED obtained by covering a blue light source with a yellow fluorescent body) without including an optical conversion sheet, it was found that both of the front brightness and the color reproduction range were required to be improved even in a case where a wavelength selective reflective polarizer was included.

From Tables 2 to 4 described above, in a preferred embodiment of the optical sheet member of the present invention and a preferred embodiment of the display device of the present invention, it was found that the color unevenness in the oblique azimuth was also reduced.

Furthermore, a wavelength selective filter for a blue color selectively transmitting light having a wavelength shorter than 460 nm was disposed in the backlight unit of the liquid crystal display device of Example 1, and thus, the same excellent evaluation result was obtained. In addition, a wavelength selective filter for a red color selectively transmitting light having a wavelength longer than 630 nm was disposed in the backlight unit of the liquid crystal display device of Example 1, and thus, the same excellent evaluation result was obtained.

### Example 26

A film was prepared by the same method as that at the time of forming the first light reflection layer of Example 14 in which an alignment layer was disposed on a support and was subjected to a rubbing treatment, and then, a λ/4 plate was directly laminated on the alignment layer, and the first light reflection layer used in Example 14 was directly laminated on the λ/4 plate. Next, a film was prepared in which a PET support was subjected to a rubbing treatment, and then, the third light reflection layer of Example 14 was directly laminated on the PET support, and the second light reflection layer of Example 14 was directly laminated on the third light reflection layer. Finally, the first light reflection layer of the former film adhered to the second light reflection layer of the latter film by disposing a commercially available acrylic adhesive agent (UV-3300, manufactured by TOAGOSEI CO., LTD.) using coating, by irradiating the adhesive agent with an ultraviolet ray having irradiation dose of 100 mJ/cm² using a metal halide lamp, and by curing the adhesive agent, and then, a brightness improvement film of Example 26 was obtained without peeling off the PET support (a refractive index of 1.63) described above. The absolute value of a difference between the refractive indices with respect to the third light reflection layer (the average refractive index of 1.56) was 0.07. (Furthermore, in a case where the PET support described above was peeled off, a difference between the refractive indices of an air layer and the third light reflection layer was 0.56.)

Next, as with Example 14, a commercially available liquid crystal display device (manufactured by Panasonic Corporation, Product Name: TH-L42D2) was disassembled, a plate in which the brightness enhancement film of Example 26 was bonded to the polarizing plate prepared in Manufacturing Example 1 described above by using an adhesive agent containing a polyvinyl alcohol-based resin having acetoacetyl group with high durability was used as a backlight side polarizing plate without disposing a dielectric multi-layer film (Product Name DBEF (Registered Trademark), manufactured by 3M Company), and thus, a liquid crystal display device of Example 26 was manufactured.

In addition, in the backlight light source of the liquid crystal display device, the backlight unit of Example 14 was modified, and the emission peak wavelength of blue light was 450 nm There was one light emission peak in a region of green to red, peak wavelength was 550 nm, and the half band width was 100 nm.

### Example 27

A film was prepared by the same method as that at the time of forming the first light reflection layer of Example 14 in which an alignment layer was disposed on a support and was subjected to a rubbing treatment, and then, a λ/4 plate was directly laminated on the alignment layer, and the first light reflection layer used in Example 14 was directly laminated on the λ/4 plate. Next, a film was prepared in which a TAC support was subjected to a rubbing treatment, and then, the third light reflection layer of Example 14 was directly laminated on the TAC support, and the second light reflection layer of Example 14 was directly laminated on the third light reflection layer. Finally, the first light reflection layer of the former film adhered to the second light reflection layer of the latter film by disposing a commercially available acrylic adhesive agent (UV-3300, manufactured by TOAGOSEI CO., LTD.) using coating, by irradiating the adhesive agent with an ultraviolet ray having irradiation dose of 100 mJ/cm² using a metal halide lamp, and by curing the adhesive agent, and then a brightness improvement film of Example 27 was obtained without peeling off the TAC support (a refractive index of 1.48) described above. The absolute value of a difference between the refractive indices with respect to the third light reflection layer (the average refractive index of 1.56) was 0.08.

Next, as with Example 14, a commercially available liquid crystal display device (manufactured by Panasonic Corporation, Product Name: TH-L42D2) was disassembled, a plate in which the brightness improvement film of Example 27 was bonded to the polarizing plate prepared in Manufacturing Example 1 described above by using an adhesive agent containing a polyvinyl alcohol-based resin having an acetoacetyl group with high durability was used as a backlight side polarizing plate without disposing a dielectric multi-layer film (Product Name DBEF (Registered Trademark), manufactured by 3M Company), and thus, a liquid crystal display device of Example 27 was manufactured.

### Example 28

A film was prepared by the same method as that at the time of forming the first light reflection layer of Example 14 in which an alignment layer was disposed on a support and was subjected to a rubbing treatment, and then, a λ/4 plate was directly laminated on the alignment layer, and the first light reflection layer used in Example 14 was directly laminated on the λ/4 plate. Next, a film was prepared in which a TAC surface of a surface scattering layer imparting TAC support was subjected to a rubbing treatment, and then, the third light reflection layer of Example 17 was directly laminated on the TAC support, and the second light reflection layer of Example 17 was directly laminated on the third light reflection layer. Finally, the first light reflection layer of the former film adhered to the second light reflection layer of the latter film by disposing a commercially available acrylic adhesive agent (UV-3300, manufactured by TOAGOSEI CO., LTD.) using coating, by irradiating the adhesive agent with an ultraviolet ray having irradiation dose of 100 mJ/cm² using a metal halide lamp, and by curing the adhesive agent, and then, the surface scattering layer imparting TAC support described above (a refractive index of 1.48) remained, and thus, a brightness improvement film of Example 28 was obtained. The absolute value of a difference between the refractive indices with respect to the third light reflection layer (the average refractive index of 1.56) was 0.08.

Next, as with Example 14, a commercially available liquid crystal display device (manufactured by Panasonic Corporation, Product Name: TH-L42D2) was disassembled, a plate in which the brightness improvement film of Example 28 was bonded to the polarizing plate prepared in Manufacturing Example 1 described above by using an adhesive agent containing a polyvinyl alcohol-based resin having an acetoacetyl group with high durability was used as a backlight side polarizing plate without disposing a dielectric multi-layer film (Product Name DBEF (Registered Trademark), manufactured by 3M Company), and thus, a liquid crystal display device of Example 28 was manufactured.

[Evaluation]

The liquid crystal display devices of Examples 26 to 28 using the brightness improvement films of Examples 26 to 28 were evaluated by on the same criteria as those in Example 1.

Specifically, in Examples 26 to 28, the front brightness was evaluated on the basis of Comparative Example 1.

As a result thereof, the front brightness of the liquid crystal display devices of Example 26 was more excellent than that of the liquid crystal display device of Comparative Example 1 by 20%. In addition, the front brightness of the liquid crystal display device of Example 27 was more excellent than that of the liquid crystal display device of Comparative Example 1 by 23%. On the other hand, the front brightness of the liquid crystal display device of Example 28 was more excellent than that of the liquid crystal display device of Comparative Example 1 by 27%.

As described above, according to the studies of the present inventors, it has been found that it was possible to improve the brightness by providing the layer changing the polarization state of light reflected from the light reflection layer on the light reflection layer on the light source side.

### EXPLANATION OF REFERENCES

1: backlight side polarizing plate
2: retardation film
2A: retardation film having absorption range
3: polarizer
3ab: absorption axis direction of polarizer
4: polarizing plate protective film
4A: polarizing plate protective film having absorption range
11: brightness enhancement film
12: λ/4 plate
12sl: slow axis direction of λ/4 plate
13: wavelength selective reflective polarizer (light reflection layer formed by immobilizing cholesteric liquid crystalline phase or dielectric multi-layer film)
13B: wavelength selective reflective polarizer having reflection range of greater than or equal to 60%
15: optical conversion sheet (containing fluorescent material such as quantum dot fluorescent body)
15A: optical conversion sheet having absorption range
15R: optical conversion sheet containing quantum rod material
16: optical sheet (prism, lens sheet, scattering sheet, and reflection polarizer)
16A: optical sheet having absorption range
21: optical sheet member
31: surface light source BL unit (edge light mode)
32: light source emitting blue light of 380 nm to 480 nm (blue LED light source module)
33: light guide plate (Light Guide Plate or Light Guiding Panel: LGP)
33A: light guide plate having absorption range
34: surface light source BL unit in direct backlight mode
35: scattering plate
42: liquid crystal cell, thin layer transistor substrate, and color filter substrate (optical switching device which is liquid crystal driving device)
43: display side polarizing plate
50: light source unit for display device
60: display device

What is claimed is:

1. An optical sheet member, comprising:
an optical conversion sheet containing a fluorescent material which absorbs at least a part of light in a wavelength range of 380 nm to 480 nm, converts the absorbed light into light in a wavelength range longer than that of the absorbed light, and re-emits the converted light; and
a wavelength selective reflective polarizer functioning in at least a part of the wavelength range of 380 nm to 480 nm.

2. The optical sheet member according to claim 1,
wherein a light reflection member further arranged between the optical conversion sheet and the wavelength selective reflective polarizer or the wavelength selective reflective polarizer has a wavelength range having reflectivity of greater than or equal to 60% in at least one wavelength range of wavelength ranges of 470 nm to 510 nm, 560 nm to 610 nm, and 660 nm to 780 nm.

3. The optical sheet member according to claim 1,
wherein the wavelength selective reflective polarizer includes a light reflection layer formed by immobilizing a cholesteric liquid crystalline phase which reflects light in at least a part of the wavelength range of 380 nm to 480 nm, and
a half band width of a reflection range of the light reflection layer is 15 nm to 400 nm.

4. The optical sheet member according to claim 1,
wherein the wavelength selective reflective polarizer includes a light reflection layer formed by immobilizing a cholesteric liquid crystalline phase which has a reflection center wavelength in at least one wavelength range of wavelength ranges of 380 nm to 480 nm, 500 nm to 570 nm, and 600 nm to 690 nm.

5. The optical sheet member according to claim 1, further comprising:
a λ/4 plate satisfying at least one of Expressions (1) to (3) described below,
450 nm/4−60 nm<Re(450)<450 nm/4+60 nm Expression (1)
550 nm/4−60 nm<Re(550)<550 nm/4+60 nm Expression (2)
630 nm/4−60 nm<Re(630)<630 nm/4+60 nm Expression (3)
wherein in Expressions (1) to (3), Re(λ) represents retardation in an in-plane direction at a wavelength of λ nm, and a unit of Re(λ) is nm.

6. The optical sheet member according to claim 5, further comprising:
a polarizing plate,
wherein the polarizing plate, the λ/4 plate, and the wavelength selective reflective polarizer are laminated in this order directly in contact with each other or through an adhesive layer.

7. The optical sheet member according to claim 1, further comprising:
a polarizing plate,
wherein the polarizing plate includes a polarizer and at least one polarizing plate protective film,
the polarizer, the polarizing plate protective film, and the wavelength selective reflective polarizer are laminated in this order directly in contact with each other or through an adhesive layer,
the polarizing plate protective film is a λ/4 plate satisfying at least one of Expressions (1) to (3) described below, and
450 nm/4−60 nm<Re(450)<450 nm/4+60 nm Expression (1)
550 nm/4−60 nm<Re(550)<550 nm/4+60 nm Expression (2)
630 nm/4−60 nm<Re(630)<630 nm/4+60 nm Expression (3)
in Expressions (1) to (3), Re(λ) represents retardation in an in-plane direction at a wavelength of λ nm, and a unit of Re(λ) is nm.

8. The optical sheet member according to claim 5,
wherein the λ/4 plate is an approximately optically monoaxial or biaxial retardation film, or a retardation film including one or more liquid crystal layers containing a liquid crystal compound.

9. The optical sheet member according to claim 1,
wherein the wavelength selective reflective polarizer is a dielectric multi-layer film.

10. The optical sheet member according to claim 9, further comprising:
a polarizing plate,
wherein the polarizing plate and the wavelength selective reflective polarizer are laminated directly in contact with each other or through an adhesive layer.

11. The optical sheet member according to claim 1,
wherein the fluorescent material contains at least one of an organic fluorescent body or an inorganic fluorescent body.

12. The optical sheet member according to claim 11,
wherein the inorganic fluorescent body contains at least one of an oxide fluorescent body, a sulfide fluorescent body, a quantum dot fluorescent body, or a quantum rod fluorescent body.

13. The optical sheet member according to claim 11,
wherein the inorganic fluorescent body contains a quantum rod material, and
the optical conversion sheet is a thermoplastic film formed by being stretched after dispersing the quantum rod material, and emits fluorescent light having at least a part of polarization properties of incidence light.

14. The optical sheet member according to claim 11,
wherein the optical sheet member has light absorption properties in at least one wavelength range of wavelength ranges of 470 nm to 510 nm, 560 nm to 610 nm, and 660 nm to 780 nm.

15. The optical sheet member according to claim 1,
wherein a light absorption member further arranged between the optical conversion sheet and the wavelength selective reflective polarizer or the wavelength selective reflective polarizer has light absorption properties in at least one wavelength range of wavelength ranges of 470 nm to 510 nm, 560 nm to 610 nm, and 660 nm to 780 nm.

16. The optical sheet member according to claim 14,
wherein the absorption properties are properties which have an absorption range having light absorbance of greater than or equal to 0.1 in at least one wavelength range of wavelength ranges of 470 nm to 510 nm, 560 nm to 610 nm, and 660 nm to 780 nm, and
light absorbance A is −log₁₀ (transmittance).

17. The optical sheet member according to claim 1,
wherein the light re-emitted from the fluorescent material is green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a light emission intensity peak having a half band width of less than or equal to 100 nm.

18. The optical sheet member according to claim 1,
wherein the optical conversion sheet includes a fluorescent material member in which the fluorescent material is dispersed in a polymer matrix between two base films on which an oxygen gas barrier layer is disposed.

19. A display device, comprising at least:
a light source having a light emission wavelength in at least a part of a wavelength range of 380 nm to 480 nm; and
the optical sheet member according to claim 1.

20. The display device according to claim 19,
wherein the light source, the optical conversion sheet included in the optical sheet member, and the wavelength selective reflective polarizer included in the optical sheet member are arranged in this order.

21. The display device according to claim 19, further comprising:
an optical switching device switching light of the light source.

22. The display device according to claim 21,
wherein the optical switching device is a liquid crystal driving device, and
a polarizing plate is disposed between the wavelength selective reflective polarizer and the liquid crystal driving device.

23. The display device according to claim 22,
wherein the polarizing plate and the wavelength selective reflective polarizer are laminated directly in contact with each other or through an adhesive layer.

24. The display device according to claim 22,
wherein the optical sheet member includes a λ/4 plate satisfying at least one of Expressions (1) to (3) described below,
the polarizing plate, the λ/4 plate, and the wavelength selective reflective polarizer are laminated in this order directly in contact with each other or through an adhesive layer, and
450 nm/4−60 nm<Re(450)<450 nm/4+60 nm Expression (1)
550 nm/4−60 nm<Re(550)<550 nm/4+60 nm Expression (2)
630 nm/4−60 nm<Re(630)<630 nm/4+60 nm Expression (3)
in Expressions (1) to (3), Re(λ) represents retardation in an in-plane direction at a wavelength of λ nm, and a unit of Re(λ) is nm.

25. The display device according to claim 22, further comprising:
a light guide plate bonded to the light source; and
an optical sheet disposed in at least one position between the light guide plate and the optical conversion sheet, between the optical conversion sheet and the wavelength selective reflective polarizer, and between the wavelength selective reflective polarizer and the polarizing plate.

26. The display device according to claim 25,
wherein the optical sheet is a single-layer optical sheet or a laminated optical sheet selected from one or more of a prism sheet, a lens sheet, and a scattering sheet.

27. The display device according to claim 19,
wherein the light source includes a blue LED, and
the optical conversion sheet includes a fluorescent material having a light emission wavelength of green light which has a light emission center wavelength in a wavelength range of 500 nm to 600 nm and has a light emission intensity peak having a half band width of less than or equal to 100 nm, and red light which has a light emission center wavelength in a wavelength range of 600 nm to 650 nm and has a half band width of less than or equal to 100 nm.

28. The display device according to claim 19,
wherein the optical conversion sheet includes a fluorescent material member in which the fluorescent material is dispersed in a polymer matrix between two base films on which an oxygen gas barrier layer is disposed, and
the optical conversion sheet is arranged between the wavelength selective reflective polarizer and the light source.

29. The display device according to claim 19, further comprising:
a thin layer transistor,
wherein the thin layer transistor includes an oxide semiconductor layer having a carrier concentration of less than 1×10¹⁴/cm³.
